(19) United States
(12) Patent Application Publication
(10) Pub. No.: US 2006/0202731 A1
(43) Pub. Date: Sep. 14, 2006

(54) Semiconductor integrated circuit device

(75) Inventors: Akira Takahashi, Tsubame-shi (JP); Jiro Miyake, Shijonawate-shi (JP); Toru Morikawa, Minoh-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/371,043

(22) Filed: Mar. 9, 2006

(30) Foreign Application Priority Data
Mar. 9, 2005 (JP) 2005-065985

(51) Int. Cl. G06F 1/04

(52) U.S. Cl. 327/291

(57) ABSTRACT

A clock signal is provided with amplitudes of a plurality of levels and flip-flop circuits having different threshold values are used so that at least two different frequencies can be simultaneously supplied through one clock signal line.

### BACKGROUND OF THE INVENTION

1. Field of the Invention

The present invention relates to a semiconductor integrated circuit device, more particularly to a semiconductor integrated circuit device adapted to supply a plurality of clocks respectively having different frequencies to a plurality of functional blocks.

2. Description of the Related Art

In a conventional semiconductor integrated circuit device in which a synchronous design is adopted, a clock signal line commonly used for a plurality of functional blocks is provided, and a clock having a predetermined frequency is supplied to the plurality of functional blocks. Therefore, as recited in No. 2002-6982 of the Publication of the Unexamined Japanese Patent Applications, in the case where a plurality of frequencies were necessary in the semiconductor integrated circuit device, for example, the signal line for supplying the clock was divided per frequency, and the clocks having the plurality of frequencies were separately supplied to the respective functional blocks via a plurality of clock signal lines resulting from the division.

A problem in the conventional configuration is that a slight timing delay is generated between the plurality of clock signal lines because the clock signals having the different frequencies are supplied to the corresponding functional blocks via the plurality of clock signals. Therefore, it was necessary to correct the timing delay so that the semiconductor integrated circuit device in which the synchronous design was adopted could accurately function.

### SUMMARY OF THE INVENTION

Therefore, a main object of the present invention is to provide a semiconductor integrated circuit device capable of preventing a timing delay between a plurality of clock signal lines.

In order to solve the foregoing problem, a semiconductor integrated circuit device according to the present invention generates a clock pulse which repeats a potential value “0” and at least two high potential values.

A semiconductor integrated circuit device according to the present invention comprises a clock supplier, a first function executor, a second function executor, and a voltage supplier. The clock supplier generates a clock signal having a clock pulse which repeats a potential value “0” and at least two high potential values and supplies the generated clock signal to the first function executor and the second function executor. The first function executor comprises at least one first retainer, and the first retainer sets a particular potential value as a first threshold value and fetches data when the potential of the clock signal changes from a potential lower than the first threshold value to a potential at least the first threshold value. The second function executor comprises at least one second retainer, and the second retainer sets a potential lower than the first threshold value as a second threshold value and fetches data when the potential of the clock signal changes from a potential lower than the second threshold value to a potential at least the second threshold value. The voltage supplier supplies the potential value “0” and the at least two high potential values to the clock supplier, the first function executor and the second function executor.

According to the foregoing configuration, the clock signals having the different amplitudes and the retainers having the different threshold voltages are used so that two different frequencies can be simultaneously supplied through one clock signal line.

A semiconductor integrated circuit device according to the present invention comprises a clock supplier, a first function executor, a second function executor, and a voltage supplier. The clock supplier generates a clock signal having a clock pulse which repeats a low potential value and at least two high potential values and supplies the generated clock signal to the first function executor and the second function executor. The first function executor comprises at least one first retainer, and the first retainer sets a particular potential value as a first threshold value and fetches data when the potential of the clock signal changes from a potential lower than the first threshold value to a potential at least the first threshold value. The second function executor comprises at least one second retainer, and the second retainer sets a potential lower than the first threshold value as a second threshold value and fetches data when the potential of the clock signal changes from a potential lower than the second threshold value to a potential at least the second threshold value. The voltage supplier supplies the low potential value and the at least two high potential values to the clock supplier, the first function executor and the second function executor.

According to the foregoing configuration, only the function executor that is desirably halted can be arbitrarily halted through one clock signal line.

A semiconductor integrated circuit device according to the present invention comprises a clock supplier, a first voltage value converter, a second voltage value converter, a first function executor, a second function executor, and a voltage supplier. The clock supplier generates a clock signal having a clock pulse which repeats a potential value “0” and at least two high potential values and supplies the generated clock signal to the first voltage value converter and the second voltage value converter. The first voltage value converter converts the clock signal and outputs the converted signal to the first function executor. The second voltage value converter converts the clock signal and outputs the converted signal to the second function executor. The first function executor comprises at least one first retainer, and the first retainer sets a particular potential value as a first threshold value and fetches data when the potential of the clock signal inputted from the first voltage value converter changes from a potential lower than the first threshold value to a potential at least the first threshold value. The second function executor comprises at least one second retainer, and the second retainer sets a potential lower than the first threshold value as a second threshold value and fetches data when the potential of the clock signal inputted from the second voltage value converter changes from a potential lower than the second threshold value to a potential at least the second threshold value. The voltage supplier supplies the potential value “0” and the at least two high potential values to the first function executor, the second function executor and the clock supplier. The first voltage value converter outputs the potential value “0” as the clock signal to the first function executor during a period when the potential of the clock signal is lower than the first threshold value. The second voltage value converter outputs the second threshold value as the clock signal to the second function executor during a period when the potential of the clock signal is lower than the second threshold value.

According to the foregoing configuration, the respective function executors can only be supplied with the necessary voltages. As a result, power consumption can be favorably reduced.

A semiconductor integrated circuit device according to the present invention comprises a function executor comprising at least one first selector, at least one second selector and at least one retainer, a clock supplier for generating a clock signal having a clock pulse which repeats a potential value “0” and at least two high potential values and supplying the generated clock signal to the function executor, and a voltage supplier for supplying the potential value “0” and the at least two high potential values to the function executor and the clock supplier. The first selector selects one of a first data and a second data respectively inputted from outside based on a selection signal. The second selector sets a particular potential value in the clock signal as a first threshold value and sets a potential value lower than the first threshold value as a second threshold value, and selects one of the threshold values based on the selection signal. The retainer fetches the data selected by the first selector when the potential value of the clock signal changes from a potential lower than the threshold value selected by the second selector to a potential at least the selected threshold value.

According to the foregoing configuration, the clock waveforms having the different amplitudes and the selection signal are used to control the threshold values of the retainer with respect to the clock signal. Thereby, frequencies in test and normal operations can be changed.

A semiconductor integrated circuit device according to the present invention comprises a function executor comprising at least one selector and at least one retainer, a clock supplier for generating a clock signal having a clock pulse which repeats a potential value “0” and at least two high potential values and supplying the generated clock signal to the function executor, a controller for supplying a control signal for controlling a maximum potential value of the clock signal to the clock supplier, and a voltage supplier for generating the potential value “0” and the at least two high potential values and supplying the generated potential values to the function executor and the clock supplier, the voltage supplier further supplying the potential value “0” and at least one high potential value to the controller. The selector sets a particular potential value in the clock signal as a first threshold value, and selects a first data from the first data and a second data respectively inputted from outside when the potential value of the clock signal is at least the first threshold value, while selecting the second data when the potential value of the clock signal is lower than the first threshold value. The retainer sets a potential value lower than the first threshold value as a second threshold value, and fetches the data selected by the selector when the potential value of the clock signal changes from a potential lower than the second threshold value to a potential at least the second threshold value.

According to the foregoing configuration, the data can be selectively inputted to the retainer through one clock signal line, which makes it unnecessary to additionally provide a signal line for the selective input.

A semiconductor integrated circuit device according to the present invention comprises a function executor comprising at least one retainer for fetching data from outside, a clock supplier for generating a clock signal and supplying the generated clock signal to the function executor, and a voltage supplier for supplying a potential value “0” and at least two high potential values to the function executor and the clock supplier. The retainer sets a particular potential as a first threshold value and sets a potential value lower than the first threshold value as a second threshold value, and fetches data showing “HIGH” when a potential of the clock signal changes from a potential lower than the second threshold value to a potential at least the first threshold value, while fetching data showing “LOW” when the potential of the clock signal changes from the potential lower than the second threshold value to a potential at least the second threshold value and lower than the first threshold value. The clock supplier generates a clock signal having a clock pulse which repeats the potential value “0” and the potential value at least the first threshold value when a control signal inputted from outside shows one value and supplies the generated clock signal to the function executor. The clock supplier generates a clock signal having a clock pulse which repeats the potential value “0” and the potential value that is at least the second threshold value and lower than the first threshold value when the control signal shows any other value and supplies the generated clock signal to the function executor.

According to the foregoing configuration, the threshold values of the data input terminal and the clock input terminal of the retainer are made different to each other. As a result, the clock signal and the data signal can be simultaneously supplied through one clock signal line.

A semiconductor integrated circuit device according to the present invention comprises a clock supplier for generating a clock signal having a clock pulse which repeats a potential value “0” and at least two high potential values, a first controller for supplying a control signal for controlling a maximum potential value of the clock signal to the clock supplier, a function executor comprising at least one second controller, at least one third controller and at least one retainer, and a voltage supplier for supplying the potential value “0” and the at least two high potential values to the second controller, the function executor and the clock supplier and supplying the potential value “0” and at least one high potential value to the first controller. The second controller sets a particular potential value in the clock signal as a first threshold value, and outputs a low potential when the potential value of the clock signal is at least the first threshold value. The third controller sets a potential value lower than the first threshold value as a second threshold value based on the control signal, and outputs the low potential when the potential value of the clock signal is at least the second threshold value. The retainer sets a potential value lower than the second threshold value as a third threshold value, and sets its internal state to have a low potential when the potential value of the clock signal is at least the first threshold value, sets its internal state to have a high potential when the potential value of the clock signal is at least the second threshold value and below the first threshold value, and fetches data from outside when the potential value of the clock signal is at least the third threshold value and below the second threshold value.

According to the foregoing configuration, the retainer can be asynchronously set and reset through one clock signal line, which makes it unnecessary to additionally provide a set signal line and a rest signal line.

A semiconductor integrated circuit device according to the present invention comprises a function executor comprising at least one first retainer, at least one second retainer, at least one third retainer and at least one controller, a clock supplier for generating a clock signal having a clock pulse which repeats a potential value “0” and at least three high potential values and supplying the generated clock signal to the function executor, and a voltage supplier for supplying the potential value “0” and at least two high potential values to the function executor and the clock supplier. The first retainer sets a particular potential value as a first threshold value, and fetches the high potential when the potential of the clock signal changes from a potential lower than the first threshold value to a potential at least the first threshold value. The second retainer sets a potential value lower than the first threshold value as a second threshold value, and fetches the high potential when the potential of the clock signal changes from a potential lower than the second threshold value to a potential at least the second threshold value. The third retainer sets a potential value lower than the second threshold value as a third threshold value, and fetches the high potential when the potential of the clock signal changes from a potential lower than the third threshold value to a potential at least the third threshold value. The controller receives outputs of the first retainer, the second retainer and the third retainer as input signals, and outputs a particular voltage value when these three input signals show particular values.

According to the foregoing configuration, an enable signal used for security and the like can be generated by means of the potential of the clock signal and the controller.

A semiconductor integrated circuit device according to the present invention comprises a first function executor comprising at least one first retainer, a second function executor comprising at least one second retainer, a clock supplier for generating a clock signal having a clock pulse which repeats a potential value “0” and at least two high potential values and supplying the generated clock signal to the first function executor and the second function executor, and a voltage supplier for supplying the potential value “0” and at least two high potential values to the first and second function executors and the clock supplier. The first retainer sets a particular potential value as a first threshold value, and fetches data when the potential of the clock signal changes from a potential lower than the first threshold value to a potential at least the first threshold value. The second retainer sets a potential value lower than the threshold value of the first function executor as a second threshold value, and fetches data when the potential of the clock signal changes from a potential lower than the second threshold value to a potential at least the second threshold value.

According to the foregoing configuration, the clock signals having the different amplitudes and the retainers having the different threshold voltages are used. Thereby, two different frequencies can be simultaneously supplied through one clock signal line, and the data can be fetched at an interval shorter than a half cycle.

A semiconductor integrated circuit device according to the present invention comprises a first function executor comprising at least one first retainer, a second function executor comprising at least one second retainer, a clock supplier for generating a clock pulse which repeats a potential value “0” and at least two high potential values and supplying the generated clock signal to the first function executor and the second function executor, the clock supplier further generating at least two reset signals having a high potential value and supplying the generated reset signals to the first function executor and the second function executor, and a voltage supplier for supplying the potential value “0” and at least two high potential values to the first and second function executors and the clock supplier. The first retainer sets a particular potential value as a first threshold value and fetches data when the potential value of the clock signal changes from a potential lower than the first threshold value to a potential at least the first threshold value. The first retainer further sets a particular potential value as a third threshold value, and sets its internal state to have a low potential when the potentials of the reset signals change to potentials lower than the third threshold value. The second retainer sets an potential lower than the first threshold value as a second threshold value, and fetches data when the potential of the clock signal changes from a potential lower than the second threshold value to a potential at least the second threshold value. The second retainer further sets a potential lower than the third threshold value as a fourth threshold value, and sets its internal state to have a low potential when the potentials of the reset signals change to potentials lower than the fourth threshold value.

According to the foregoing configuration, the function executor to be asynchronously reset can be selected through one reset signal line based on the potentials of the reset signals.

The effects obtained by the semiconductor integrated circuit device according to the present invention are: the clock signals having the different amplitudes and the retainers having the different threshold values are used so that the two different frequencies can be simultaneously supplied with a single clock signal line; only the function executor that is desirably halted can be halted with the single clock signal line; the power consumption can be reduced by supplying only the necessary voltages to the respective function executors; the clock waveforms having the different amplitudes and the selection signal are used to control the threshold values of the retainer with respect to the clock signal so that the frequencies in the test and normal operations can be changed; the data can be selectively inputted to the retainer can be changed with the single clock signal line, which makes it unnecessary to additionally provide a signal line for the selective input; the threshold values of the data input terminal and the clock input terminal of the retainer are made different to each other so that the clock signal and the data signal can be simultaneously supplied through one clock signal line; the retainer can be asynchronously set and reset through one clock signal line, which makes it unnecessary to additionally provide a set signal line and a rest signal line; the enable signal used for security and the like can be generated by means of the potential of the clock signal and the controller; the clock signals having the different amplitudes and the retainers having the different threshold voltages are used so that the two different frequencies can be simultaneously supplied through one clock signal line, and the data can be fetched at the interval shorter than the half cycle; and the function executor to be asynchronously reset can be selected based on the potentials of the reset signals through one reset signal line.

The semiconductor integrated circuit device according to the present invention is effectively applied to a semiconductor integrated circuit device and the like because various functions can be realized through a single clock signal line.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating an exemplary configuration of a semiconductor integrated circuit device according to an embodiment 1 of the present invention.

FIG. 2 is a block diagram of a clock generator according to the embodiment 1.

FIG. 3 is a waveform chart of a clock signal outputted from the clock generator according to the embodiment 1.

FIG. 4 is a waveform chart of the clock signal outputted from the clock generator according to the embodiment 1.

FIG. 5 is a block diagram illustrating an exemplary configuration of a semiconductor integrated circuit device according to an embodiment 2 of the present invention.

FIG. 6 is a block diagram of a clock generator according to the embodiment 2.

FIG. 7 is a waveform chart of a clock signal outputted from the clock generator according to the embodiment 2.

FIG. 8 is a waveform chart of the clock signal outputted from the clock generator according to the embodiment 2.

FIG. 9 is a block diagram illustrating an exemplary configuration of a semiconductor integrated circuit device according to an embodiment 3 of the present invention.

FIG. 10 is a waveform chart of clock signal lines according to the embodiment 3.

FIG. 11 is a block diagram illustrating an exemplary configuration of a semiconductor integrated circuit device according to an embodiment 4 of the present invention.

FIG. 12 is a block diagram of a clock generator according to the embodiment 4.

FIG. 13 is a block diagram illustrating an exemplary configuration of a flip-flop circuit according to the embodiment 4.

FIG. 14 is a waveform chart of a clock signal outputted from the clock generator according to the embodiment 4.

FIG. 15 is a waveform chart of the clock signal outputted from the clock generator according to the embodiment 4.

FIG. 16 is a waveform chart of the clock signal outputted from the clock generator according to the embodiment 4.

FIG. 17 is a block diagram illustrating an exemplary configuration of a semiconductor integrated circuit device according to an embodiment 5 of the present invention.

FIG. 18 is a block diagram of a clock generator according to the embodiment 5.

FIG. 19 is a block diagram illustrating an exemplary configuration of a flip-flop circuit according to the embodiment 5.

FIG. 20 is a waveform chart of a clock signal outputted from the clock generator according to the embodiment 5.

FIG. 21 is a waveform chart of the clock signal outputted from the clock generator according to the embodiment 5.

FIG. 22 is a waveform chart of the clock signal outputted from the clock generator according to the embodiment 5.

FIG. 23 is a waveform chart of the clock signal outputted from the clock generator according to the embodiment 5.

FIG. 24 is a block diagram illustrating an exemplary configuration of a semiconductor integrated circuit device according to an embodiment 6 of the present invention.

FIG. 25 is a block diagram of a clock generator according to the embodiment 6.

FIG. 26 is a block diagram illustrating an exemplary configuration of a flip-flop circuit according to the embodiment 6.

FIG. 27 is a waveform chart of a clock signal outputted from the clock generator according to the embodiment 6.

FIG. 28 is a waveform chart of the clock signal outputted from the clock generator according to the embodiment 6.

FIG. 29 is a block diagram illustrating an exemplary configuration of a semiconductor integrated circuit device according to an embodiment 7 of the present invention.

FIG. 30 is a block diagram of a clock generator according to the embodiment 7.

FIG. 31 is a block diagram illustrating an exemplary configuration of a flip-flop circuit according to the embodiment 7.

FIG. 32 is a waveform chart of a clock signal outputted from the clock generator according to the embodiment 7.

FIG. 33 is a waveform chart of the clock signal outputted from the clock generator according to the embodiment 7.

FIG. 34 is a block diagram illustrating an exemplary configuration of a semiconductor integrated circuit device according to an embodiment 8 of the present invention.

FIG. 35 is a block diagram of a clock generator according to the embodiment 8.

FIG. 36 is a block diagram illustrating an exemplary configuration of a combinational circuit according to the embodiment 8.

FIG. 37 is a waveform chart of a clock signal outputted from the clock generator according to the embodiment 8.

FIG. 38 is a waveform chart of the clock signal outputted from the clock generator according to the embodiment 8.

FIG. 39 is a block diagram illustrating an exemplary configuration of a semiconductor integrated circuit device according to an embodiment 9 of the present invention.

FIG. 40 is a block diagram of a clock generator according to the embodiment 9.

FIG. 41 is a waveform chart of a clock signal outputted from the clock generator according to the embodiment 9.

FIG. 42 is a waveform chart of the clock signal outputted from the clock generator according to the embodiment 9.

FIG. 43 is a block diagram illustrating an exemplary configuration of a semiconductor integrated circuit device according to an embodiment 10 of the present invention.

FIG. 44 is a block diagram of a clock generator according to the embodiment 10.

FIG. 45 is a block diagram illustrating an exemplary configuration of a flip-flop circuit according to the embodiment 10.

FIG. 46 is a block diagram illustrating another exemplary configuration of the flip-flop circuit according to the embodiment 10.

FIG. 47 is a waveform chart of a clock signal and reset signals outputted from the clock generator according to the embodiment 10.

FIG. 48 is a waveform chart of the clock signal and the reset signals outputted from the clock generator according to the embodiment 10.

### DETAILED DESCRIPTION OF THE INVENTION

Hereinafter, preferred embodiments of the present invention are described referring to the drawings.

### Embodiment 1

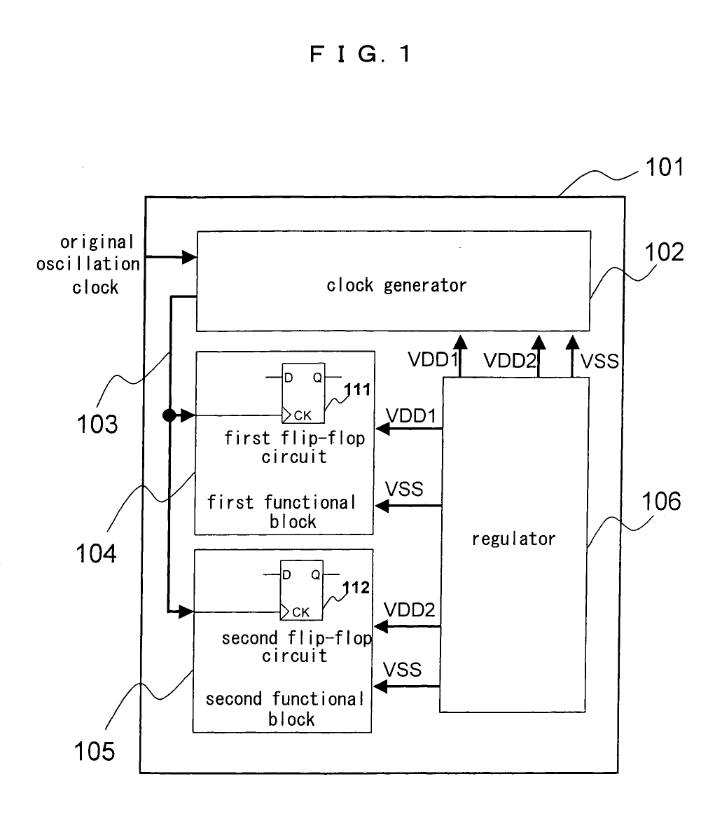

FIG. 1 is a block diagram illustrating a configuration of a semiconductor integrated circuit device according to an embodiment 1 of the present invention. A semiconductor integrated circuit device 101 comprises a clock generator (clock supplier) 102, a clock signal line 103, a first functional block (first function executor) 104, a second functional block (second function executor) 105, and a regulator (voltage supplier) 106.

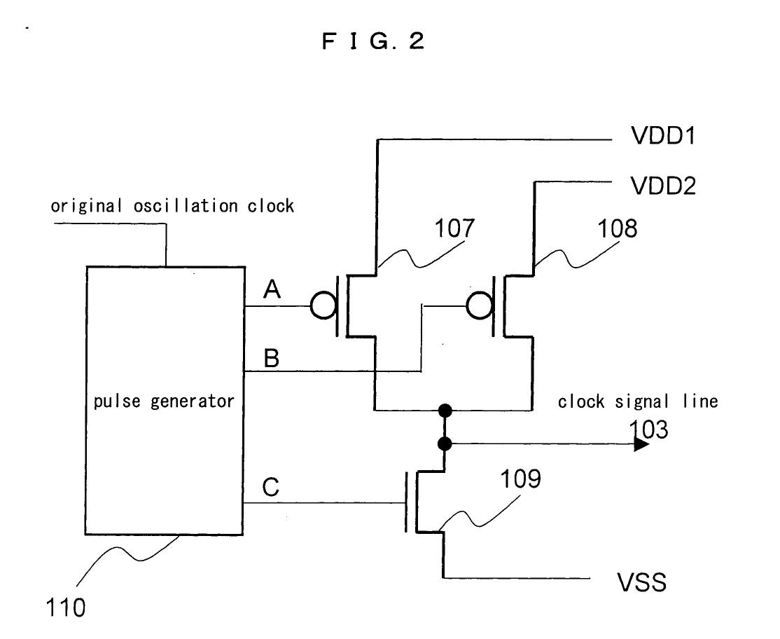

A power-supply voltage VDD1, a power-supply voltage VDD2 and a reference voltage VSS are supplied from the regulator 106 to the clock generator 102. FIG. 2 is a circuit diagram of the clock generator 102. The clock generator 102 comprises a pulse generator 110, a Pch transistor 107, a Pch transistor 108, and an Nch transistor 109.

An original oscillation clock from outside is connected to the pulse generator 110. A drain terminal of the Pch transistor 107 is connected to the power-supply voltage VDD1, and a gate terminal thereof is connected to the pulse generator 110. A drain terminal of the Pch transistor 108 is connected to the power-supply voltage VDD2, and a gate terminal thereof is connected to the pulse generator 110. The power-supply voltage VDD2 is lower than the power-supply voltage VDD1 (VDD2<VDD1).

A drain terminal of the Nch transistor 109 is connected to a source terminal of the transistor 107, and a source terminal of the transistor 108 and the clock signal line 103. A gate terminal of the transistor 109 is connected to the pulse generator 110, and a source terminal thereof is connected to VSS.

The first functional block 104 comprises a first flip-flop circuit (first retainer) 111. The first flip-flop circuit 111 comprises a D input terminal connected to a logic in a previous stage, a Q output terminal connected to a logic in a subsequent stage, and a CK input terminal for inputting a clock from the clock signal line 103. The first flip-flop circuit 111 fetches a potential of the D input terminal when a potential lower than Level A (first threshold value) changes into a potential at least the Level A.

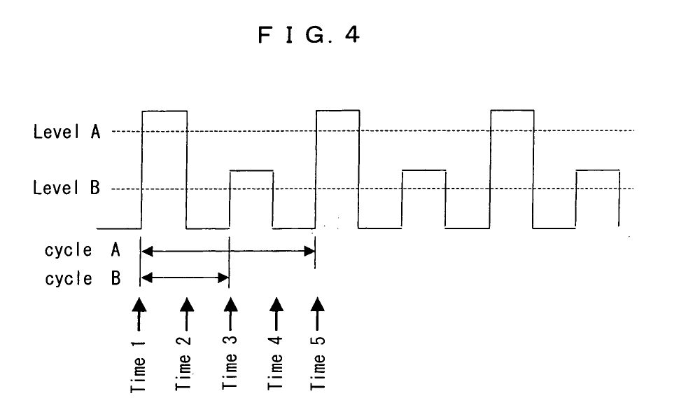

The second functional block 105 comprises a second flip-flop circuit (second retainer) 112. The second flip-flop circuit 112 comprises a D input terminal connected to a logic in a previous stage, a Q output terminal connected to a logic in a subsequent stage, and a CK input terminal for inputting the clock from the clock signal line 103. The second flip-flop circuit 112 fetches a potential of the D input terminal when a potential lower than Level B (second threshold value) changes into a potential at least the B potential. A relationship between the Levels A and B is, as shown in FIG. 4, Level B<Level A.

The clock signal line 103 supplies a clock signal outputted from the clock generator 102 to the first functional block 104 and the second functional block 105. The regulator 106 supplies the power-supply voltages VDD1 and VDD2 (VDD1>VDD2) and the reference voltage VSS to the clock generator 102, and supplies the power-supply voltage VDD1 and the reference voltage VSS to the first functional block 104. The regulator 106 further supplies the power-supply voltage VDD2 and the reference voltage VSS to the second functional block 105.

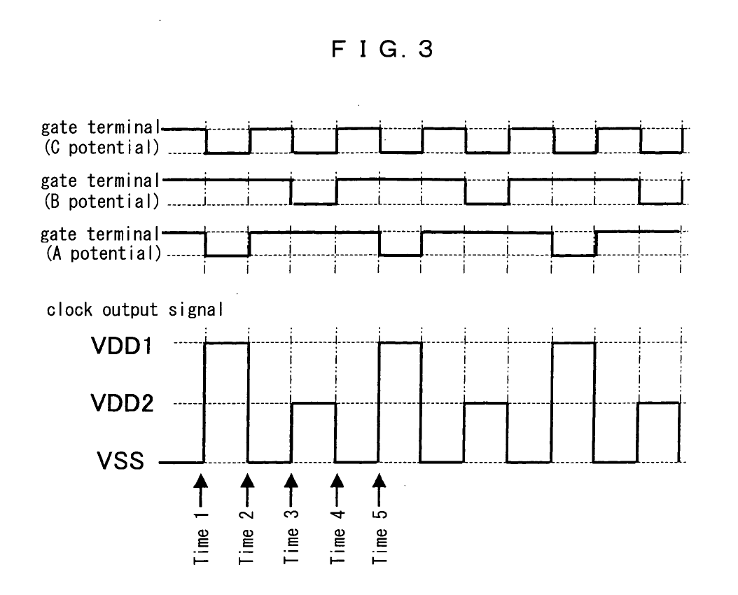

An operation of the semiconductor integrated circuit device thus configured is described below. FIG. 3 is a timing chart for illustrating a relationship among the gate terminal of the Pch transistor 107 (A potential), the gate terminal of the Pch transistor 108 (B potential), the gate terminal of the Nch transistor 109 (C potential) and the clock signal outputted from the clock generator 102 and transmitted via the clock signal line 103. FIG. 4 is a timing chart for illustrating a relationship among the clock signal line 103, the first functional block 104 and the second functional block 105. Below are described operations in Time 1-Time 5 shown in FIGS. 3 and 4.

Operation at Time 1

LOW is inputted from the pulse generator 110 to the gate terminal C of the Nch transistor 109. HIGH is inputted from the pulse generator 110 to the gate terminal B of the Pch transistor 108. LOW is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. The clock in which the voltage level is changed from VSS to VDD1 is inputted from the clock signal line 103 to the first functional block 104. In the first flip-flop circuit 111, the value of the D terminal is fetched since the voltage level is changed from VSS to VDD1 in the CK terminal thereof. The clock in which the voltage level is changed from VSS to VDD1 is inputted from the clock signal line 103 to the second functional block 105. In the second flip-flop circuit 112, the value of the D terminal is fetched since the voltage level is changed from VSS to VDD1 in the CK terminal thereof.

Operation Between Time 1 and Time 2

LOW is inputted from the pulse generator 110 to the gate terminal C of the Nch transistor 109. HIGH is inputted from the pulse generator 110 to the gate terminal B of the Pch transistor 108. LOW is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. The clock in which the voltage level is VDD1 is inputted from the clock signal line 103 to the first functional block 104. In the first flip-flop circuit 111, the internal data is retained since the voltage level is VDD1 in the CK terminal thereof. The clock in which the voltage level is VDD1 is inputted from the clock signal line 103 to the second functional block 105, In the second flip-flop circuit 112, the internal data is retained since the voltage level is VDD1 in the CK terminal thereof.

Operation at Time 2

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103.

The clock in which the voltage level is changed from VDD1 to VSS is inputted from the clock signal line 103 to the first functional block 104. In the first flip-flop circuit 111, the internal data is retained since the voltage level is changed from VDD1 to VSS in the CK terminal thereof. The clock in which the voltage level is changed from VDD1 to VSS is inputted from the clock signal line 103 to the second functional block 105. In the second flip-flop circuit 112, the internal data is retained since the voltage level is changed from VDD1 to VSS in the CK terminal thereof.

Operation Between Time 2 and Time 3

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103.

The clock in which the voltage level is VSS is inputted from the clock signal line 103 to the first functional block 104. In the first flip-flop circuit 111, the internal data is retained since the voltage level is VSS in the CK terminal thereof. The clock in which the voltage level is VSS is inputted from the clock signal line 103 to the second functional block 105. In the second flip-flop circuit 112, the internal data is retained since the voltage level is VSS in the CK terminal thereof.

Operation at Time 3

LOW is inputted from the pulse generator 110 to the gate terminal C of the Nch transistor 109. LOW is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. The clock in which the voltage level is changed from VSS to VDD2 is inputted from the clock signal line 103 to the first functional block 104. In the first flip-flop circuit 111, the internal data is retained since the voltage level is changed from VDD to VDD2 in the CK terminal thereof. The clock in which the voltage level is changed VSS to VDD2 is inputted from the clock signal line 103 to the second functional block 105. In the second flip-flop circuit 112, the value of the D terminal is fetched since the voltage level is changed from VSS to VDD2 in the CK terminal thereof.

Operation Between Time 3 and Time 4

LOW is inputted from the pulse generator 110 to the gate terminal C of the Nch transistor 109. LOW is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. The clock in which the voltage level is VDD2 is inputted from the clock signal line 103 to the first functional block 104. In the first flip-flop circuit 111, the internal data is retained since the voltage level is VDD2 in the CK terminal thereof. The clock in which the voltage level is VDD2 is inputted from the clock signal line 103 to the second functional block 105. In the second flip-flop circuit 112, the internal data is retained since the voltage level is VDD2 in the CK terminal thereof.

Operation at Time 4

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. The clock in which the voltage level is changed from VDD2 to VSS is inputted from the clock signal line 103 to the first functional block 104. In the first flip-flop circuit 111, the internal data is retained since the voltage level is changed from VDD2 to VSS in the CK terminal thereof. The clock in which the voltage level is changed from VDD2 to VSS is inputted from the clock signal line 103 to the second functional block 105. In the second flip-flop circuit 112, the internal data is retained since the voltage level is changed from VDD2 to VSS in the CK terminal thereof.

Operation Between Time 4 and Time 5

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The clock in which the voltage level is VSS is inputted from the clock signal line 103 to the first functional block 104. In the first flip-flop circuit 111, the internal data is retained since the voltage level is VSS in the CK terminal thereof. The clock in which the voltage level is VSS is inputted from the clock signal line 103 to the second functional block 105. In the second flip-flop circuit 112, the internal data is retained since the voltage level is VSS in the CK terminal thereof.

The operations from the Time 1 to the Time 5 so far described are repeated so that the first flip-flop circuit 111 fetches the data based on Cycle A, while the second flip-flop circuit 112 fetches the data based on Cycle B.

When the clock signals having the different amplitudes and the flip-flop circuits having the different threshold voltages are thus used, two different frequencies can be simultaneously supplied via one clock signal line. As a result, the clocks can be adjusted at one time in the first and second functional blocks, which reduces number of designing steps.

In the foregoing description of the present embodiment, the two different threshold voltages are provided for the flip-flop circuits, however, there may be at least three different threshold voltages.

### Embodiment 2

A disadvantage in the present embodiment 1 is that it is not possible to halt one of the clocks of the first and second functional blocks because the functional blocks share the same clock signal line connected thereto. An embodiment 2 of the present invention improves the disadvantage.

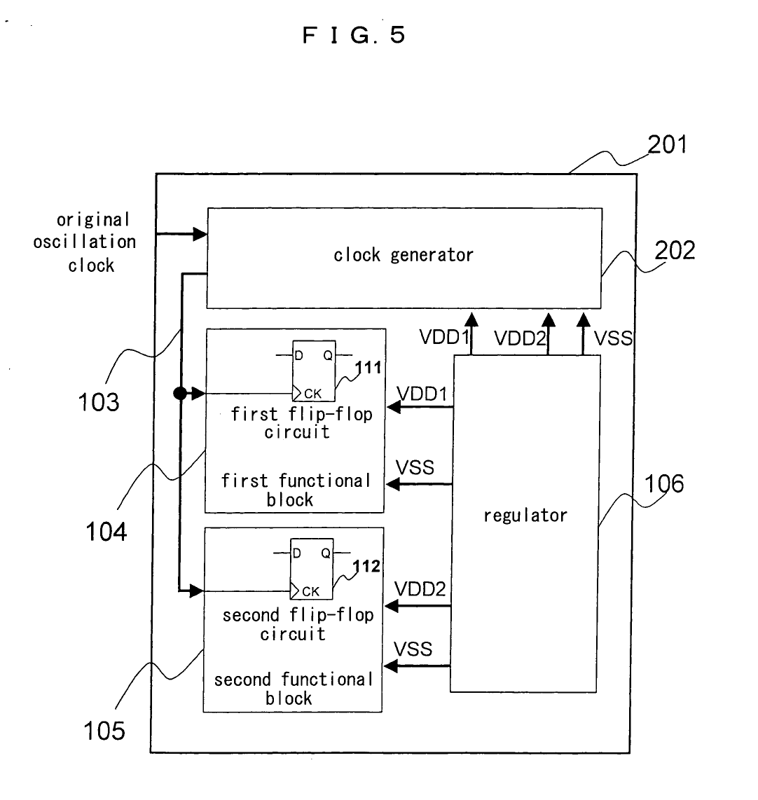

FIG. 5 is a block diagram illustrating a configuration of a semiconductor integrated circuit device according to the embodiment 2. A semiconductor integrated circuit device 201 comprises a clock generator (clock supplier) 202, a clock signal line 203, a first functional block (first function executor) 104, a second functional block (second function executor) 105, and a regulator (voltage supplier) 106. The first functional block (first function executor) 104 comprises a first flip-flop circuit (first retainer) 111. The second functional block (second function executor) 105 comprises a second flip-flop circuit (second retainer) 112.

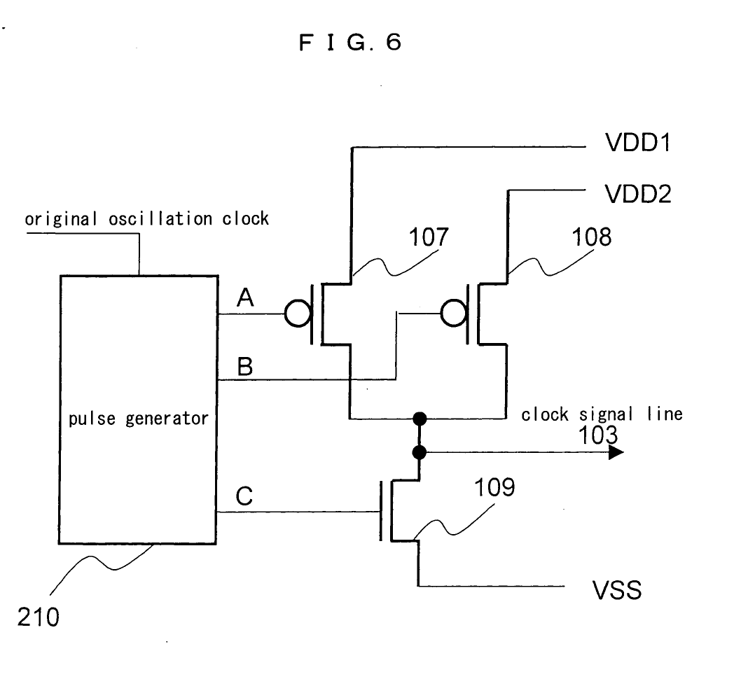

A power-supply voltage VDD1, a power-supply voltage VDD2 and a reference voltage VSS are supplied from the regulator 106 to the clock generator 202. FIG. 6 is a circuit diagram of the clock generator 202. The clock generator 202 comprises a pulse generator 210, a Pch transistor 107, a Pch transistor 108, and an Nch transistor 109.

An original oscillation clock from outside is connected to the pulse generator 210. A drain terminal of the Pch transistor 107 is connected to the power-supply voltage VDD1, and a gate terminal thereof is connected to the pulse generator 210. A drain terminal of the Pch transistor 108 is connected to the power-supply voltage VDD2, and a gate terminal thereof is connected to the pulse generator 210. The power-supply voltage VDD2 is lower than the power-supply voltage VDD1 (VDD2<VDD1).

A drain terminal of the Nch transistor 109 is connected to a source terminal of the transistor 107, a source terminal of the transistor 108 and the clock signal line 103. A gate terminal of the transistor 109 is connected to the pulse generator 210, and a source terminal thereof is connected to VSS.

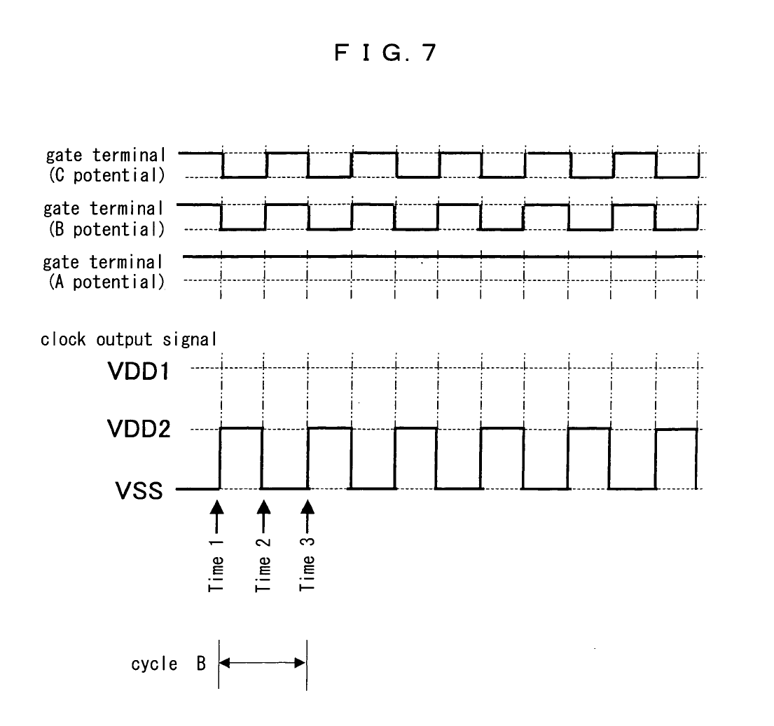

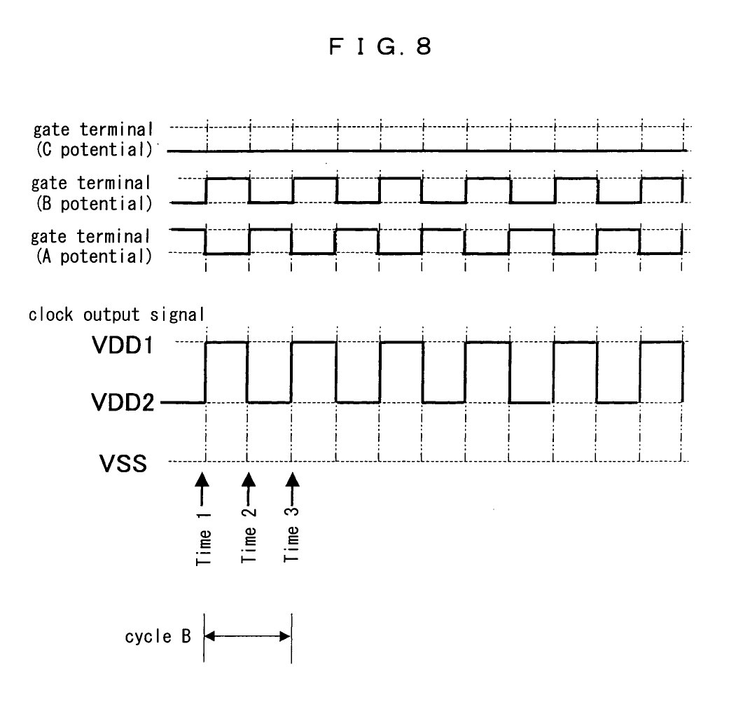

The pulse generator 210 can supply potentials shown in FIGS. 7 and 8 to the gate terminal (A potential), the gate terminal (B potential) and the gate terminal (C potential). The first and second functional blocks 104 and 105 are configured in the same manner as described in the embodiment 1.

An operation of the semiconductor integrated circuit device thus configured is described below. FIG. 7 shows a timing by which the voltage level of the clock output signal changes between VSS and VDD2 in accordance with the gate terminal of the Pch transistor 107 (A potential), the gate terminal of the Pch transistor 108 (B potential) and the gate terminal of the Nch transistor 109 (C potential). FIG. 8 shows a timing by which the voltage level of the clock output signal changes between VDD2 and VDD1 in accordance with the gate terminal of the Pch transistor 107 (A potential), the gate terminal of the Pch transistor 108 (B potential) and the gate terminal of the Nch transistor 109 (C potential).

Below are described states of the clock output signal changing between VSS and VDD2 and the clock output signal changing between VDD2 and VDD1 from Time 1 through Time 3.

Operation of Clock Output Signal Changing Between VSS and VDD2

Operation at Time 1

LOW is inputted from the pulse generator 210 to the gate terminal C of the Nch transistor 109. LOW is inputted from the pulse generator 210 to the gate terminal B of the Pch transistor 108. HIGH is inputted from the pulse generator 210 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. The clock in which the voltage level is changed from VSS to VDD2 is inputted from the clock signal line 103 to the first functional block 104. In the first flip-flop circuit 111, the internal data is retained since the voltage level is changed from VSS to VDD2 in the CK terminal thereof. The clock in which the voltage level is changed from VSS to VDD2 is inputted from the clock signal line 103 to the second functional block 105. In the second flip-flop circuit 112, the value of the D terminal is fetched since the voltage level is changed from VSS to VDD2 in the CK terminal thereof.

Operation Between Time 1 and Time 2

LOW is inputted from the pulse generator 210 to the gate terminal C of the Nch transistor 109. LOW is inputted from the pulse generator 210 to the gate terminal B of the Pch transistor 108. LOW is inputted from the pulse generator 210 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. The clock in which the voltage level is VDD2 is inputted from the clock signal line 103 to the first functional block 104. In the first flip-flop circuit 111, the internal data is retained since the voltage level is VDD2 in the CK terminal thereof. The clock in which the voltage level is VDD2 is inputted from the clock signal line 103 to the second functional block 105. In the second flip-flop circuit 112, the internal data is retained since the voltage level is VDD2 in the CK terminal thereof.

Operation at Time 2

HIGH is inputted from the pulse generator 210 to the gate terminal C of the Nch transistor 109. HIGH is inputted from the pulse generator 210 to the gate terminal B of the Pch transistor 108. HIGH is inputted from the pulse generator 210 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. The clock in which the voltage level is changed from VDD2 to VSS is inputted from the clock signal line 103 to the first functional block 104. In the first flip-flop circuit 111, the internal data is retained since the voltage level is changed from VDD2 to VSS in the CK terminal thereof. The clock in which the voltage level is changed from VDD2 to VSS is inputted from the clock signal line 103 to the second functional block 105. In the second flip-flop circuit 112, the internal data is retained since the voltage level is changed from VDD2 to VSS in the CK terminal thereof.

Operation Between Time 2 and Time 3

HIGH is inputted from the pulse generator 210 to the gate terminal C of the Nch transistor 109. HIGH is inputted from the pulse generator 210 to the gate terminal B of the Pch transistor 108. HIGH is inputted from the pulse generator 210 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The clock in which the voltage level is VSS is inputted from the clock signal line 103 to the first functional block 104. In the first flip-flop circuit 111, the internal data is retained since the voltage level is VSS in the CK terminal thereof. The clock in which the voltage level is VSS is inputted from the clock signal line 103 to the second functional block 105. In the second flip-flop circuit 112, the internal data is retained since the voltage level is VSS in the CK terminal thereof.

The operations from the Time 1 to the Time 3 so far described are repeated so that the first flip-flop circuit 111 continues to retain the internal data, while the second flip-flop circuit 112 fetches the data based on Cycle B.

Operation of Clock Output Signal Changing Between VDD 2 and VDD1

Operation at Time 1

LOW is inputted from the pulse generator 210 to the gate terminal C of the Nch transistor 109. HIGH is inputted from the pulse generator 210 to the gate terminal B of the Pch transistor 108. LOW is inputted from the pulse generator 210 to the gate terminal A of the Pch transistor 107. Since the gate potentials of the Nch transistor 109, the Pch transistor 108 and the Pch transistor 107 have the foregoing values, the voltage level is changed from VDD2 to VDD1 in the clock signal line 103. The clock in which the voltage level is changed from VDD2 to VDD1 is inputted from the clock signal line 103 to the first functional block 104. In the first flip-flop circuit 111, the value of the D terminal is fetched since the voltage level is changed from VDD2 to VDD1 in the CK terminal thereof. The clock in which the voltage level is changed from VDD2 to VDD1 is inputted from the clock signal line 103 to the second functional block 105. In the second flip-flop circuit 112, the internal data is retained since the voltage level is changed from VDD2 to VDD1 in the CK terminal thereof.

Operation Between Time 1 and 2

LOW is inputted from the pulse generator 210 to the gate terminal C of the Nch transistor 109. HIGH is inputted from the pulse generator 210 to the gate terminal B of the Pch transistor 108. LOW is inputted from the pulse generator 210 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. The clock in which the voltage level is VDD1 is inputted from the clock signal line 103 to the first functional block 104. In the first flip-flop circuit 111, the internal data is retained since the voltage level is VDD1 in the CK terminal thereof. The clock in which the voltage level is VDD1 is inputted from the clock signal line 103 to the second functional block 105. In the second flip-flop circuit 112, the internal data is retained since the voltage level is VDD1 in the CK terminal thereof.

Operation at Time 2

LOW is inputted from the pulse generator 210 to the gate terminal C of the Nch transistor 109. LOW is inputted from the pulse generator 210 to the gate terminal B of the Pch transistor 108. HIGH is inputted from the pulse generator 210 to the gate terminal A of the Pch transistor 107. Since the gate potentials of the Nch transistor 109, the Pch transistor 108 and the Pch transistor 107 have the foregoing values, the voltage level is changed from VDD1 to VDD2 in the clock signal line 103. The clock in which the voltage level is changed from VDD1 to VDD2 is inputted from the clock signal line 103 to the first functional block 104. In the first flip-flop circuit 111, the internal data is retained since the voltage level is changed from VDD1 to VDD2 in the CK terminal thereof. The clock in which the voltage level is changed from VDD1 to VDD2 is inputted from the clock signal line 103 to the second functional block 105. In the second flip-flop circuit 112, the internal data is retained since the voltage level is changed from VDD1 to VDD2 in the CK terminal thereof.

Operation Between Time 2 and 3

LOW is inputted from the pulse generator 210 to the gate terminal C of the Nch transistor 109. LOW is inputted from the pulse generator 210 to the gate terminal B of the Pch transistor 108. HIGH is inputted from the pulse generator 210 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. The clock in which the voltage level is VDD2 is inputted from the clock signal line 103 to the first functional block 104. In the first flip-flop circuit 111, the internal data is retained since the voltage level is VDD2 in the CK terminal thereof. The clock in which the voltage level is VDD2 is inputted from the clock signal line 103 to the second functional block 105. In the second flip-flop circuit 112, the internal data is retained since the voltage level is VDD2 in the CK terminal thereof.

The operations from the Time 1 to the Time 3 so far described are repeated so that the first flip-flop circuit 111 fetches the data based on Cycle B, while the second flip-flop circuit 112 continues to retain the internal data.

When the output signal from the pulse generator 210 is thus changed, only the functional block that is desirably halted can be arbitrarily halted through one clock signal line. In the foregoing description of the present embodiment, the two different threshold voltages are provided for the flip-flop circuits, however, there may be at least three different threshold voltages.

### Embodiment 3

As disadvantages in the embodiments 1 and 2, the clock having the voltage level of VDD2, which is unnecessary, is inputted to the first functional block, and the clock having the voltage level of VDD1, which is twice as much as the threshold voltage, is inputted to the second functional block. As a result, power consumption is unfavorably increased. An embodiment 3 of the present invention improves the disadvantages.

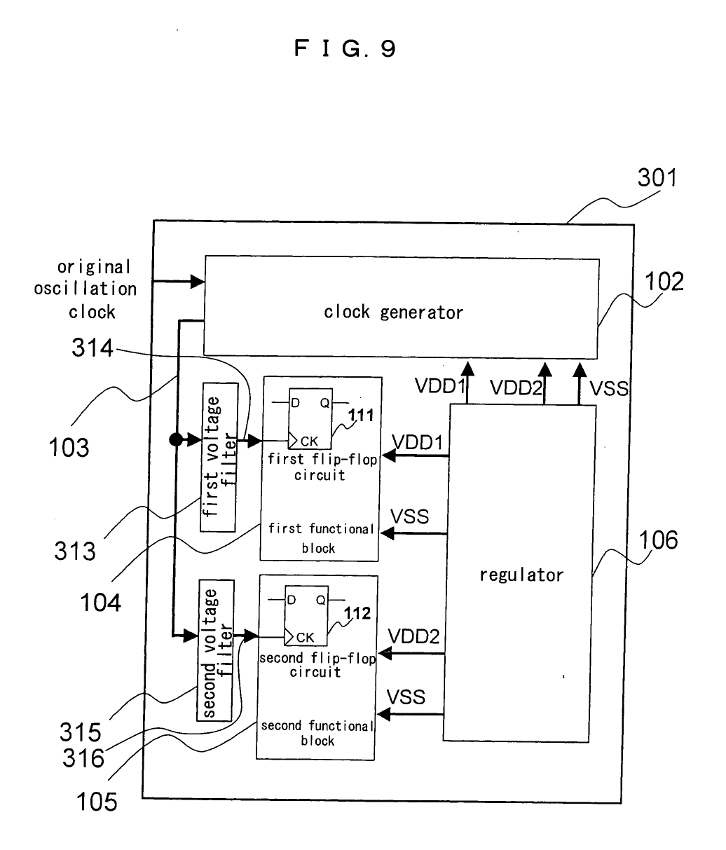

FIG. 9 is a block diagram illustrating a configuration of a semiconductor integrated circuit device according to the embodiment 3. A semiconductor integrated circuit device 301 comprises a clock generator (clock supplier) 102, a clock signal line 103, a first functional block (first function executor) 104, a second functional block (second function executor) 105, a regulator (voltage supplier) 106, a first voltage filter (first voltage converter) 313, a first clock signal line 314, a second voltage filter (second voltage converter) 315, and a second clock signal line 316. The first functional block 104 comprises a first flip-flop circuit (first retainer) 111. The second functional block 105 comprises a second flip-flop circuit (second retainer) 112.

The clock signal line 103 supplies a clock signal outputted from the clock generator 102 to the first voltage filter 313 and the second voltage filter 315.

The first voltage filter 313 supplies VDD1 when a potential of the clock signal supplied via the clock signal line 103 is at least VDD1 and supplies VSS when the potential of the clock signal is below VDD1 respectively to the first clock signal line 314.

The first clock signal line 314 supplies the potential outputted from the first voltage filter 313 to the first functional block 104. The second voltage filter 315 supplies VDD2 when the potential of the clock signal supplied via the clock signal line 103 is at least VDD2 and supplies VSS when the potential of the clock signal is below VDD2 respectively to the second clock signal line 316. The second clock signal line 316 supplies the potential outputted from the second voltage filter 315 to the second functional block 105. The first and second functional blocks are configured in the same manner as described in the embodiments 1 and 2.

An operation of the semiconductor integrated circuit device thus configured is described below. As described earlier, in the timing cart of FIG. 3, the relationship among the gate terminal of the Pch transistor 107 (A potential), the gate terminal of the Pch transistor 108 (B potential), the gate terminal of the Nch transistor 109 (C potential) and the clock signal outputted from the clock generator 102 and transmitted by the clock signal line 103 is illustrated.

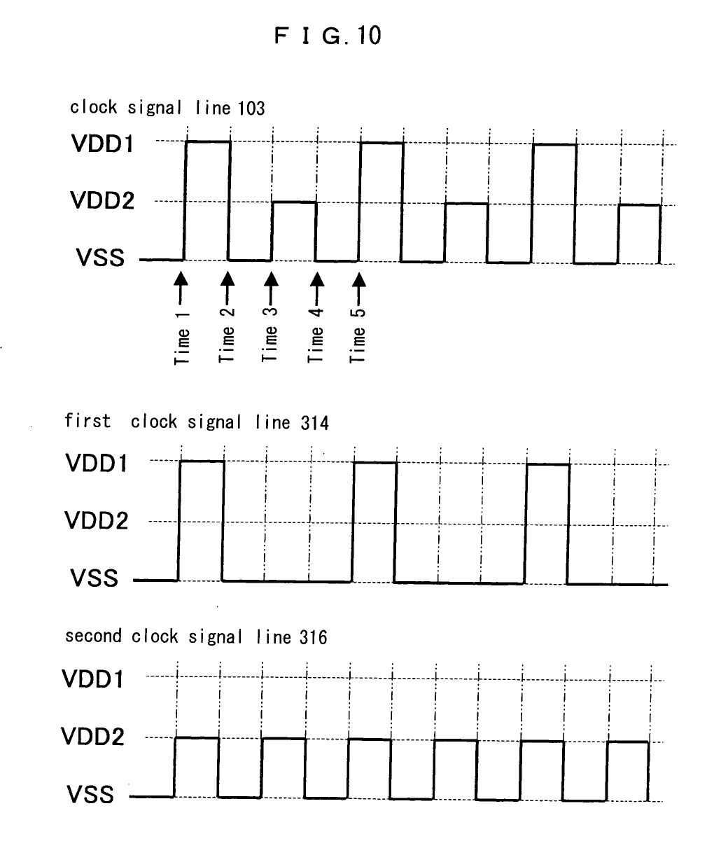

FIG. 10 is a timing chart for illustrating a relationship among the potential of the clock signal line 103, the potential of the clock signal line 314 and the potential of the clock signal line 316. Below are described operations in Time 1-Time 5 shown in FIGS. 3 and 10.

Operation at Time 1

LOW is inputted from the pulse generator 110 to the gate terminal C of the Nch transistor 109. HIGH is inputted from the pulse generator 110 to the gate terminal B of the Pch transistor 108. LOW is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. The voltage changed from VSS to VDD1 is inputted from the clock signal line 103 to the first voltage filter 313. Thereby, the first voltage filter 313 supplies the voltage changed from VSS to VDD1 to the first clock signal line 314. The voltage changed from VSS to VDD1 is inputted from the first voltage filter 313 to the first clock signal line 314. Thereby, the first clock signal line 314 supplies the voltage changed from VSS to VDD1 to the first functional block 104.

The clock in which voltage level is changed from VSS to VDD1 is inputted from the first clock signal line 314 to the first functional block 104. In the first flip-flop circuit 111, the value of the D terminal is fetched since the voltage level is changed from VSS to VDD1 in the CK terminal thereof. The voltage changed from VSS to VDD1 is inputted from the clock signal line 103 to the second voltage filter 315. Thereby, the second voltage filter 315 supplies the voltage changed from VSS to VDD2 to the second clock signal line 316. The voltage changed from VSS to VDD2 is inputted from the second voltage filter 315 to the second clock signal line 316. Thereby, the second clock signal line 316 supplies the voltage changed from VSS to VDD2 to the second functional block 105.

The clock in which the voltage level is changed from VSS to VDD2 is inputted from the second clock signal line 316 to the second functional block 105. In the second flip-flop circuit 112, the value of the D terminal is fetched since the voltage level is changed from VSS to VDD2 in the CK terminal thereof.

Operation Between Time 1 and Time 2

LOW is inputted from the pulse generator 110 to the gate terminal C of the Nch transistor 109. HIGH is inputted from the pulse generator 110 to the gate terminal B of the Pch transistor 108. LOW is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. The voltage of VDD1 is inputted from the clock signal line 103 to the first voltage filter 313. Thereby, the first voltage filter 313 supplies the voltage of VDD1 to the first clock signal line 314. The voltage of VDD1 is inputted from the first voltage filter 313 to the first clock signal line 314. Thereby, the first clock signal line 314 supplies the voltage of VDD1 to the first functional block 104. The clock in which the voltage level is VDD1 is inputted from the first clock signal line 314 to the first functional block 104. In the first flip-flop circuit 111, the internal data is retained since the voltage level is VDD1 in the CK terminal thereof. The voltage of VDD1 is inputted from the clock signal line 103 to the second voltage filter 315. Thereby, the second voltage filter 315 supplies the voltage of VDD2 to the second clock signal line 316. The voltage of VDD2 is inputted from the second voltage filter 315 to the second clock signal line 316. Thereby, the second clock signal line 316 supplies the voltage of VDD2 to the second functional block 105. The clock in which the voltage level is VDD2 is inputted from the second clock signal line 316 to the second functional block 105. Thereby, the internal data is retained in the second flip-flop circuit 112 since the voltage level is VDD2 in the CK terminal thereof.

Operation at Time 2

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103. The voltage changed from VDD1 to VSS VDD1 is inputted from the clock signal line 103 to the first voltage filter 313. Thereby, the first voltage filter 313 supplies the voltage changed from VDD1 to VSS to the first clock signal line 314. The voltage changed from VDD1 to VSS is inputted from the first voltage filter 313 to the first clock signal line 314. Thereby, the first clock signal line 314 supplies the voltage changed from VDD1 to VSS to the first functional block 104. The clock in which the voltage level is changed from VDD1 to VSS is inputted from the first clock signal line 314 to the first functional block 104. In the first flip-flop circuit 111, the internal data is retained since the voltage level is changed from VDD1 to VSS in the CK terminal thereof. The voltage changed from VDD1 to VSS is inputted from the clock signal line 103 to the second voltage filter 315. Thereby, the second voltage filter 315 supplies the voltage changed from VDD2 to VSS to the second clock signal line 316. The voltage changed from VDD2 to VSS is inputted from the second voltage filter 315 to the second clock signal line 316. Thereby, the second clock signal line 316 supplies the voltage changed from VDD2 to VSS to the second functional block 105. The clock whose voltage level is changed from VDD2 to VSS is inputted from the second clock signal line 316 to the second functional block 105. Thereby, the internal data is retained in the second flip-flop circuit 112 since the voltage level is changed from VDD2 to VSS in the CK terminal thereof.

Operation Between Time 2 and 3

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The voltage of VSS is inputted from the clock signal line 103 to the first voltage filter 313. Thereby, the first voltage filter 313 supplies the voltage of VSS to the first clock signal line 314. The voltage of VSS is inputted from the first voltage filter 313 to the first clock signal line 314. Thereby, the first clock signal line 314 supplies the voltage of VSS to the first functional block 104. The clock in which the voltage level is VSS is inputted from the first clock signal line 314 to the first functional block 104. In the first flip-flop circuit 111, the internal data is retained since the voltage level is VSS in the CK terminal thereof. The voltage of VSS is inputted from the clock signal line 103 to the second voltage filter 315, and the second clock signal line 316 is thereby supplied with the voltage of VSS. The voltage of VSS is inputted from the second voltage filter 315 to the second clock signal line 316, and the second functional block 105 is thereby supplied with the voltage of VSS. The clock in which the voltage level is VSS is inputted from the second clock signal line 316 to the second functional block 105. Thereby, the internal data is retained in the second flip-flop circuit 112 since the voltage level is VSS in the CK terminal thereof.

Operation at Time 3

LOW is inputted from the pulse generator 110 to the gate terminal C of the Nch transistor 109. LOW is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. The voltage changed from VSS to VDD2 is inputted from the clock signal line 103 to the first voltage filter 313. Thereby, the first voltage filter 313 supplies the voltage of VSS to the first clock signal line 314. The voltage of VSS is inputted from the first voltage filter 313 to the first clock signal line 314. Thereby, the first clock signal line 314 supplies the voltage of VSS to the first functional block 104. The clock whose the voltage level is VSS is inputted from the first clock signal line 314 to the first functional block 104. In the first flip-flop circuit 111, the internal data is retained since the voltage level is VSS in the CK terminal thereof. The voltage changed from VSS to VDD2 is inputted from the clock signal line 103 to the second voltage filter 315. Thereby, the second voltage filter 315 supplies the voltage changed from VSS to VDD2 to the second clock signal line 316. The voltage changed from VSS to VDD2 is inputted from the second voltage filter 315 to the second clock signal line 316. Thereby, the second clock signal line 316 supplies the voltage changed from VSS to VDD2 to the second functional block 105. The clock whose voltage level is changed from VSS to VDD2 is inputted from the second clock signal line 316 to the second functional block 105. Thereby, the value of the D terminal is fetched in the second flip-flop circuit 112 since the voltage level is changed from VSS to VDD2 in the CK terminal thereof.

Operation Between Time 3 and 4

LOW is inputted from the pulse generator 110 to the gate terminal C of the Nch transistor 109. LOW is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. The voltage of VDD2 is inputted from the clock signal line 103 to the first voltage filter 313. Thereby, the first voltage filter 313 supplies the voltage of VSS to the first clock signal line 314. The voltage of VSS is inputted from the first voltage filter 313 to the first clock signal line 314. Thereby, the first clock signal line 314 supplies the voltage of VSS to the first functional block 104. The clock whose voltage level is VSS is inputted from the first clock signal line 314 to the first functional block 104. In the first flip-flop circuit 111, the internal data is retained since the voltage level is VSS in the CK terminal thereof. The voltage of VDD2 is inputted from the clock signal line 103 to the second voltage filter 315. Thereby, the second voltage filter 315 supplies the voltage of VDD2 to the second clock signal line 316. The voltage of VDD2 is inputted from the second voltage filter 315 to the second clock signal line 316. Thereby, the second clock signal line 316 supplies the voltage of VDD2 to the second functional block 105. The clock whose voltage level is VDD2 is inputted from the second clock signal line 316 to the second functional block 105. Thereby, the internal data is retained in the second flip-flop circuit 112 since the voltage level is VDD2 in the CK terminal thereof.

Operation at Time 4

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. The voltage changed from VDD2 to VSS is inputted from the clock signal line 103 to the first voltage filter 313. Thereby, the first voltage filter 313 supplies the voltage of VSS to the first clock signal line 314. The voltage of VSS is inputted from the first voltage filter 313 to the first clock signal line 314. Thereby, the first clock signal line 314 supplies the voltage of VSS to the first functional block 104. The clock whose the voltage level is VSS is inputted from the first clock signal line 314 to the first functional block 104. In the first flip-flop circuit 111, the internal data is retained since the voltage level is VSS in the CK terminal thereof. The voltage changed from VDD2 to VSS is inputted from the clock signal line 103 to the second voltage filter 315. Thereby, the second voltage filter 315 supplies the voltage changed from VDD2 to VSS to the second clock signal line 316. The voltage changed from VDD2 to VSS is inputted from the second voltage filter 315 to the second clock signal line 316. Thereby, the second clock signal line 316 supplies the voltage changed from VDD2 to VSS to the second functional block 105. The clock whose voltage level is changed from VDD2 to VSS is inputted from the second clock signal line 316 to the second functional block 105. Thereby, the internal data is retained in the second flip-flop circuit 112 since the voltage level is changed from VDD2 to VSS in the CK terminal thereof.

Operation Between Time 4 and 5

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The voltage of VSS is inputted from the clock signal line 103 to the first voltage filter 313. Thereby, the first voltage filter 313 supplies the voltage of VSS to the first clock signal line 314. The voltage of VSS is inputted from the first voltage filter 313 to the first clock signal line 314. Thereby, the first clock signal line 314 supplies the voltage of VSS to the first functional block 104. The clock whose the voltage level is VSS is inputted from the first clock signal line 314 to the first functional block 104. In the first flip-flop circuit 111, the internal data is retained since the voltage level is VSS in the CK terminal thereof. The voltage of VSS is inputted from the clock signal line 103 to the second voltage filter 315. Thereby, the second voltage filter 315 supplies the voltage of VSS to the second clock signal line 316. The voltage of VSS is inputted from the second voltage filter 315 to the second clock signal line 316. Thereby, the second clock signal line 316 supplies the voltage of VSS to the second functional block 105. The clock whose voltage level is VSS is inputted from the second clock signal line 316 to the second functional block 105. Thereby, the internal data is retained in the second flip-flop circuit 112 since the voltage level is VSS in the CK terminal thereof.

The operations from the Time 1 to the Time 5 so far described are repeated so that only the voltage of VDD1 or VSS is supplied to the first functional block, and only the voltage of VDD2 or VSS is supplied to the second functional block. As a result, the power consumption can be reduced. In the foregoing description of the present embodiment, the two different threshold voltages are provided for the flip-flop circuits, however, there may be at least three different threshold voltages.

### Embodiment 4

As a disadvantage of the embodiments 1 through 3, one cock signal line does not allow a frequency to be changed in a shifting operation and a capturing operation during a scan test. An embodiment 4 of the present invention improves the disadvantage.

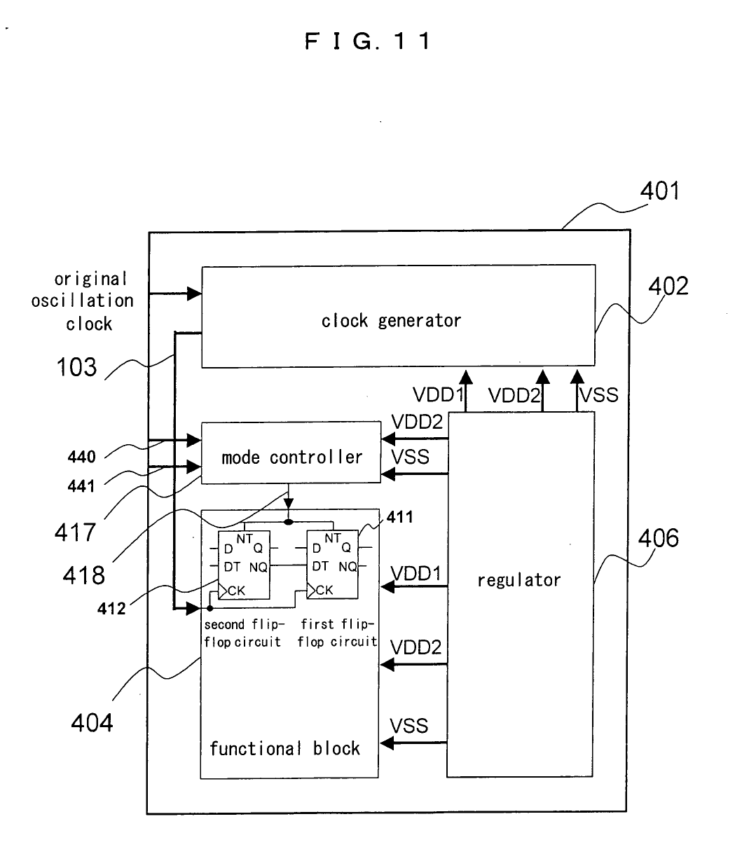

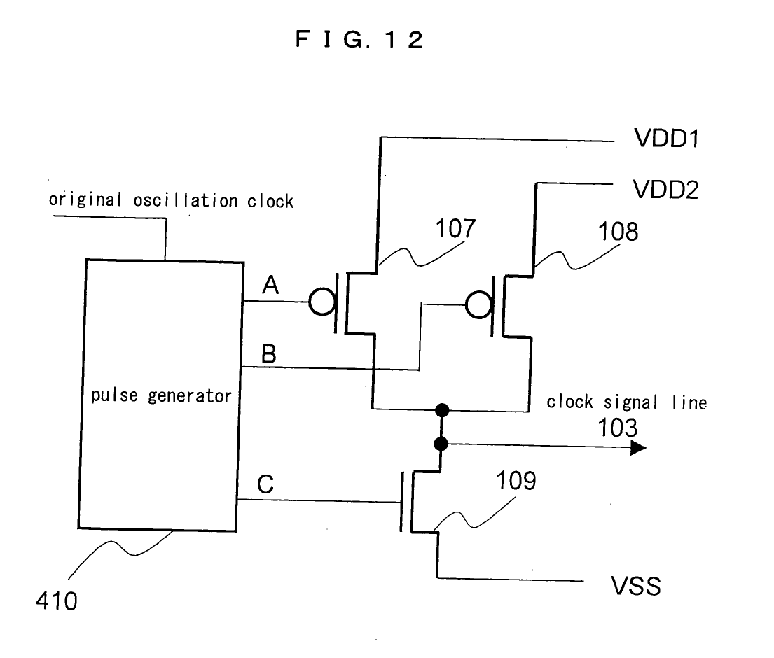

FIG. 11 is a block diagram illustrating a configuration of a semiconductor integrated circuit device according to the embodiment 4. FIG. 12 is a circuit diagram of a clock generator 402. A semiconductor integrated circuit device 401 comprises the clock generator (clock supplier) 402, a clock signal line 103, a functional block (function executor) 404, a regulator (voltage supplier) 406, and a mode controller 417. The clock signal line 103 supplies a clock signal outputted from the clock generator 402 to the functional block 404.

Power-supply voltages VDD1 and VDD2 and a reference voltage VSS are supplied from the regulator 406 to the clock generator 402. The clock generator 402 comprises, as shown in FIG. 12, a pulse generator 410, a Pch transistor 107, a Pch transistor 108 and an Nch transistor 109. An original oscillation clock from outside is connected to the pulse generator 410. A drain terminal of the Pch transistor 107 is connected to the power-supply voltage VDD1, and a gate terminal thereof is connected to the pulse generator 410. A drain terminal of the Pch transistor 108 is connected to the power-supply voltage VDD2, and a gate terminal thereof is connected to the pulse generator 410. The power-supply voltage VDD2 is lower than the power-supply voltage VDD1 (VDD2<VDD1). A drain terminal of the Nch transistor 109 is connected to a source terminal of the transistor 107, and a source terminal of the transistor 108 and the clock signal line 103. A gate terminal of the transistor 109 is connected to the pulse generator 410, and a source terminal thereof is connected to VSS.

A scan test signal 440 and an external shift enable signal 441 are inputted from outside to the mode controller 417, and an internal shift enable signal 418 of the mode controller 417 is connected to the functional block 404. In the mode controller thus connected, HIGH is outputted as the internal shift enable signal 418 when the scan test signal 440 and the external shift enable signal 441 are both HIGH, while LOW is outputted otherwise.

The functional block 404 comprises a first flip-flop circuit 411 and a second flip-flop circuit 412 serving as retainers.

The first flip-flop circuit 411 comprises a D input terminal connected to a logic in a previous stage, a Q output terminal connected to a logic in a subsequent stage, an NQ output terminal which is connected to a scan chain subsequent thereto and outputs an inversion logic of the Q output terminal, an NT input terminal to which the internal shift enable signal 418 is inputted from the mode controller 417, a DT input terminal connected to an NQ output terminal of the second flip-flop circuit 412, and a CK input terminal to which a clock is inputted from the clock signal line 103.

The second flip-flop circuit 411 comprises a D input terminal connected to a logic in a previous stage, a Q output terminal connected to a logic in a subsequent stage, the NQ output terminal which is connected to the DT input terminal of the first flip-flop circuit 411 subsequent thereto and outputs an inversion logic of the Q output terminal, an NT input terminal to which the internal shift enable signal 418 is inputted from the mode controller 417, a DT input terminal connected to the scan chain in a previous stage, and a CK input terminal to which the clock is inputted from the clock signal line 103.

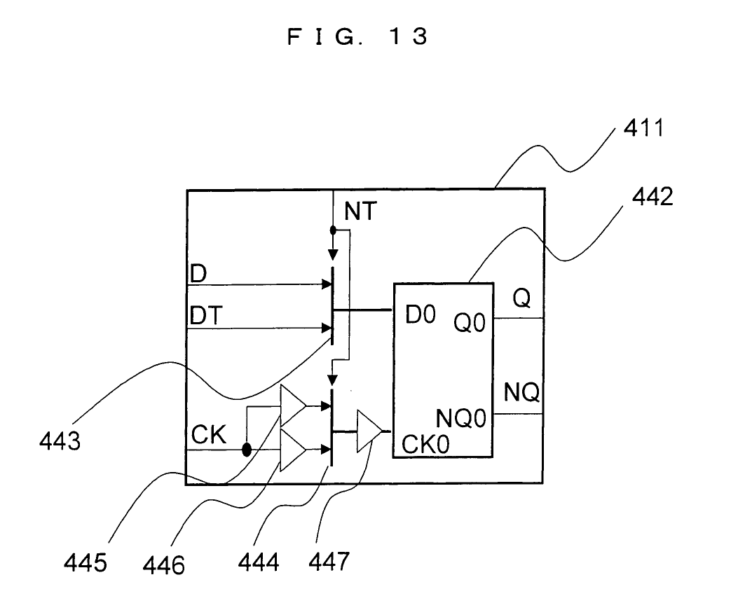

FIG. 13 shows a configuration of the first flip-flop circuit 411. The first flip-flop circuit 411 comprises a two-input selector (first selector) 443, a first buffer 445, a second buffer 446, a two-input selector (second selector) 444, a third buffer 447, and a data flip-flop 442.

A selection terminal of the two-input selector 443 is connected to the NT input terminal, a first input terminal thereof is connected to the D input terminal, a second input terminal thereof is connected to the DT input terminal, and an output terminal thereof is connected to a D0 terminal of the data flip-flop 442. A value of the first input terminal is inputted to the two-input selector 443 when the selection terminal thereof is at the LOW level, while a value of the second input terminal is inputted thereto when the selection terminal thereof is at the HIGH level.

An input terminal of the first buffer 445 is connected to the CK input terminal, and HIGH is outputted from the first buffer 445 when a potential of the CK input terminal is at least Level A (second threshold value). An input terminal of the second buffer 446 is connected to the CK input terminal, and HIGH is outputted from the second buffer 446 when a potential of the CK input terminal is at least Level B (first threshold value). A relationship between the Levels A and B is Level A<Level B.

A selection terminal of the two-input selector 444 is connected to the NT input terminal, a first input terminal thereof is connected to an output terminal of the first buffer 445, and a second input terminal thereof is connected to an output terminal of the second buffer 446. A value of the first input terminal is inputted to the two-input selector 444 when the selection terminal thereof is at the LOW level, while a value of the second input terminal is inputted thereto when the selection terminal thereof is at the HIGH level.

An input terminal of the third buffer 447 is connected to an output terminal of the two-input selector 444, and an output terminal thereof is connected to a CK0 input terminal of the data flip-flop 442, wherein an internal delay that is enough for the D0 input terminal of the data flip-flop 442 to fetch data in a stable manner is included.

A Q0 output terminal of the data flip-flop 442 is connected to the Q output terminal, and an NQ0 output terminal thereof is connected to the NQ output terminal.

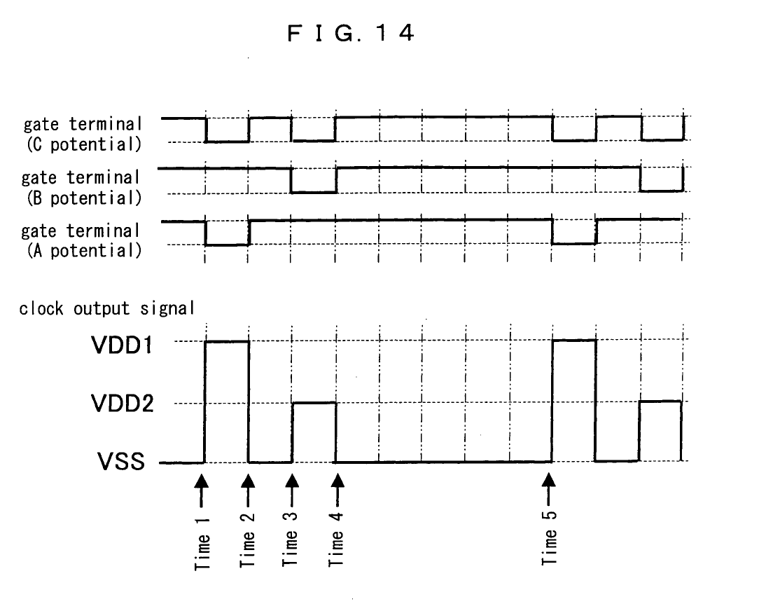

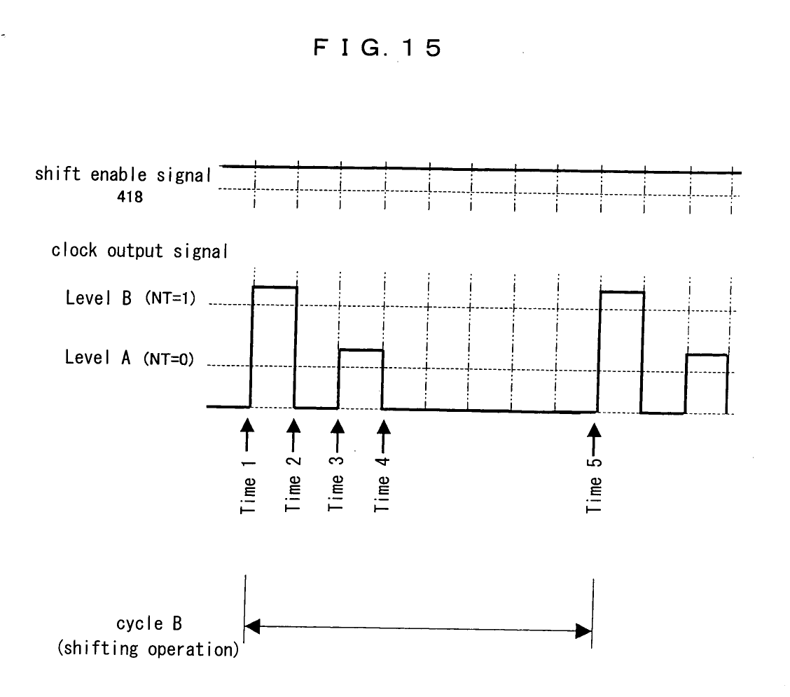

The second flip-flop circuit 412 is configured in the same manner as the first flip-flop circuit 411. The pulse generator 410 can supply potentials shown in FIGS. 14 and 15 to the gate terminal (A potential), the gate terminal (B potential) and the gate terminal (C potential).

The regulator 406 supplies the power-supply voltages VDD1 and VDD2 (VDD2<VDD1) and the reference voltage VSS to the clock generator 402, supplies the power-supply voltages VDD1 and VDD2 and the reference voltage VSS to the functional block 404, and supplies the power-supply voltage VDD2 and the reference voltage VSS to the mode controller 417.

An operation of the semiconductor integrated circuit device thus configured is described referring to three cases of i) normal operation, ii) shifting operation in the scan test, and iii) capturing operation in the scan test.

i) Normal Operation

LOW is inputted as the scan test signal 440, and LOW is inputted as the external shift enable signal 441. The mode controller 417 outputs LOW as the internal shift enable signal 418 in response to the input of the foregoing signal values to the input terminal thereof. LOW from the mode controller 417 and the clock from the clock generator 402 are inputted to the first functional block. LOW is inputted to the NT input terminals of the first flip-flop circuit 411 and the second flip-flop circuit 412, while the clock is inputted to the CK input terminals thereof. The first flip-flop circuit 411 and the second flip-flop circuit 412 fetch the values of the D input terminals when the potentials of the CK input terminals thereof changes from a potential lower than the Level A to a potential at least the Level A based on the input of LOW to the NT input terminals thereof, while retaining internal data otherwise.

ii) Shifting Operation in Scan Test

FIG. 14 is a timing chart for illustrating a relationship among the gate terminal (A potential) of the Pch transistor 107, the gate terminal (B potential) of the Pch transistor 108, the gate terminal (C potential) of the Nch transistor 109, and the clock signal outputted from the clock generator 402 and transmitted via the clock signal line 103. FIG. 15 is a timing chart for illustrating a relationship between the potential of the clock signal line 103 and the internal shift enable signal 418. Below are described operations in Time 1-Time 5 shown in FIGS. 14 and 15.

Operation at Time 1

LOW is inputted from the pulse generator 410 to the gate terminal C of the Nch transistor 109. HIGH is inputted from the pulse generator 410 to the gate terminal B of the Pch transistor 108. LOW is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404. HIGH is outputted to the NT terminals of the first flip-flop circuit 411 and the second flip-flop circuit 412. Since HIGH is inputted to the NT input terminals of the first flip-flop circuit 411 and the second flip-flop circuit 412, the DT input terminals thereof are thereby selected, and the threshold values of the CK input terminals turn to Level B. In the first flip-flop circuit 411 and the second flip-flop circuit 412, the values of the DT terminals are fetched since the voltage levels are changed from VSS to VDD1 in the CK input terminals thereof.

Operation Between Time 1 and Time 2

LOW is inputted from the pulse generator 410 to the gate terminal C of the Nch transistor 109. HIGH is inputted from the pulse generator 410 to the gate terminal B of the Pch transistor 108. LOW is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, based on which HIGH is supplied to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The first flip-flop circuit 411 and the second flip-flop circuit 412 retain the internal data since the voltage levels are VDD1 in the CK input terminals thereof.

Operation at Time 2

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are changed from VDD1 to VSS in the CK input terminals thereof.

Operation Between Time 2 and Time 3

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are VSS in the CK input terminals thereof.

Operation at Time 3

LOW is inputted from the pulse generator 410 to the gate terminal C of the Nch transistor 109. LOW is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are changed from VSS to VDD2 in the CK input terminals thereof.

Operation Between Time 3 and Time 4

LOW is inputted from the pulse generator 410 to the gate terminal C of the Nch transistor 109. LOW is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are maintained at VDD2 in the CK input terminals thereof.

Operation at Time 4

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are changed from VDD2 to VSS in the CK input terminals thereof.

Operation Between Time 4 and Time 5

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are VSS in the CK input terminals thereof.

When the operations from the Time 1 to the Time 5 so far described are repeated, the values of the DT input terminals are fetched based on Cycle B in the first flip-flop circuit 411 and the second flip-flop circuit 412 since the NT input terminals thereof are at the HIGH level.

iii) Capturing Operation in Scan Test

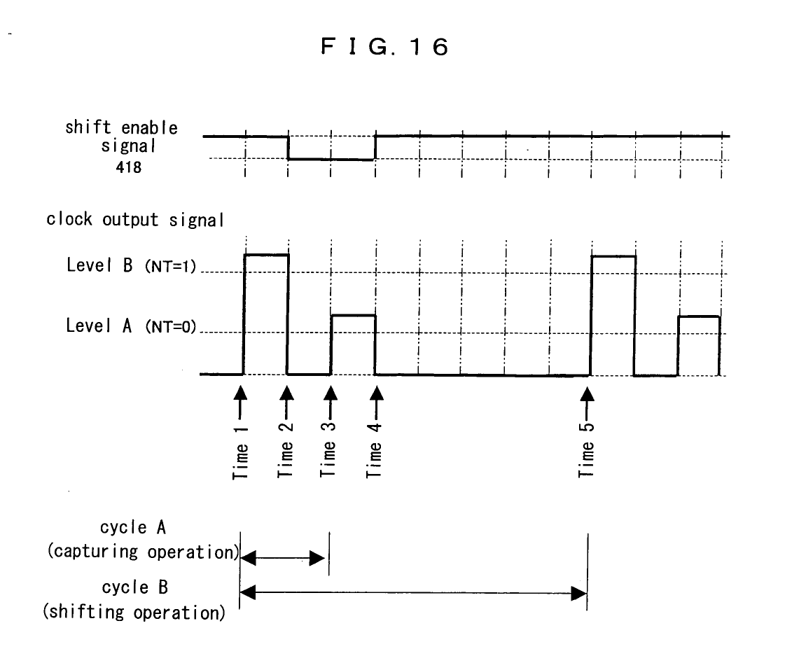

FIG. 16 is a timing chart for illustrating a relationship between the potential of the clock signal line 103 and the internal shift enable signal 418. Below are described operations from Time 1 through Time 5 shown in FIGS. 14 and 16.

Operation at Time 1

LOW is inputted from the pulse generator 410 to the gate terminal C of the Nch transistor 109. HIGH is inputted from the pulse generator 410 to the gate terminal B of the Pch transistor 108. LOW is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The values of the DT terminals are fetched in the first flip-flop circuit 411 and the second flip-flop circuit 412 since the voltage levels are changed from VSS to VDD1 in the CK input terminals thereof.

Operation Between Time 1 and Time 2

LOW is inputted from the pulse generator 410 to the gate terminal C of the Nch transistor 109. HIGH is inputted from the pulse generator 410 to the gate terminal B of the Pch transistor 108. LOW is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are VDD1 in the CK input terminals thereof.

Operation at Time 2

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103. HIGH is inputted as the scan test signal 440, and LOW is inputted as the external shift enable signal 441. LOW is outputted from the mode controller 417 as the internal shift enable signal 418 since the input terminal thereof has the foregoing value. LOW is inputted from the mode controller 417 to the functional block 404, and LOW is thereby supplied from the functional block 404 to the NT terminals of the first flip-flop circuit 411 and the second flip-flop circuit 412. Because LOW is inputted to the NT input terminals of the first flip-flop circuit 411 and the second flip-flop circuit 412, the D input terminals thereof are thereby selected, and the threshold values of the CK input terminals turn to the Level A. The internal data are retained in the first flip-flop circuit 411 and the second flip-flop circuit 412 since the voltage levels are changed from VDD1 to VSS in the CK input terminals thereof.

Operation Between Time 2 and Time 3

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. HIGH is inputted as the scan test signal 440, and LOW is inputted as the external shift enable signal 441. LOW is outputted from the mode controller 417 as the internal shift enable signal 418 since the input terminal thereof has the foregoing value. LOW is inputted from the mode controller 417 to the functional block 404, and LOW is thereby supplied from the functional block 404 to the NT terminals of the first flip-flop circuit 411 and the second flip-flop circuit 412. Because LOW is inputted to the NT input terminals of the first flip-flop circuit 411 and the second flip-flop circuit 412, the D input terminals thereof are thereby selected, and the threshold values of the CK input terminals turn to the Level A. The internal data are retained in the first flip-flop circuit 411 and the second flip-flop circuit 412 since the voltage levels are VSS in the CK input terminals thereof.

Operation at Time 3

LOW is inputted from the pulse generator 410 to the gate terminal C of the Nch transistor 109. LOW is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. HIGH is inputted as the scan test signal 440, and LOW is inputted as the external shift enable signal 441. LOW is outputted from the mode controller 417 as the internal shift enable signal 418 since the input terminal thereof has the foregoing value. LOW is inputted from the mode controller 417 to the functional block 404, and LOW is thereby supplied from the functional block 404 to the NT terminals of the first flip-flop circuit 411 and the second flip-flop circuit 412. Because LOW is inputted to the NT input terminals of the first flip-flop circuit 411 and the second flip-flop circuit 412, the D input terminals thereof are thereby selected, and the threshold values of the CK input terminals turn to the Level A. The values of the D input terminals are fetched in the first flip-flop circuit 411 and the second flip-flop circuit 412 since the voltage levels are changed from VSS to VDD2 in the CK input terminals thereof.

Operation Between Time 3 and Time 4

LOW is inputted from the pulse generator 410 to the gate terminal C of the Nch transistor 109. LOW is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. HIGH is inputted as the scan test signal 440, and LOW is inputted as the external shift enable signal 441. LOW is outputted from the mode controller 417 as the internal shift enable signal 418 since the input terminal thereof has the foregoing value. LOW is inputted from the mode controller 417 to the functional block 404, and LOW is thereby supplied from the functional block 404 to the NT terminals of the first flip-flop circuit 411 and the second flip-flop circuit 412. Because LOW is inputted to the NT input terminals of the first flip-flop circuit 411 and the second flip-flop circuit 412, the D input terminals thereof are thereby selected, and the threshold values of the CK input terminals turn to the Level A. The internal data are retained in the first flip-flop circuit 411 and the second flip-flop circuit 412 since the voltage levels are maintained at VDD2 in the CK input terminals thereof.

Operation at Time 4

HIGH is inputted from the pulse generator 410 to the gate terminal C of the Nch transistor 109. HIGH is inputted from the pulse generator 410 to the gate terminal B of the Pch transistor 108. HIGH is inputted from the pulse generator 410 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are changed from VDD2 to VSS in the CK input terminals thereof.

Operation Between Time 4 and Time 5

HIGH is inputted from the pulse generator 110 to the gate terminal C of the Nch transistor 109. HIGH is inputted from the pulse generator 110 to the gate terminal B of the Pch transistor 108. HIGH is inputted from the pulse generator 110 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. HIGH is inputted as the scan test signal 440, and HIGH is inputted as the external shift enable signal 441. HIGH is outputted from the mode controller 417 as the internal shift enable signal 418 since the input terminal thereof has the foregoing value. HIGH is inputted from the mode controller 417 to the functional block 404, and HIGH is thereby supplied from the functional block 404 to the NT terminals of the first flip-flop circuit 411 and the second flip-flop circuit 412. Because HIGH is inputted to the NT input terminals of the first flip-flop circuit 411 and the second flip-flop circuit 412, the DT input terminals thereof are thereby selected, and the threshold values of the CK input terminals turn to the Level B. The internal data are retained in the first flip-flop circuit 411 and the second flip-flop circuit 412 since the voltage levels are VSS in the CK input terminals thereof.

When the values of the D input terminals are thus fetched at Time 3 after the values of the DT input terminals are fetched at Time 1, the capturing operation can be based on Cycle A. When the clock waveform having the different levels and the shift enable signal are thus used to control the threshold values of the CK input terminals in the flip-flop circuits, the frequencies in the shifting and capturing operations can be changed.

### Embodiment 5

A disadvantage in the embodiment 4 is that the shifting operation is not possible without the shift enable signal. An embodiment 5 of the present invention improves the disadvantage.

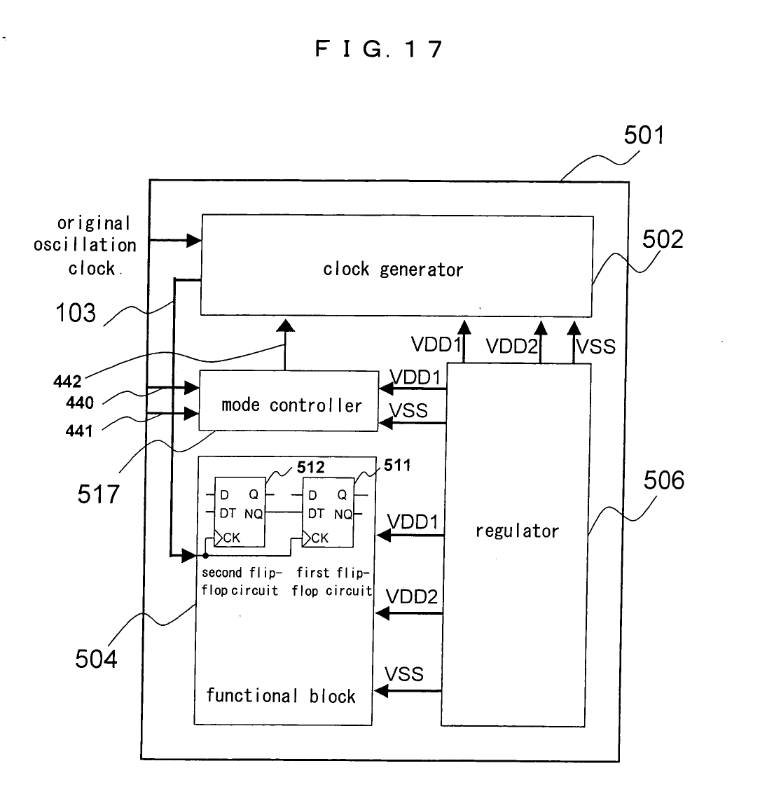

FIG. 17 is a block diagram illustrating a configuration of a semiconductor integrated circuit device according to the embodiment 5. A semiconductor integrated circuit device 501 comprises a clock generator (clock supplier) 502, a clock signal line 103, a functional block (function executor) 504, a regulator (voltage supplier) 506, and a mode controller (controller) 517.

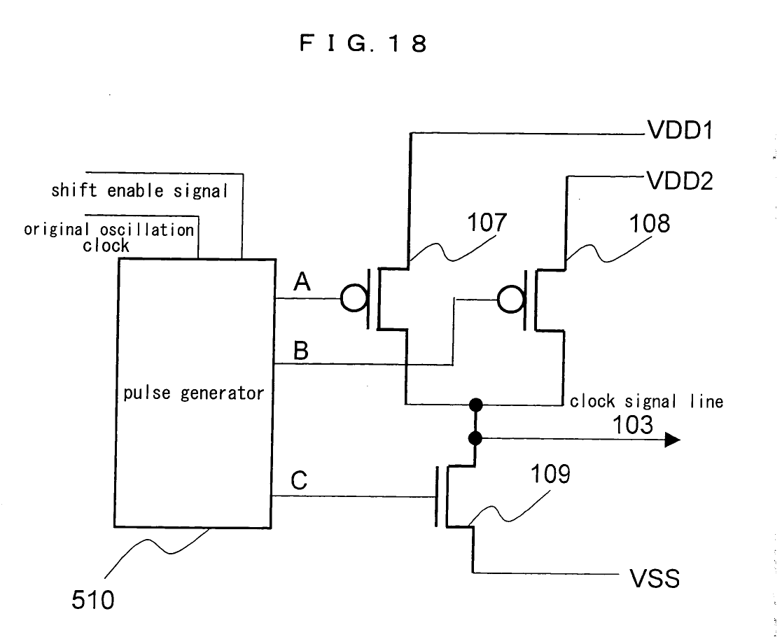

FIG. 18 is a circuit diagram of the clock generator 502. The clock generator 502 is supplied with power-supply voltages VDD1 and VDD2 and a reference voltage VSS from the regulator 506.

The clock generator 502 comprises a pulse generator 510, a Pch transistor 107, a Pch transistor 108, and an Nch transistor 109.

An original oscillation clock from outside and a shift enable signal 442 from the mode controller 417 are connected to the pulse generator 510. A drain terminal of the Pch transistor 107 is connected to the power-supply voltage VDD1, and a gate terminal thereof is connected to the pulse generator 510. A drain terminal of the Pch transistor 108 is connected to the power-supply voltage VDD2, and a gate terminal thereof is connected to the pulse generator 510. The power-supply voltage VDD2 is lower than the power-supply voltage VDD1. A drain terminal of the Nch transistor 109 is connected to a source terminal of the transistor 107, and a source terminal of the transistor 108 and the clock signal line 103. A gate terminal of the transistor 109 is connected to the pulse generator 510, and a source terminal thereof is connected to VSS.

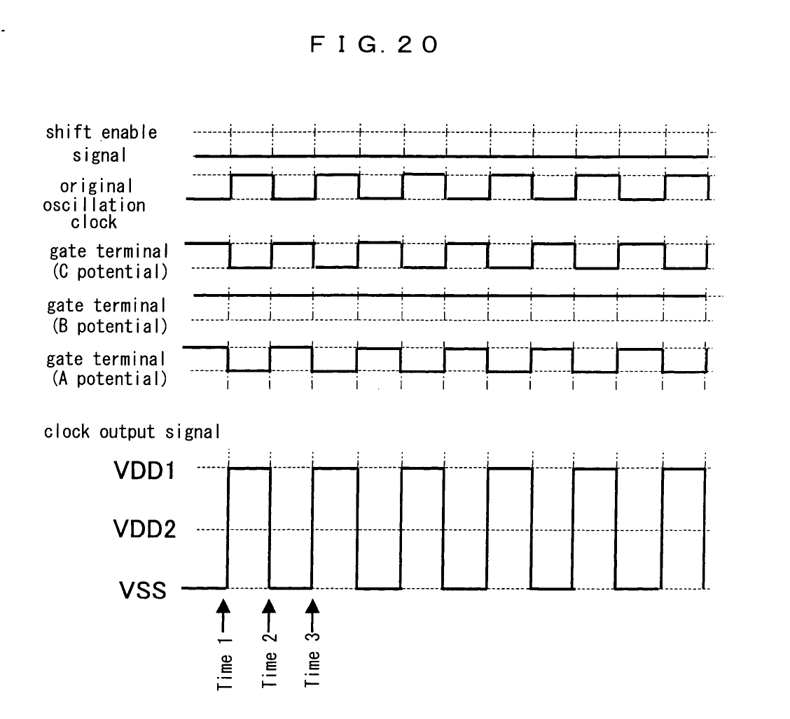

The pulse generator 510 can supply potentials shown in FIGS. 20, 21 and 22 to the gate terminal (A potential), the gate terminal (B potential), and the gate terminal (C potential).

The clock signal line 103 supplies a clock signal outputted from clock generator 502 to the functional block 504. The functional block 504 comprises a first flip-flop circuit 511 and a second flip-flop circuit 512 serving as retainers. Below is given only a description of the first flip-flop circuit 511 since the first flip-flop circuit 511 and the second flip-flop circuit 512 are configured in the same manner.

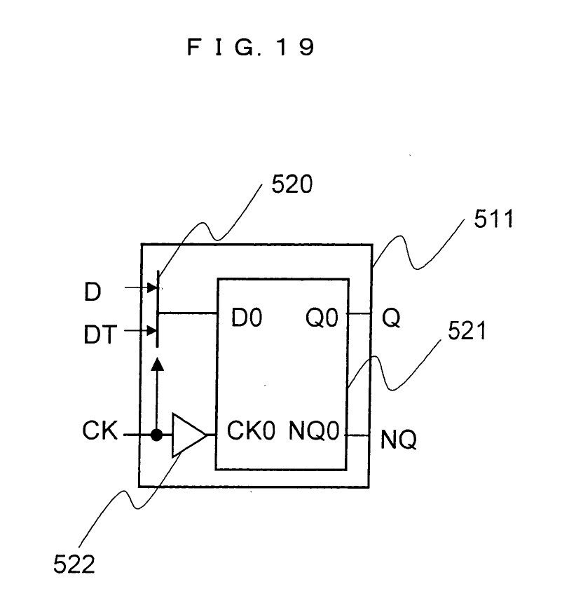

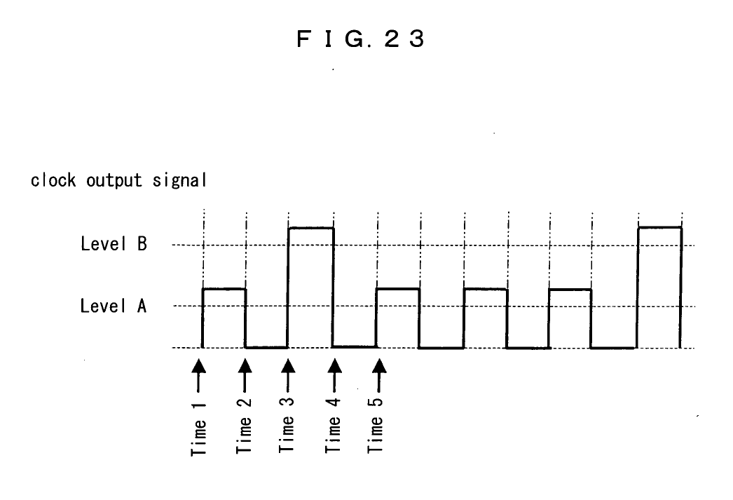

FIG. 19 shows a configuration of the first flip-flop circuit 511. FIG. 23 shows a relationship between the clock output signal and respective threshold values.

The first flip-flop circuit 511 comprises a two-input selector (selector) 502, a delay buffer 522, and a data flip-flop circuit 521. The two-input selector 520 comprises a D input terminal connected to a logic in a previous stage, a DT input terminal connected to a scan chain in a previous stage, and a CK input terminal to which a selection signal is inputted. In the two-input selector 520, the D input terminal is selected when the potential of the CK input terminal is a least Level B (first threshold value), while the DT input terminal is selected when the potential of the CK input terminal is lower than the Level B.

The delay buffer 522 adds a delay that is enough for the data flip-flop circuit 521 to fetch data in a stable manner to an input signal inputted from the CK input terminal.

The data flip-flop circuit 521 comprises a data input terminal D0, a clock input terminal CK0, a data output terminal Q0, and an inversion data output terminal NQ0. An output signal of the two-input selector 520 is connected to the data input terminal D0. The clock input terminal CK0 inputs therein an output signal of the delay buffer 522 as a clock input signal, and fetches the potential of the D0 input terminal when the potential of the CK input terminal changes from a potential lower than the Level A (second threshold value) to a potential at least the Level A. The data output terminal Q0 is connected to the Q output terminal. The inversion data output terminal NQ0 is connected to the NQ output terminal. The Levels A is lower than the Level B (Level A<Level B).

The DT input terminal of the first flip-flop circuit 511 and the NQ output terminal of the second flip-flop circuit 512 are connected to each other. The regulator 506 supplies the power-supply voltages VDD1 and VDD2 (VDD2<VDD1) and the reference voltage VSS to the clock generator 502. The regulator 506 supplies the power-supply voltages VDD1 and VDD2 and the reference voltage VSS to the functional block 504. The regulator 506 supplies the power-supply voltage VDD1 and the reference voltage VSS to the mode controller 517.

The mode controller 517 is supplied with the power-supply voltage VDD1 and the reference voltage VSS from the regulator 506 and a scan test signal 440 and an external shift enable signal 441 from outside. The mode controller 517 supplies the shift enable signal 442 to the clock generator 502. More specifically, HIGH is outputted as the shift enable signal 442 when the scan test signal 440 and the external shift enable signal 441 are both HIGH, while LOW is outputted otherwise.

An operation of the semiconductor integrated circuit device thus configured is described referring to three cases of i) normal operation, ii) shifting operation in the scan test, and iii) capturing operation in the scan test.

i) Normal Operation

FIG. 20 is a timing chart for illustrating a relationship among the shift enable signal 442, the original oscillation clock, the gate terminal (A potential) of the Pch transistor 107, the gate terminal (B potential) of the Pch transistor 108, the gate terminal (C potential) of the Nch transistor 109, and the clock signal outputted from the clock generator 502 and transmitted via the clock signal line 103 during the normal operation. Below are described operations from Time 1 through Time 3 shown in FIG. 20.

Operation at Time 1

LOW is inputted as the scan test signal 440. LOW is outputted as the shift enable signal 442 from the mode controller 517 since the scan test signal 440 has the foregoing value. LOW is inputted from the pulse generator 510 to the gate terminal C of the Nch transistor 109. HIGH is inputted from the pulse generator 510 to the gate terminal B of the Pch transistor 108. LOW is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. The clock in which the voltage level is changed from VSS to VDD1 is inputted from the clock signal line 103 to the functional block 504. In the first flip-flop circuit 511 and the second flip-flop circuit 512, the values of the D input terminals are fetched since the voltage levels are changed from VSS to VDD1 in the CK terminals thereof.

Operation Between Time 1 and Time 2

LOW is inputted as the scan test signal 440. LOW is outputted as the shift enable signal 442 from the mode controller 517 since the scan test signal 440 has the foregoing value. LOW is inputted from the pulse generator 510 to the gate terminal C of the Nch transistor 109. HIGH is inputted from the pulse generator 510 to the gate terminal B of the Pch transistor 108. LOW is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. The clock in which the voltage level is VDD1 is inputted from the clock signal line 103 to the functional block 504. In the first flip-flop circuit 511 and the second flip-flop circuit 512, the internal data are retained since the voltage levels are VDD1 in the CK terminals thereof.

Operation at Time 2

LOW is inputted as the scan test signal 440. LOW is outputted as the shift enable signal 442 from the mode controller 517 since the scan test signal 440 has the foregoing value. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103. The clock in which the voltage is changed from VDD1 to VSS is inputted from the clock signal line 103 to the functional block 504. In the first flip-flop circuit 511 and the second flip-flop circuit 512, the internal data are retained since the voltage levels are changed from VDD1 to VSS in the CK terminals thereof.

Operation Between Time 2 and Time 3

LOW is inputted as the scan test signal 440. LOW is outputted as the shift enable signal 442 from the mode controller 517 since the scan test signal 440 has the foregoing value. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The clock in which the voltage is VSS is inputted from the clock signal line 103 to the functional block 504. In the first flip-flop circuit 511 and the second flip-flop circuit 512, the internal data are retained since the voltage levels are VSS in the CK terminals thereof.

When the operations from the Time 1 through Time 3 are thus repeated, the data of the D input terminals are fetched when the potentials of the CK terminals are changed from VSS to VDD1.

ii) Shifting Operation in Scan Test

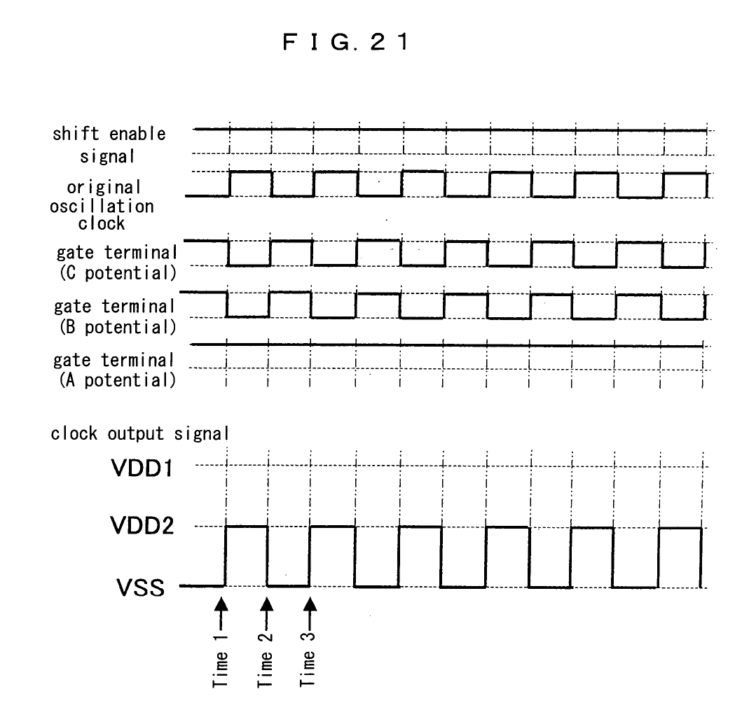

FIG. 21 is a timing chart for illustrating a relationship among the shift enable signal 442, the original oscillation clock, the gate terminal (A potential) of the Pch transistor 107, the gate terminal (B potential) of the Pch transistor 108, the gate terminal (C potential) of the Nch transistor 109, and the clock signal outputted from the clock generator 502 and transmitted via the clock signal line 103 during the shifting operation. Below are described operations from Time 1 through Time 3 shown in FIG. 21.

Operation at Time 1

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. LOW is inputted from the pulse generator 510 to the gate terminal C of the Nch transistor 109. LOW is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. The clock in which the voltage level is changed from VSS to VDD2 is inputted from the clock signal line 103 to the functional block 504. In the first flip-flop circuit 511 and the second flip-flop circuit 512, the values of the DT input terminals are fetched since the voltage levels are changed from VSS to VDD2 in the CK terminals thereof.

Operation Between Time 1 and Time 2

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. LOW is inputted from the pulse generator 510 to the gate terminal C of the Nch transistor 109. LOW is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. The clock in which the voltage level is VDD2 is inputted from the clock signal line 103 to the functional block 504. In the first flip-flop circuit 511 and the second flip-flop circuit 512, the internal data are retained since the voltage levels are VDD2 in the CK terminals thereof.

Operation at Time 2

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values.

HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. The clock in which the voltage is changed from VDD2 to VSS is inputted from the clock signal line 103 to the functional block 504. In the first flip-flop circuit 511 and the second flip-flop circuit 512, the internal data are retained since the voltage levels are changed from VDD2 to VSS in the CK terminals thereof.

Operation Between Time 2 and Time 3

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The clock in which the voltage level is VSS is inputted from the clock signal line 103 to the functional block 504. In the first flip-flop circuit 511 and the second flip-flop circuit 512, the internal data are retained since the voltage levels are VSS in the CK terminals thereof.

The operations from the Time 3 through the Time 3 are repeated because the NQ output terminal of the second flip-flop circuit 512 is connected to the DT input terminal of the first flip-flop circuit 511. Thereby, the shifting operation in which the data of the DT input terminals are fetched when the potentials of the CK terminals are changed from VSS to VDD2 is executed. The shifting operation allows an arbitrary value from outside to be stored in the flip-flop circuits.

iii) Capturing Operation in Scan Test

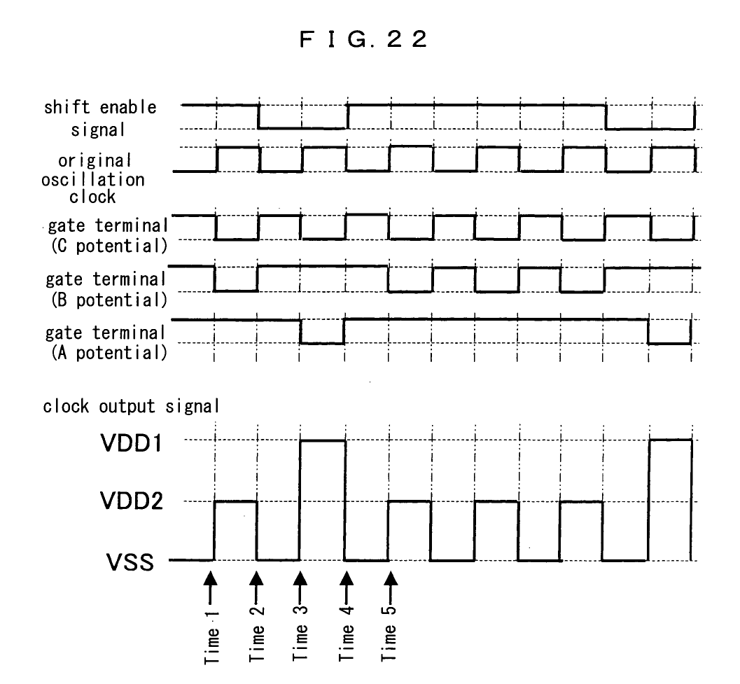

FIG. 22 is a timing chart for illustrating a relationship among the shift enable signal 442, the original oscillation clock, the gate terminal (A potential) of the Pch transistor 107, the gate terminal (B potential) of the Pch transistor 108, the gate terminal (C potential) of the Nch transistor 109, and the clock signal outputted from the clock generator 502 and transmitted by the clock signal line 103 during the scan test operation. Below are described operations from Time 1 through Time 5 shown in FIG. 22.

Operation at Time 1

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. LOW is inputted from the pulse generator 510 to the gate terminal C of the Nch transistor 109. LOW is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. The clock in which the voltage level is changed from VSS to VDD2 is inputted from the clock signal line 103 to the functional block 504. In the first flip-flop circuit 511 and the second flip-flop circuit 512, the values of the DT input terminals are fetched since the voltage levels are changed from VSS to VDD2 in the CK terminals thereof.

Operation Between Time 1 and Time 2

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. LOW is inputted from the pulse generator 510 to the gate terminal C of the Nch transistor 109. LOW is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. The clock in which the voltage is VDD2 is inputted from the clock signal line 103 to the functional block 504. In the first flip-flop circuit 511 and the second flip-flop circuit 512, the internal data are retained since the voltage levels are VDD2 in the CK terminals thereof.

Operation at Time 2

HIGH is inputted as the scan test signal 440. LOW is inputted as the external shift enable signal 441. LOW is outputted as the shift enable signal 442 from the mode controller 517 since the scan test signal 440 and the external shift enable signal 441 have the foregoing values. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. The clock in which the voltage is changed from VDD2 to VSS is inputted from the clock signal line 103 to the functional block 504. In the first flip-flop circuit 511 and the second flip-flop circuit 512, the internal data are retained since the voltage levels are changed from VDD2 to VSS in the CK terminals thereof.

Operation Between Time 2 and Time 3

HIGH is inputted as the scan test signal 440. LOW is inputted as the external shift enable signal 441. LOW is outputted as the shift enable signal 442 from the mode controller 517 since the scan test signal 440 and the external shift enable signal 441 have the foregoing values. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The clock in which the voltage level is VSS is inputted from the clock signal line 103 to the functional block 504. In the first flip-flop circuit 511 and the second flip-flop circuit 512, the internal data are retained since the voltage levels are VSS in the CK terminals thereof.

Operation at Time 3

HIGH is inputted as the scan test signal 440. LOW is inputted as the external shift enable signal 441. LOW is outputted as the shift enable signal 442 from the mode controller 517 since the scan test signal 440 and the external shift enable signal 441 have the foregoing values. LOW is inputted from the pulse generator 510 to the gate terminal C of the Nch transistor 109. HIGH is inputted from the pulse generator 510 to the gate terminal B of the Pch transistor 108. LOW is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. The clock in which the voltage level is changed from VSS to VDD1 is inputted from the clock signal line 103 to the functional block 504. In the first flip-flop circuit 511 and the second flip-flop circuit 512, the values of the DT input terminals are fetched since the voltage levels are changed from VSS to VDD1 in the CK terminals thereof.

Operation Between Time 3 and Time 4

HIGH is inputted as the scan test signal 440. LOW is inputted as the external shift enable signal 441. LOW is outputted as the shift enable signal 442 from the mode controller 517 since the scan test signal 440 and the external shift enable signal 441 have the foregoing values. LOW is inputted from the pulse generator 510 to the gate terminal C of the Nch transistor 109. HIGH is inputted from the pulse generator 510 to the gate terminal B of the Pch transistor 108. LOW is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. The clock in which the voltage is VDD1 is inputted from the clock signal line 103 to the functional block 504. In the first flip-flop circuit 511 and the second flip-flop circuit 512, the internal data are retained since the voltage levels are VDD1 in the CK terminals thereof.

Operation at Time 4

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103. The clock in which the voltage level is changed from VDD1 to VSS is inputted from the clock signal line 103 to the functional block 504. In the first flip-flop circuit 511 and the second flip-flop circuit 512, the internal data are retained since the voltage levels are changed from VDD1 to VSS in the CK terminals thereof.

Operation Between Time 4 and Time 5

HIGH is inputted as the scan test signal 440. HIGH is inputted as the external shift enable signal 441. HIGH is outputted as the shift enable signal 442 from the mode controller 517 since the scan test signal 440 and the external shift enable signal 441 have the foregoing values. HIGH is inputted from the pulse generator 510 to the gate terminal C of the Nch transistor 109. HIGH is inputted from the pulse generator 510 to the gate terminal B of the Pch transistor 108. HIGH is inputted from the pulse generator 510 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. The clock in which the voltage level is VSS is inputted from the clock signal line 103 to the functional block 504. In the first flip-flop circuit 511 and the second flip-flop circuit 512, the internal data are retained since the voltage levels are VSS in the CK terminals thereof.

As described, the data of the DT input terminals can be fetched when the shift enable signal 442 is at the HIGH level, while the data of the D input terminals are fetched when the shift enable signal 442 is at the LOW level.

Thus, the signals to be inputted to the flip-flop circuits can be selected via one clock signal line, which makes it unnecessary to additionally provide a signal line for the selection.

### Embodiment 6

A disadvantage in the embodiments 1 through 5 is that it is not possible to supply the data signal and the clock signal at one time via one clock signal line. An embodiment 6 of the present invention improves the disadvantage.

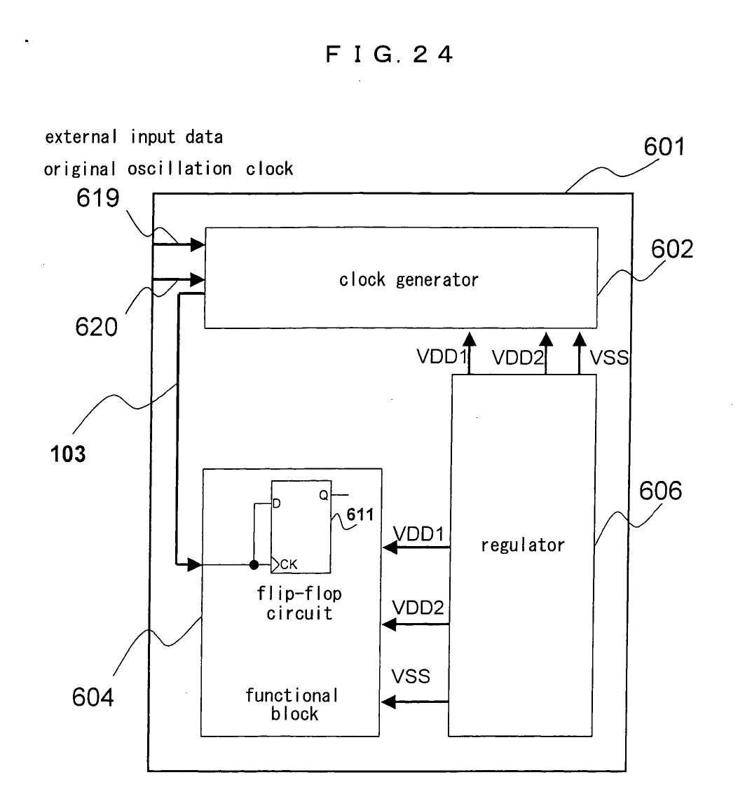

FIG. 24 is a block diagram illustrating a configuration of a semiconductor integrated circuit device according to the embodiment 6. A semiconductor integrated circuit device 601 comprises a clock generator (clock supplier) 602, a clock signal line 103, a functional block (function executor) 604, and a regulator 606.

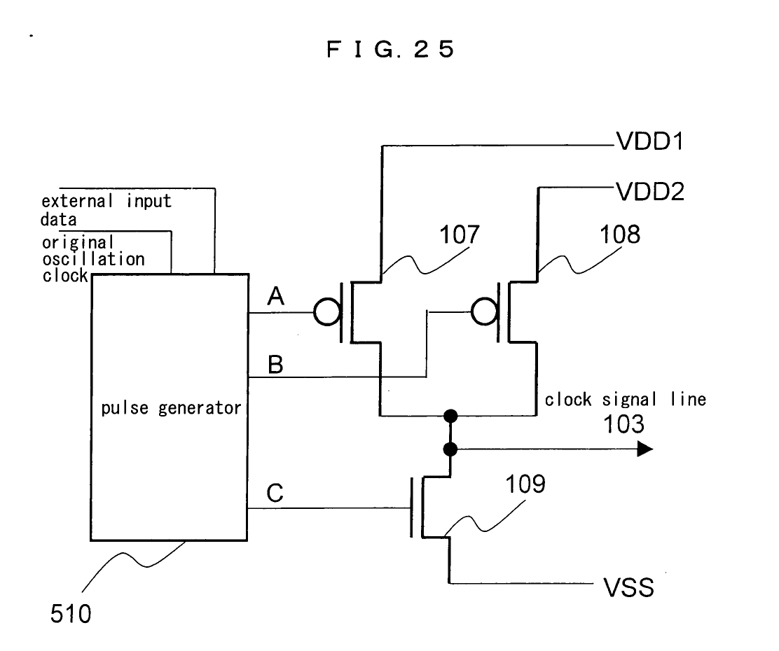

The clock generator 602 is supplied with power-supply voltages VDD1 and VDD2 and a reference voltage VSS from the regulator 606. FIG. 25 is a circuit diagram of the clock generator 602. The clock generator 602 comprises a pulse generator 610, a Pch transistor 107, a Pch transistor 108, and an Nch transistor 109. An original oscillation clock 620 and an external input data 619 from outside are connected to the pulse generator 610. A drain terminal of the Pch transistor 107 is connected to the power-supply voltage VDD1, and a gate terminal thereof is connected to the pulse generator 510. A drain terminal of the Pch transistor 108 is connected to the power-supply voltage VDD2, and a gate terminal thereof is connected to the pulse generator 610. The power-supply voltage VDD2 is lower than the power-supply voltage VDD1. A drain terminal of the Nch transistor 109 is connected to a source terminal of the transistor 107, and a source terminal of the transistor 108 and the clock signal line 103. A gate terminal of the transistor 109 is connected to the pulse generator 610, and a source terminal thereof is connected to VSS.

The clock signal line 103 supplies a clock signal outputted from the clock generator 602 to the functional block 604. The functional block 604 comprises a first flip-flop circuit (retainer) 611. In the first flip-flop circuit 611, a D input terminal and a CK input terminal thereof are connected to the clock signal line 103, and a Q output terminal thereof is connected to a logic in a subsequent stage.

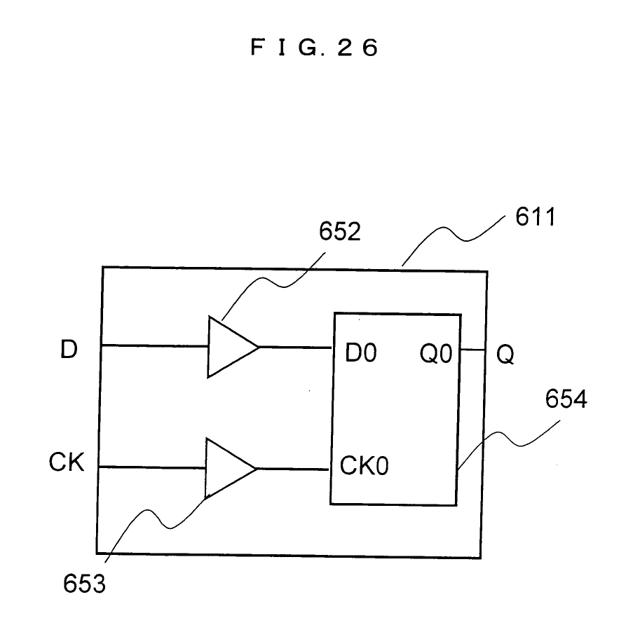

FIG. 26 shows a configuration of the flip-flop circuit 611. The flip-flop circuit 611 comprises a first buffer 652, a second buffer 653, and a data flip-flop 654.

An input terminal of the first buffer 652 is connected to the D input terminal of the flip-flop circuit 611, and an output terminal thereof is connected to a D0 input terminal of the data flip-flop 654. HIGH is outputted from the data buffer 652 when the potential of the D input terminal is at least Level B (first threshold value).

In the second buffer 653, an input terminal thereof is connected to the CK terminal of the flip-flop circuit 611, and an output terminal thereof is connected to a CK0 input terminal of the data flip-flop 654. The second buffer 653 includes an internal delay that is enough to accurately judge the potential of the D0 input terminal of the data flip-flop 654, and outputs HIGH when the potential of the CK input terminal is at least Level A (second threshold value). The Level A is lower than the Level B (Level A<Level B).

In the data flip-flop 654, a Q0 output terminal thereof is connected to the Q output terminal of the flip-flop circuit 611, and the value of the D0 input terminal is fetched when the potential of the CK0 input terminal is changed from LOW to HIGH.

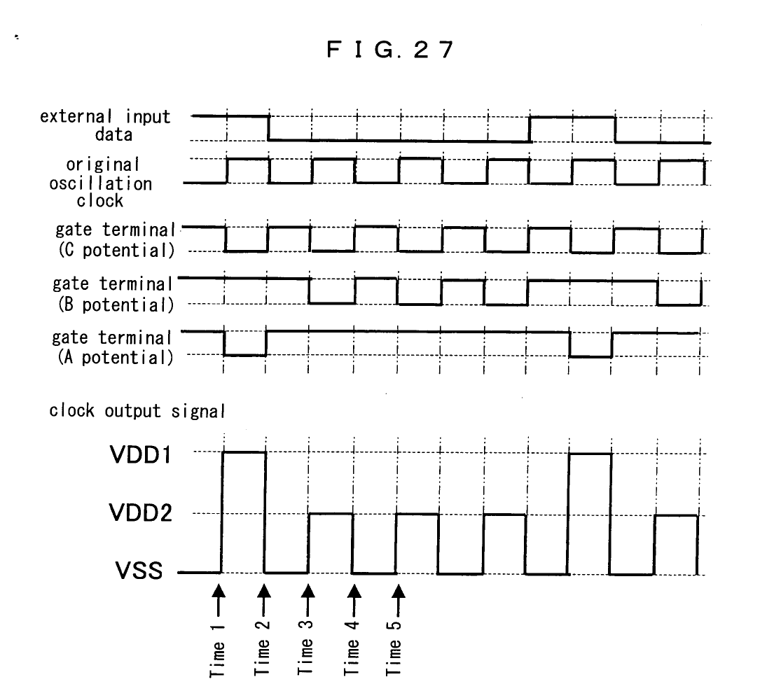

The pulse generator 610 can supply potentials shown in FIG. 27 to the original oscillation clock 620, the external input data 619, the gate terminal (A potential), the gate terminal (B potential), and the gate terminal (C potential)

The regulator 606 supplies power-supply voltages VDD1 and VDD2 (VDD2<VDD1) and a reference voltage VSS to the clock generator 602, and supplies the power-supply voltages VDD1 and VDD2 and the reference voltage VSS to the functional block 604.

An operation of the semiconductor integrated circuit device thus configured is described below.

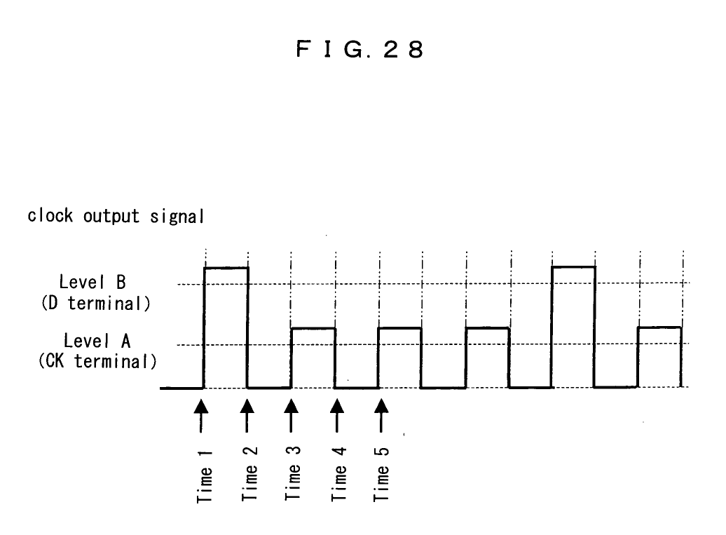

FIG. 27 is a timing chart for illustrating a relationship among the external input data 619, the original oscillation clock 620, the gate terminal (A potential) of the Pch transistor 107, the gate terminal (B potential) of the Pch transistor 108, the gate terminal (C potential) of the Nch transistor 109, and the clock signal outputted from the clock generator 602 and transmitted via the clock signal line 103. FIG. 28 is a timing chart for illustrating a relationship between the potential of the clock signal line 103 and the threshold values of the D input terminal and the CK input terminal of the flip-flop circuit 611. Below are described operations from Time 1 through Time 5 shown in FIGS. 27 and 28.

Operation at Time 1

HIGH as the external input data 619 and HIGH as the original oscillation clock 620 are inputted to the pulse generator 610. LOW is inputted from the pulse generator 610 to the gate terminal C of the Nch transistor 109. HIGH is inputted from the pulse generator 610 to the gate terminal B of the Pch transistor 108. LOW is inputted from the pulse generator 610 to the gate terminal A of the Pch transistor 107. Since the gate potentials of the Nch transistor 109, the Pch transistor 108 and the Pch transistor 107 have the foregoing values, the voltage level is changed from VSS to VDD1 in the clock signal line 103. In the first flip-flop circuit 611, HIGH is fetched since the voltage level is changed from VSS to VDD1 in the CK terminal thereof and the potential of the D input terminal thereof is at least the Level B.

Operation Between Time 1 and Time 2

HIGH as the external input data 619 and HIGH as the original oscillation clock 620 are inputted to the pulse generator 610. LOW is inputted from the pulse generator 610 to the gate terminal C of the Nch transistor 109. HIGH is inputted from the pulse generator 610 to the gate terminal B of the Pch transistor 108. LOW is inputted from the pulse generator 610 to the gate terminal A of the Pch transistor 107. Since the gate potentials of the Nch transistor 109, the Pch transistor 108 and the Pch transistor 107 have the foregoing values, the voltage level is maintained at VDD1 in the clock signal line 103. In the first flip-flop circuit 611, the internal data is retained since the voltage level is maintained at VDD1 in the CK terminal thereof and the potential of the D input terminal thereof is at least the Level B.

Operation at Time 2

LOW as the external input data 619 and LOW as the original oscillation clock 620 are inputted to the pulse generator 610. HIGH is inputted from the pulse generator 610 to the gate terminal C of the Nch transistor 109. HIGH is inputted from the pulse generator 610 to the gate terminal B of the Pch transistor 108. HIGH is inputted from the pulse generator 610 to the gate terminal A of the Pch transistor 107. Since the gate potentials of the Nch transistor 109, the Pch transistor 108 and the Pch transistor 107 have the foregoing values, the voltage level is changed from VDD1 to VSS in the clock signal line 103. In the first flip-flop circuit 611, the internal data is retained since the voltage level is changed from VDD1 to VSS in the CK terminal thereof and the potential of the D input terminal thereof is below the Level B.

Operation Between Time 2 and Time 3

LOW as the external input data 619 and LOW as the original oscillation clock 620 are inputted to the pulse generator 610. HIGH is inputted from the pulse generator 610 to the gate terminal C of the Nch transistor 109. HIGH is inputted from the pulse generator 610 to the gate terminal B of the Pch transistor 108. HIGH is inputted from the pulse generator 610 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. In the first flip-flop circuit 611, the internal data is retained since the voltage level is maintained at VSS in the CK terminal thereof and the potential of the D input terminal thereof is below the Level B.

Operation at Time 3

LOW as the external input data 619 and HIGH as the original oscillation clock 620 are inputted to the pulse generator 610. LOW is inputted from the pulse generator 610 to the gate terminal C of the Nch transistor 109. LOW is inputted from the pulse generator 610 to the gate terminal B of the Pch transistor 108. HIGH is inputted from the pulse generator 610 to the gate terminal A of the Pch transistor 107. Since the gate potentials of the Nch transistor 109, the Pch transistor 108 and the Pch transistor 107 have the foregoing values, the voltage level is changed from VSS to VDD2 in the clock signal line 103. In the first flip-flop circuit 611, LOW is fetched since the voltage level is changed from VSS to VDD2 in the CK terminal thereof and the potential of the D input terminal thereof is below the Level B.

Operation Between Time 3 and Time 4

LOW as the external input data 619 and HIGH as the original oscillation clock 620 are inputted to the pulse generator 610. LOW is inputted from the pulse generator 610 to the gate terminal C of the Nch transistor 109. LOW is inputted from the pulse generator 610 to the gate terminal B of the Pch transistor 108. HIGH is inputted from the pulse generator 610 to the gate terminal A of the Pch transistor 107. Since the gate potentials of the Nch transistor 109, the Pch transistor 108 and the Pch transistor 107 have the foregoing values, the voltage level is maintained at VDD2 in the clock signal line 103. In the first flip-flop circuit 611, the internal data is retained since the voltage level is maintained at VDD2 in the CK terminal thereof and the potential of the D input terminal thereof is below the Level B.

Operation at Time 4

LOWS as the external input data 619 and LOW as the original oscillation clock 620 are inputted to the pulse generator 610. HIGH is inputted from the pulse generator 610 to the gate terminal C of the Nch transistor 109. HIGH is inputted from the pulse generator 610 to the gate terminal B of the Pch transistor 108. HIGH is inputted from the pulse generator 610 to the gate terminal A of the Pch transistor 107. Since the gate potentials of the Nch transistor 109, the Pch transistor 108 and the Pch transistor 107 have the foregoing values, the voltage level is changed from VDD2 to VSS in the clock signal line 103. In the first flip-flop circuit 611, the internal data is retained since the voltage level is changed from VDD2 to VSS in the CK terminal thereof and the potential of the D input terminal thereof is below the Level B.

Operation Between Time 4 and Time 5

LOW as the external input data 619 and LOW as the original oscillation clock 620 are inputted to the pulse generator 610. HIGH is inputted from the pulse generator 610 to the gate terminal C of the Nch transistor 109. HIGH is inputted from the pulse generator 610 to the gate terminal B of the Pch transistor 108. HIGH is inputted from the pulse generator 610 to the gate terminal A of the Pch transistor 107. Since the gate potentials of the Nch transistor 109, the Pch transistor 108 and the Pch transistor 107 have the foregoing values, the voltage level is maintained at VSS in the clock signal line 103. In the first flip-flop circuit 611, the internal data is retained since the voltage level is maintained at VSS in the CK terminal thereof and the potential of the D input terminal thereof is below the Level B.

When the threshold values of the D input terminal and the CK input terminal are made different as in the operations from the Time 1 through Time 5, the clock signal and the data signal can be supplied at one time through one clock signal line.

### Embodiment 7

A disadvantage in the embodiment 6 is that it is not possible to control asynchronous setting and resetting via the clock signal line. An embodiment 6 of the present invention improves the disadvantage.

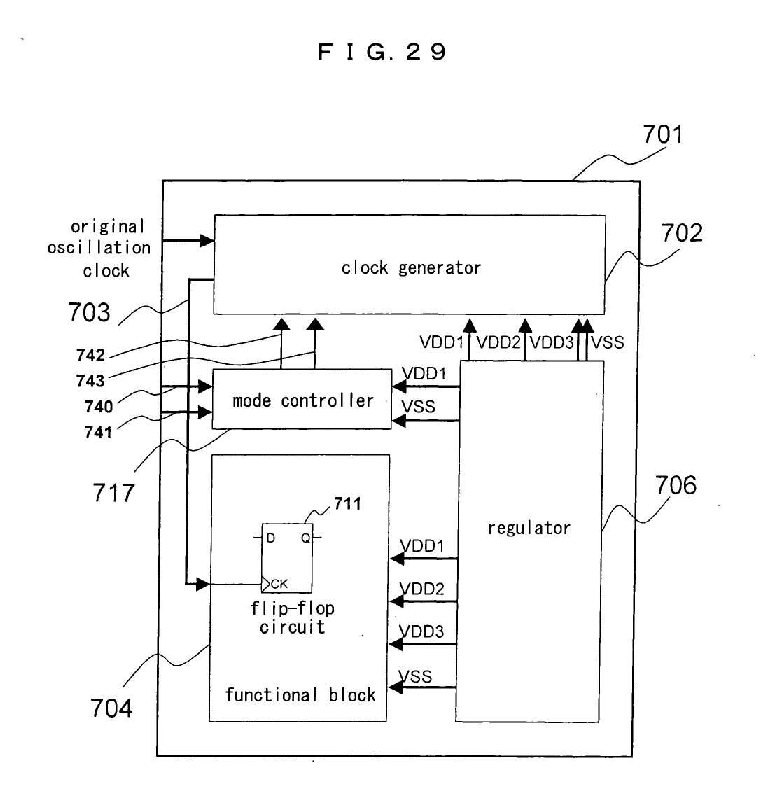

FIG. 29 is a block diagram illustrating a configuration of a semiconductor integrated circuit device according to the embodiment 7. A semiconductor integrated circuit device 701 comprises a clock generator (clock supplier) 702, a clock signal line 703, a functional block (function executor) 704, a regulator (voltage supplier) 706, and a mode controller (first controller) 717.

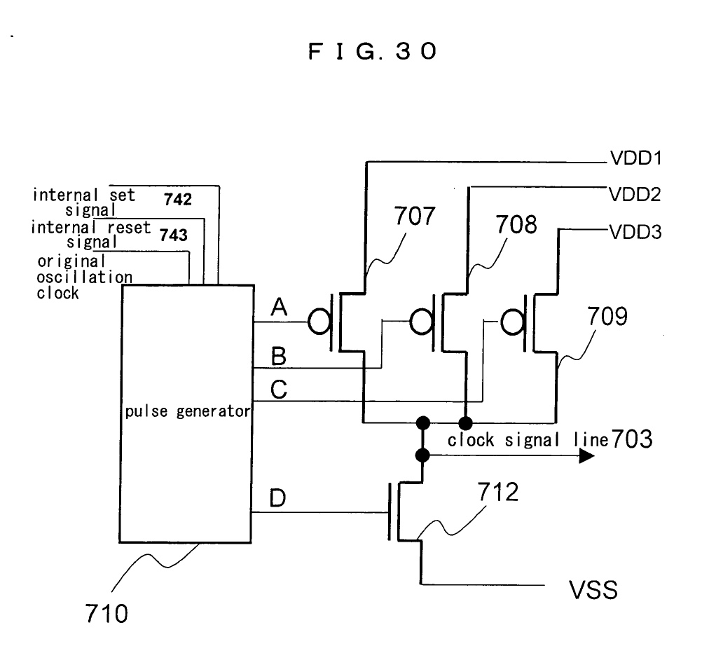

FIG. 30 is a circuit diagram of the clock generator 702. The clock generator 702 comprises a pulse generator 710, a Pch transistor 707, a Pch transistor 708, a Pch transistor 709 and an Nch transistor 712.

Power-supply voltages VDD1, VDD2 and VDD3 and a reference voltage VSS are supplied from the regulator 706 to the pulse generator 710, and an original oscillation clock from outside, an internal set signal 742 and an internal reset signal 743 from the mode controller 717 are connected to the pulse generator 710.

A drain terminal of the Pch transistor 707 is connected to the power-supply voltage VDD1, and a gate terminal thereof is connected to the pulse generator 710.

A drain terminal of the Pch transistor 708 is connected to the power-supply voltage VDD2 (VDD2<VDD1), and a gate terminal thereof is connected to the pulse generator 710.

A drain terminal of the Pch transistor 709 is connected to the power-supply voltage VDD3, and a gate terminal thereof is connected to the pulse generator 710. The power-supply voltage VDD3 is lower than the power-supply voltage VDD2.

A drain terminal of the Nch transistor 712 is connected to a source terminal of the transistor 707, a source terminal of the transistor 708, a source terminal of the transistor 709, and the clock signal line 703. A gate terminal of the Nch transistor 712 is connected to the pulse generator 710, and a source terminal thereof is connected to VSS.

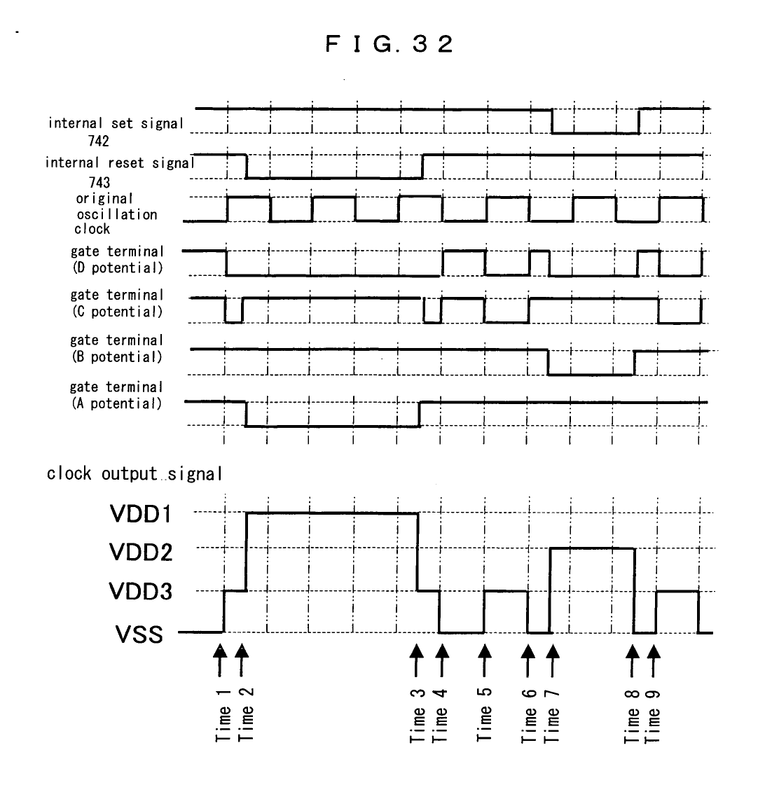

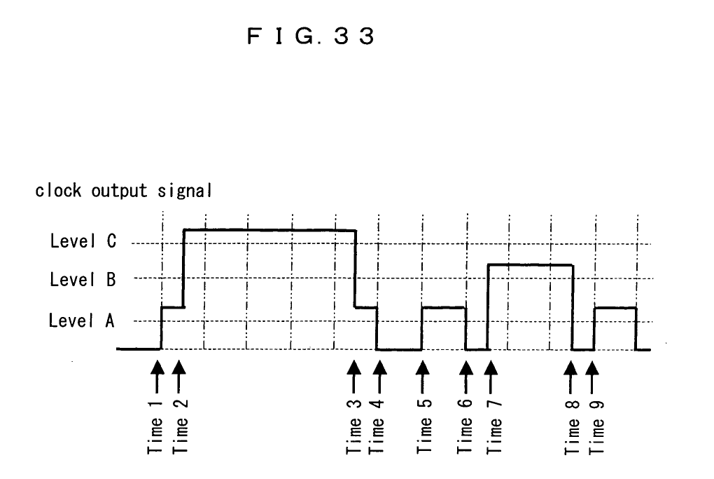

The pulse generator 710 can supply potentials shown in FIGS. 32 and 33 to the gate terminal (A potential), the gate terminal (B potential), the gate terminal (C potential), and the gate terminal (D potential).

The clock signal line 703 supplies a clock signal outputted from the clock generator 702 to the functional block 704. The functional block 704 comprises a flip-flop circuit 711.

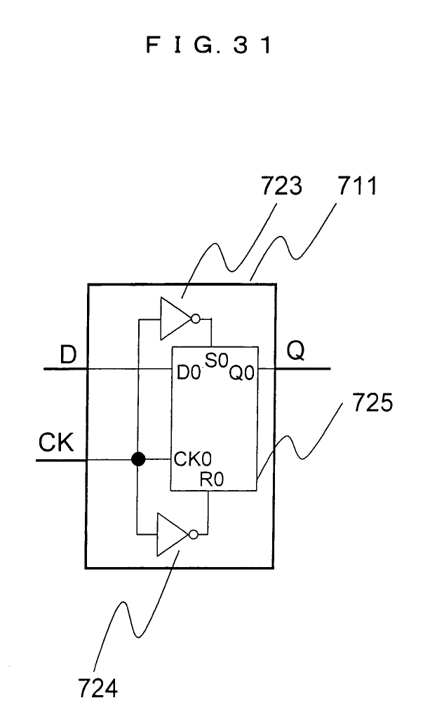

FIG. 31 shows a configuration of the flip-flop circuit 711. FIG. 33 shows a relationship between the clock output signal and respective threshold levels.

The flip-flop circuit 711 comprises an inverter (third controller) 723, an inverter (second controller) 723, and a data flip-flop (retainer) 725.

An input terminal of the inverter 723 is connected to a CK0 input terminal of the data flip-flop 725 and a CK terminal of the flip-flop circuit 711. An output terminal of the inverter 723 is connected to a S0 input terminal of the data flip-flop 725. LOW is outputted from the inverter 723 when the potential of the CK terminal is at least Level B (second threshold value).

An input terminal of the inverter 724 is connected to the CK0 input terminal of the data flip-flop 725 and the CK terminal of the flip-flop circuit 711. An output terminal of the inverter 724 is connected to a R0 input terminal of the data flip-flop 725. LOW is outputted from the inverter 724 when the potential of the CK terminal is at least Level C (first threshold value).

A D0 input terminal of the data flip-flop 725 is connected to a D terminal of the flip-flop circuit 711, a CK0 input terminal thereof is connected to the CK terminal of the flip-flop circuit 711, and a Q0 output terminal thereof is connected to a Q terminal of the flip-flop circuit 711. The data flip-flop 725 fetches the potential of the D terminal when the potential of the CK terminal thereof changes from a potential lower than Level A (third threshold value) to a potential at least the Level A, outputs LOW to the Q0 output terminal when the potential of the R0 input terminal thereof is at the LOW level, and outputs HIGH to the Q0 output terminal when the potential of the S0 input terminal thereof is at the LOW level and the potential of the R0 input terminal thereof is at the HIGH level. A relationship among the Levels A, B and C is Level A<Level B<Level C as shown in FIG. 33.

The regulator 706 supplies the power-supply voltages VDD1, VDD2 and VDD3 and the reference voltage VSS to the clock generator 702 (VDD3<VDD2<VDD1), supplies the power-supply voltages VDD1, VDD2 and VDD3 and the reference voltage VSS to the functional block 704, and supplies the power-supply voltage VDD1 and the reference voltage VSS to the mode controller 717.

To the mode controller 717, the power-supply voltage VDD1 and the reference voltage VSS from the regulator 706 are supplied, and an external set signal 740 and an external reset signal 741 from outside are inputted. The mode controller 717 outputs the potential of the external set signal 740 to the clock generator 702 asynchronously with the internal set signal 742, and outputs the potential of the external reset signal 741 asynchronously with the internal reset signal 743.

An operation of the semiconductor integrated circuit device thus configured is described below. FIG. 32 is a timing chart for illustrating a relationship among the internal set signal 742, the internal reset signal 743, the original oscillation signal, the gate terminal (A potential) of the Pch transistor 707, the gate terminal (B potential) of the Pch transistor 708, the gate terminal (C potential) of the Pch transistor 709, the gate terminal (D potential) of the Nch transistor 712 and the clock signal outputted from the clock generator 702 and transmitted via the clock signal line 703. Below are described operations in Time 1-Time 9 shown in FIG. 32.

Operation at Time 1

HIGH is inputted as the external set signal 740, and HIGH is inputted as the external reset signal 741. HIGH as the internal set signal 742 and HIGH as the internal reset signal 743 are outputted from the mode controller 717. LOW is inputted from the pulse generator 710 to the gate terminal D of the Nch transistor 712. LOW is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VSS to VDD3 in the clock signal line 703. The clock in which the voltage level is changed from VSS to VDD3 is inputted from the clock signal line 703 to the functional block 704. The clock in which the voltage level is changed from VSS to VDD3 is inputted to the CK terminal of the flip-flop circuit 711. HIGH is outputted to the output terminal of the inverter 723 since the voltage level is changed from VSS to VDD3 in the input terminal thereof. HIGH is outputted to the output terminal of the inverter 724 since the voltage level is changed from VSS to VDD3 in the input terminal thereof. Since the outputs of the inverters 723 and 724 have the foregoing values, the data flip-flop circuit 725 fetches the value of the D0 input terminal.

Operation Between Time 1 and Time 2

HIGH is inputted as the external set signal 740, and HIGH is inputted as the external reset signal 741. HIGH as the internal set signal 742 and HIGH as the internal reset signal 743 are outputted from the mode controller 717. LOW is inputted from the pulse generator 710 to the gate terminal D of the Nch transistor 712. LOW is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed maintained at VDD3 in the clock signal line 703. The voltage of VDD3 is inputted from the clock signal line 703 to the functional block 704. The voltage of VDD3 is inputted to the CK terminal of the flip-flop circuit 711. HIGH is outputted to the output terminal of the inverter 723 since the voltage level is VDD3 in the input terminal thereof. HIGH is outputted to the output terminal of the inverter 724 since the voltage level is VDD3 in the input terminal thereof. Since the outputs of the inverters 723 and 724 have the foregoing values, the data flip-flop circuit 725 retains the internal data.

Operation at Time 2

HIGH is inputted as the external set signal 740, and LOW is inputted as the external reset signal 741. HIGH as the internal set signal 742 and LOW as the internal reset signal 743 are outputted from the mode controller 717. LOW is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. LOW is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VDD3 to VDD1 in the clock signal line 703. The clock in which the voltage level is changed from VDD3 to VDD1 is inputted from the clock signal line 703 to the functional block 704. The clock in which the voltage level is changed from VDD3 to VDD1 is inputted to the CK terminal of the flip-flop circuit 711. HIGH is outputted to the output terminal of the inverter 723 since the voltage level is changed from VDD3 to VDD1 in the input terminal thereof. LOW is outputted to the output terminal of the inverter 724 since the voltage level is changed from VDD3 to VDD1 in the input terminal thereof. Since the outputs of the inverters 723 and 724 have the foregoing values, the data flip-flop circuit 725 falls into a reset state with the internal state thereof being LOW.

Operation Between Time 2 and Time 3

HIGH is inputted as the external set signal 740, and LOW is inputted as the external reset signal 741. HIGH as the internal set signal 742 and LOW as the internal reset signal 743 are outputted from the mode controller 717. LOW is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. LOW is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VDD1 in the clock signal line 703. The voltage of VDD1 is inputted from the clock signal line 703 to the functional block 704. The voltage of VDD1 is inputted to the CK terminal of the flip-flop circuit 711. HIGH is outputted to the output terminal of the inverter 723 since the voltage level is VDD1 in the input terminal thereof. LOW is outputted to the output terminal of the inverter 724 since the voltage level is VDD1 in the input terminal thereof. Since the outputs of the inverters 723 and 724 have the foregoing values, the data flip-flop circuit 725 falls into the reset state with the internal state thereof being LOW.

Operation at Time 3

HIGH is inputted as the external set signal 740, and HIGH is inputted as the external reset signal 741. HIGH as the internal set signal 742 and HIGH as the internal reset signal 743 are outputted from the mode controller 717. LOW is inputted from the pulse generator 710 to the gate terminal D of the Nch transistor 712. LOW is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VDD1 to VDD3 in the clock signal line 703. The clock in which the voltage level is changed from VDD1 to VDD3 is inputted from the clock signal line 703 to the functional block 704. The clock in which the voltage level is changed from VDD1 to VDD3 is inputted to the CK terminal of the flip-flop circuit 711. HIGH is outputted to the output terminal of the inverter 723 since the voltage level is changed from VDD1 to VDD3 in the input terminal thereof. HIGH is outputted to the output terminal of the inverter 724 since the voltage level is changed from VDD1 to VDD3 in the input terminal thereof. Since the outputs of the inverters 723 and 724 have the foregoing values, the data flip-flop circuit 725 retains the internal data.

Operation Between Time 3 and Time 4

HIGH is inputted as the external set signal 740, and HIGH is inputted as the external reset signal 741. HIGH as the internal set signal 742 and HIGH as the internal reset signal 743 are outputted from the mode controller 717. LOW is inputted from the pulse generator 710 to the gate terminal D of the Nch transistor 712. LOW is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VDD3 in the clock signal line 703. The voltage of VDD3 is inputted from the clock signal line 703 to the functional block 704. The voltage of VDD3 is inputted to the CK terminal of the flip-flop circuit 711. HIGH is outputted to the output terminal of the inverter 723 since the voltage level is VDD3 in the input terminal thereof. HIGH is outputted to the output terminal of the inverter 724 since the voltage level is VDD3 in the input terminal thereof. Since the outputs of the inverters 723 and 724 have the foregoing values, the data flip-flop circuit 725 retains the internal data.

Operation at Time 4

HIGH is inputted as the external set signal 740, and HIGH is inputted as the external reset signal 741. HIGH as the internal set signal 742 and HIGH as the internal reset signal 743 are outputted from the mode controller 717. HIGH is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VDD3 to VSS in the clock signal line 703. The clock in which the voltage level is changed from VDD3 to VSS is inputted from the clock signal line 703 to the functional block 704. The clock in which the voltage level is changed from VDD3 to VSS is inputted to the CK terminal of the flip-flop circuit 711. HIGH is outputted to the output terminal of the inverter 723 since the voltage level is changed from VDD3 to VSS in the input terminal thereof. HIGH is outputted to the output terminal of the inverter 724 since the voltage level is changed from VDD3 to VSS in the input terminal thereof. Since the outputs of the inverters 723 and 724 have the foregoing values, the data flip-flop circuit 725 retains the internal data.

Operation Between Time 4 and Time 5

HIGH is inputted as the external set signal 740, and HIGH is inputted as the external reset signal 741. HIGH as the internal set signal 742 and HIGH as the internal reset signal 743 are outputted from the mode controller 717. HIGH is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VSS in the clock signal line 703. The voltage of VSS is inputted from the clock signal line 703 to the functional block 704. The voltage of VSS is inputted to the CK terminal of the flip-flop circuit 711. HIGH is outputted to the output terminal of the inverter 723 since the voltage level is VSS in the input terminal thereof. HIGH is outputted to the output terminal of the inverter 724 since the voltage level is VSS in the input terminal thereof. Since the outputs of the inverters 723 and 724 have the foregoing values, the data flip-flop circuit 725 retains the internal data.

Operation at Time 3

HIGH is inputted as the external set signal 740, and HIGH is inputted as the external reset signal 741. HIGH as the internal set signal 742 and HIGH as the internal reset signal 743 are outputted from the mode controller 717. LOW is inputted from the pulse generator 710 to the gate terminal D of the Nch transistor 712. LOW is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VSS to VDD3 in the clock signal line 703. The clock in which the voltage level is changed from VSS to VDD3 is inputted from the clock signal line 703 to the functional block 704. The clock in which the voltage level is changed from VSS to VDD3 is inputted to the CK terminal of the flip-flop circuit 711. HIGH is outputted to the output terminal of the inverter 723 since the voltage level is changed from VSS to VDD3 in the input terminal thereof. HIGH is outputted to the output terminal of the inverter 724 since the voltage level is changed from VSS to VDD3 in the input terminal thereof. Since the outputs of the inverters 723 and 724 have the foregoing values, the data flip-flop circuit 725 fetches the potential of the D0 input terminal.

Operation Between Time 5 and Time 6

HIGH is inputted as the external set signal 740, and HIGH is inputted as the external reset signal 741. HIGH as the internal set signal 742 and HIGH as the internal reset signal 743 are outputted from the mode controller 717. LOW is inputted from the pulse generator 710 to the gate terminal D of the Nch transistor 712. LOW is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VDD3 in the clock signal line 703. The voltage of VDD3 is inputted from the clock signal line 703 to the functional block 704. The voltage of VDD3 is inputted to the CK terminal of the flip-flop circuit 711. HIGH is outputted to the output terminal of the inverter 723 since the voltage level is c VDD3 in the input terminal thereof. HIGH is outputted to the output terminal of the inverter 724 since the voltage level is VDD3 in the input terminal thereof. Since the outputs of the inverters 723 and 724 have the foregoing values, the data flip-flop circuit 725 retains the internal data.

Operation at Time 6

HIGH is inputted as the external set signal 740, and HIGH is inputted as the external reset signal 741. HIGH as the internal set signal 742 and HIGH as the internal reset signal 743 are outputted from the mode controller 717. HIGH is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VDD3 to VSS in the clock signal line 703. The clock in which the voltage level is changed from VDD3 to VSS is inputted from the clock signal line 703 to the functional block 704. The clock in which the voltage level is changed from VDD3 to VSS is inputted to the CK terminal of the flip-flop circuit 711. HIGH is outputted to the output terminal of the inverter 723 since the voltage level is changed from VDD3 to VSS in the input terminal thereof. HIGH is outputted to the output terminal of the inverter 724 since the voltage level is changed from VDD3 to VSS in the input terminal thereof. Since the outputs of the inverters 723 and 724 have the foregoing values, the data flip-flop circuit 725 retains the internal data.

Operation Between Time 6 and Time 7

HIGH is inputted as the external set signal 740, and HIGH is inputted as the external reset signal 741. HIGH as the internal set signal 742 and HIGH as the internal reset signal 743 are outputted from the mode controller 717. HIGH is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VSS in the clock signal line 703. The voltage of VSS is inputted from the clock signal line 703 to the functional block 704. The voltage of VSS is inputted to the CK terminal of the flip-flop circuit 711. HIGH is outputted to the output terminal of the inverter 723 since the voltage level is VSS in the input terminal thereof. HIGH is outputted to the output terminal of the inverter 724 since the voltage level is VSS in the input terminal thereof. Since the outputs of the inverters 723 and 724 have the foregoing values, the data flip-flop circuit 725 retains the internal data.

Operation at Time 7

LOW is inputted as the external set signal 740, and HIGH is inputted as the external reset signal 741. LOW as the internal set signal 742 and HIGH as the internal reset signal 743 are outputted from the mode controller 717. LOW is inputted from the pulse generator 710 to the gate terminal D of the Nch transistor 712. HIGH is inputted from the pulse generator 710 to the gate terminal C of the Pch transistor 709. LOW is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VSS to VDD2 in the clock signal line 703. The clock in which the voltage level is changed from VSS to VDD2 is inputted from the clock signal line 703 to the functional block 704. The clock in which the voltage level is changed from VSS to VDD2 is inputted to the CK terminal of the flip-flop circuit 711. LOW is outputted to the output terminal of the inverter 723 since the voltage level is changed from VSS to VDD2 in the input terminal thereof. HIGH is outputted to the output terminal of the inverter 724 since the voltage level is changed from VSS to VDD2 in the input terminal thereof. Since the outputs of the inverters 723 and 724 have the foregoing values, the data flip-flop circuit 725 falls into a set state with the internal state thereof being HIGH.

Operation Between Time 7 and Time 8

LOW is inputted as the external set signal 740, and HIGH is inputted as the external reset signal 741. LOW as the internal set signal 742 and HIGH as the internal reset signal 743 are outputted from the mode controller 717. LOW is inputted from the pulse generator 710 to the gate terminal D of the Nch transistor 712. HIGH is inputted from the pulse generator 710 to the gate terminal C of the Pch transistor 709. LOW is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VDD2 in the clock signal line 703. The voltage of VDD2 is inputted from the clock signal line 703 to the functional block 704. The voltage of VDD2 is inputted to the CK terminal of the flip-flop circuit 711. LOW is outputted to the output terminal of the inverter 723 since the voltage level is VDD2 in the input terminal thereof. HIGH is outputted to the output terminal of the inverter 724 since the voltage level is VDD2 in the input terminal thereof. Since the outputs of the inverters 723 and 724 have the foregoing values, the data flip-flop circuit 725 falls into the set state with the internal state thereof being HIGH.

Operation at Time 8

HIGH is inputted as the external set signal 740, and HIGH is inputted as the external reset signal 741. HIGH as the internal set signal 742 and HIGH as the internal reset signal 743 are outputted from the mode controller 717. HIGH is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is changed from VDD2 to VSS in the clock signal line 703. The clock in which the voltage level is changed from VDD2 to VSS is inputted from the clock signal line 703 to the functional block 704. The clock in which the voltage level is changed from VDD2 to VSS is inputted to the CK terminal of the flip-flop circuit 711. HIGH is outputted to the output terminal of the inverter 723 since the voltage level is changed from VDD2 to VSS in the input terminal thereof. HIGH is outputted to the output terminal of the inverter 724 since the voltage level is changed from VDD2 to VSS in the input terminal thereof. Since the outputs of the inverters 723 and 724 have the foregoing values, the data flip-flop circuit 725 retains the internal data.

Operation Between Time 8 and Time 9

HIGH is inputted as the external set signal 740, and HIGH is inputted as the external reset signal 741. HIGH as the internal set signal 742 and HIGH as the internal reset signal 743 are outputted from the mode controller 717. HIGH is inputted from the pulse generator 710 to the gate terminal D of the Nch transistor 712. HIGH is inputted from the pulse generator 710 to the gate terminal C of the Pch transistor 709. HIGH is inputted from the pulse generator 710 to the gate terminal B of the Pch transistor 708. HIGH is inputted from the pulse generator 710 to the gate terminal A of the Pch transistor 707. Since the gate potentials of the Nch transistor 712, the Pch transistor 709, the Pch transistor 708 and the Pch transistor 707 have the foregoing values, the voltage level is maintained at VSS in the clock signal line 703. The voltage of VSS is inputted from the clock signal line 703 to the functional block 704. The voltage of VSS is inputted to the CK terminal of the flip-flop circuit 711. HIGH is outputted to the output terminal of the inverter 723 since the voltage level is VSS in the input terminal thereof. HIGH is outputted to the output terminal of the inverter 724 since the voltage level is VSS in the input terminal thereof. Since the outputs of the inverters 723 and 724 have the foregoing values, the data flip-flop circuit 725 retains the internal data.

As described so far, the data flip-flop circuit 725 falls into the reset state when the clock signal has the voltage level of VDD1, falls into the set state when the clock signal has the voltage level of VDD2, and fetches the data when the voltage level of the clock signal is changed from VSS to VDD1.

The flip-flop circuit can be thus asynchronously set and reset through one clock signal line, which makes it unnecessary to additionally provide a set signal line and a reset signal line.

In the present embodiment, the flip-flop circuit is preferentially reset, however, may be preferentially set. Further, the external set signal 740 and the external reset signal 741 are inputted from outside in the present embodiment, however, the output of the functional block 704 may be inputted instead.

### Embodiment 8

A disadvantage in the embodiment 7 is that it is not possible to generate an enable signal used for security and the like using the potential of the clock signal line. An embodiment 8 of the present invention improves the disadvantage.

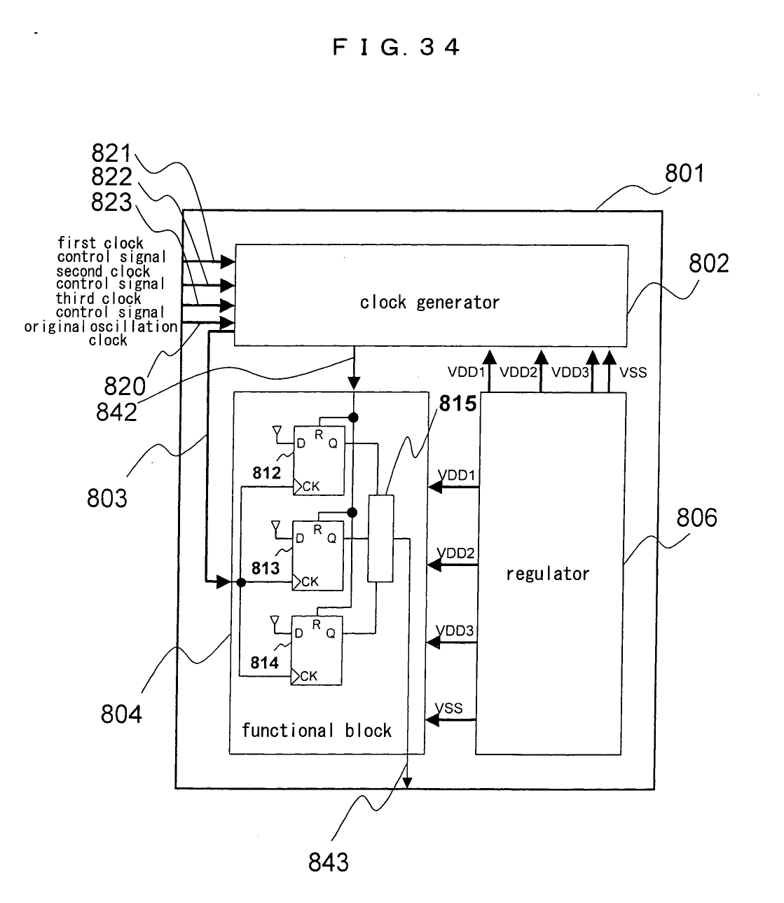

FIG. 34 is a block diagram illustrating a configuration of a semiconductor integrated circuit device according to the embodiment 8. A semiconductor integrated circuit device 801 comprises a clock generator (clock supplier) 802, a clock signal line 803, a functional block (function executor) 804, and a regulator (voltage supplier) 806.

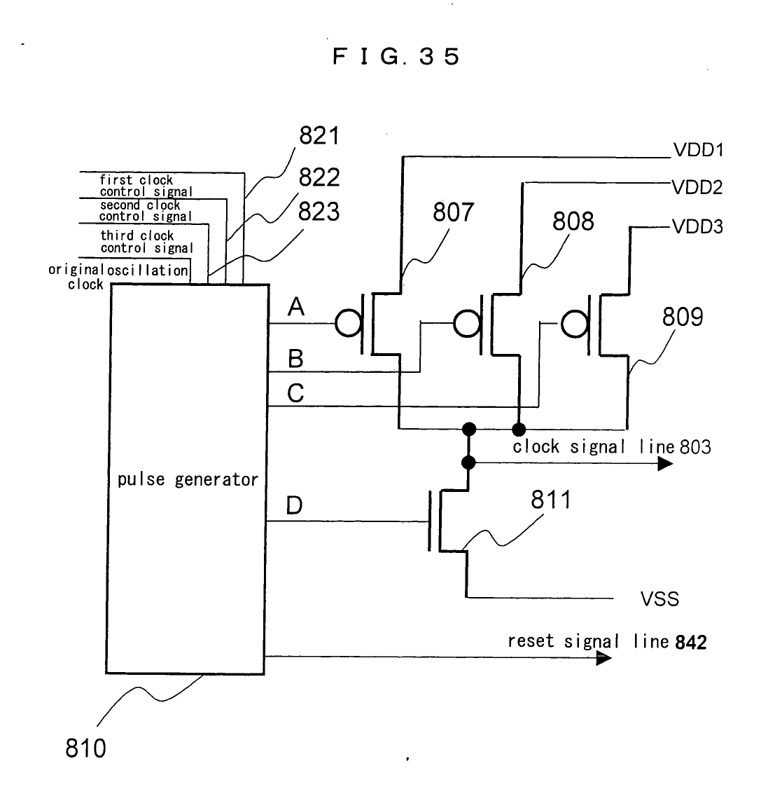

Power-supply voltage VDD1, VDD2 and VDD3 and a reference voltage VSS are supplied from the regulator 806 to the clock generator 802. FIG. 35 is a circuit diagram of the clock generator 802. The clock generator 802 comprises a pulse generator 810, a Pch transistor 807, a Pch transistor 808, a Pch transistor 809, and an Nch transistor 811. An original oscillation clock, a first clock control signal 821, a second clock control signal 822, and a third clock control signal 823 from outside are connected to the pulse generator 810. A drain terminal of the Pch transistor 807 is connected to the power-supply voltage VDD1, and a gate terminal thereof is connected to the pulse generator 810. A drain terminal of the Pch transistor 808 is connected to the power-supply voltage VDD2, and a gate terminal thereof is connected to the pulse generator 810. The power-supply voltage VDD2 is lower than the power-supply voltage VDD1. A drain terminal of the Pch transistor 809 is connected to the power-supply voltage VDD3, and a gate terminal thereof is connected to the pulse generator 810. The power-supply voltage VDD3 is lower than the power-supply voltage VDD2. A drain terminal of the Nch transistor 811 is connected to a source terminal of the transistor 807, a source terminal of the transistor 808, a source terminal of the transistor 809, and the clock signal line 803. A gate terminal of the Nch transistor 811 is connected to the pulse generator 810, and a source terminal thereof is connected to VSS.

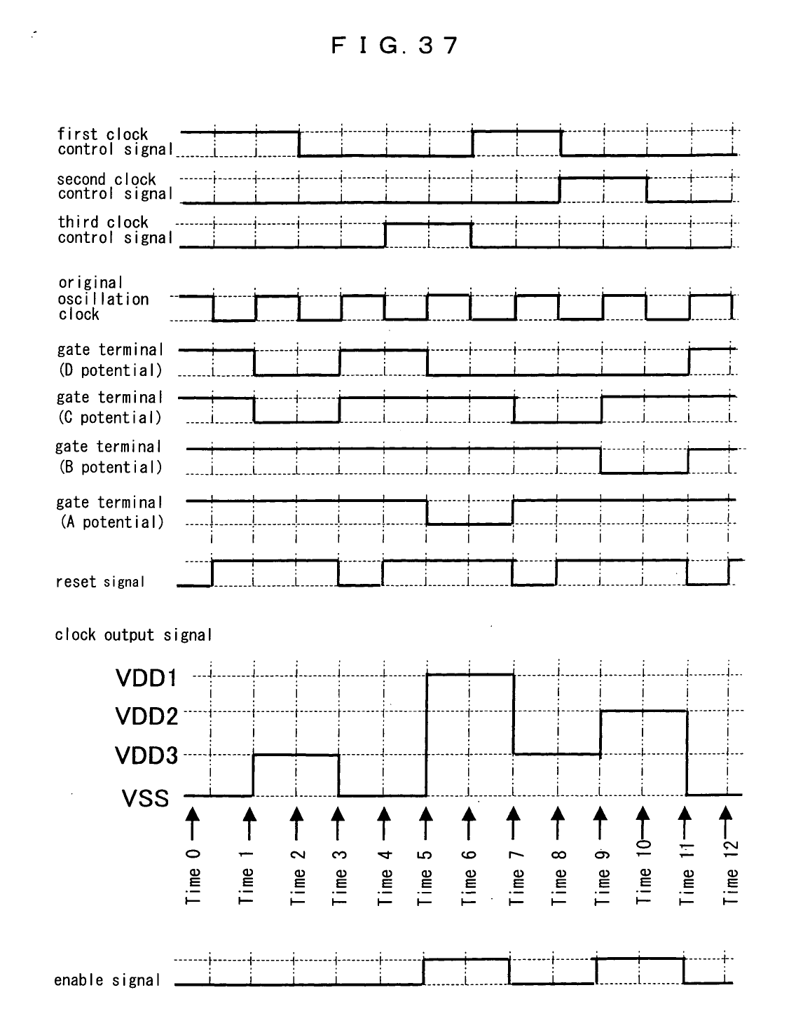

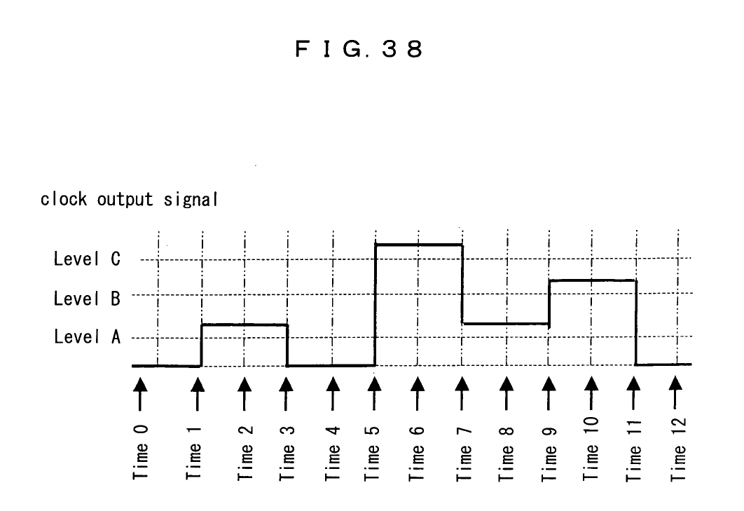

The pulse generator 810 can supply potentials shown in FIGS. 37 and 38 to the gate terminal (A potential), the gate terminal (B potential), the gate terminal (C potential), the gate terminal (D potential), and a reset signal line 842.

A clock signal outputted from the clock generator 802 is supplied to the functional block 804 through the clock signal line 803. A reset signal outputted from the clock generator 802 is supplied to the functional block 804 through the reset signal line 842.

The functional block 804 comprises a flip-flop circuit (first retainer) 812, a second flip-flop circuit (second retainer) 813, a third flip-flop circuit (third retainer) 814, a combinational circuit (controller) 815, an enable signal line 843.

FIG. 38 shows a relationship between the clock output signal and respective threshold values. A D input terminal of the first flip-flop circuit 812 is fixed to be HIGH, a CK input terminal thereof is connected to the clock signal line 803, a R input terminal thereof is connected to the reset signal line 842, and a Q output terminal thereof is connected to the combinational circuit 815 in a subsequent stage. The first flip-flop circuit 812 fetches the potential of the D input terminal when the potential of the CK input terminal thereof changes from a potential below Level A (third threshold value) to a potential at least the Level A, and operates in such a manner that the internal state thereof changes to be LOW when the R input terminal thereof is at the LOW level.

A D input terminal of the second flip-flop circuit 813 is fixed to be HIGH, a CK input terminal thereof is connected to the clock signal line 803, a R input terminal thereof is connected to the reset signal line 842, and a Q output terminal thereof is connected to the combinational circuit 815 in a subsequent stage. The second flip-flop circuit 813 fetches the potential of the D input terminal when the potential of the CK input terminal thereof changes from a potential below Level B (second threshold value) to a potential at least the Level B, and operates in such a manner that the internal state thereof changes to be LOW when the R input terminal thereof is at the LOW level.

A D input terminal of the third flip-flop circuit 814 is fixed to be HIGH, a CK input terminal thereof is connected to the clock signal line 803, a R input terminal thereof is connected to the reset signal line 842, and a Q output terminal thereof is connected to the combinational circuit 815 in a subsequent stage. The third flip-flop circuit 814 fetches the potential of the D input terminal when the potential of the CK input terminal thereof changes from a potential below Level C (first threshold value) to a potential at least the Level C, and operates in such a manner that the internal state thereof changes to be LOW when the R input terminal thereof is at the LOW level. As shown in FIG. 38, a relationship among the Levels A, B and C is Level A<Level B<Level C.

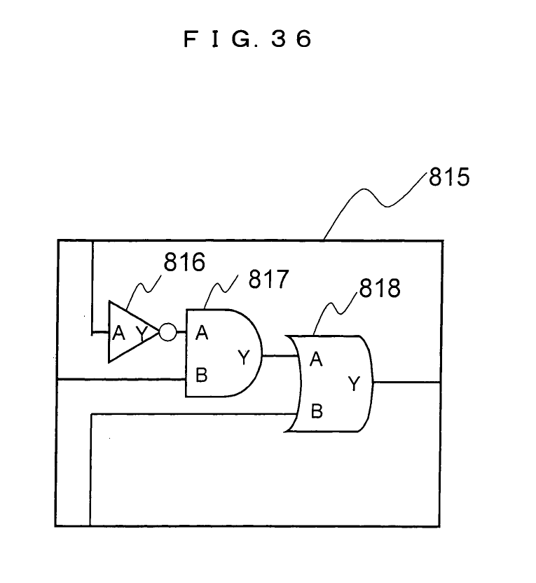

FIG. 36 is a circuit diagram of the combinational circuit 815. The combinational circuit 815 comprises: an inversion circuit 816 whose A input terminal is connected to the Q output terminal of the first flip-flop circuit 812; an AND circuit 817 whose A input terminal is connected to an output terminal of the inversion circuit 816, and whose B input terminal is connected to the Q output terminal of the second flip-flop circuit 813; an OR circuit 818 whose A input terminal is connected to an output terminal of the AND circuit 817, whose B input terminal is connected to the Q output terminal of the third flip-flop circuit 814, and whose output terminal is connected to the enable signal line 843; and the enable signal line 843 for transmitting outside the output of the OR circuit 818 so that it can be used for the security and the like.

The regulator 806 supplies power-supply voltages VDD1, VDD2 and VDD3 and a reference voltage VSS to the clock generator 802 (VDD3<VDD2<VDD1), and supplies the power-supply voltages VDD1, VDD2 and VDD3 and the reference voltage VSS to the functional block 804.

An operation of the semiconductor integrated circuit device thus configured is described below. FIG. 37 is a timing chart for illustrating a relationship among the first clock control signal 821, the second clock signal 822, the third clock control signal 823, the original oscillation clock, the gate terminal (A potential) of the Pch transistor 807, the gate terminal (B potential) of the Pch transistor 808, the gate terminal (C potential) of the Pch transistor 809, the gate terminal (D potential) of the Nch transistor 811, the clock signal outputted from the clock generator 802 and transmitted by the clock signal line 803, the reset signal line 842, and the enable signal line 843. Below are described operations in Time 1-Time 12 shown in FIG. 37.

Operation at Time 0

HIGH is inputted from outside as the first clock control signal 821. LOW is inputted from outside as the second clock control signal 822. LOW is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage at the level of VSS is outputted from the clock signal line 803. LOW is outputted from the pulse generator 810 to the reset signal line 842. The clock in which the voltage level is changed from VSS to VDD3 is inputted from the clock signal line 803 to the functional block 804, and LOW is inputted from the reset signal line 842 to the functional block 804. The potential of VSS is inputted to the CK input terminals of the first flip-flop circuit 812, the second flip-flop circuit 813, and the third flip-flop circuit 814, and LOW is inputted to the R input terminals of the respective flip-flop circuits. The internal states of the first flip-flop circuit 812, the second flip-flop circuit 813, and the third flip-flop circuit 814 are rendered LOW since the R input terminals thereof are at the LOW level. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is LOW.

Operation at Time 1

HIGH is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is changed from VSS to VDD3 in the clock signal line 803. HIGH is outputted from the pulse generator 810 to the reset signal line 842. The clock in which the voltage level is changed from VSS to VDD3 is inputted from the clock signal line 803 to the functional block 804, and HIGH is inputted from the reset signal line 842 to the functional block 804. The clock in which the voltage level is changed from VSS to VDD3 is inputted to the CK input terminals of the first flip-flop circuit 812, the second flip-flop circuit 813, and the third flip-flop circuit 814, and HIGH is inputted to the R input terminals of the respective flip-flop circuits. The first flip-flop circuit 812 fetches HIGH since the voltage level is changed from VSS to VDD3 in the CK input terminal thereof. The internal state of the second flip-flop circuit 813 is retained since the voltage level is changed from VSS to VDD3 in the CK input terminal thereof. The internal state of the third flip-flop circuit 814 is retained since the voltage level is changed from VSS to VDD3 in the CK input terminal thereof. LOW is outputted to the output terminal of the inversion circuit 816 since the input terminal thereof is at the HIGH level. In the AND circuit 817, LOW is outputted to the output terminal thereof since LOW is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation Between Time 1 and Time 2

HIGH is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD3 in the clock signal line 803. HIGH is outputted from the pulse generator 810 to the reset signal line 842. The clock in which the voltage level is VDD3 is inputted from the clock signal line 803 to the functional block 804, and HIGH is inputted from the reset signal line 842 to the functional block 804. The clock in which the voltage level is VDD3 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is VDD3 in the CK input terminal thereof. The internal state of the second flip-flop circuit 813 is retained since the voltage level is VDD3 in the CK input terminal thereof. The internal state of the third flip-flop circuit 814 is retained since the voltage level is VDD3 in the CK input terminal thereof. LOW is outputted to the output terminal of the inversion circuit 816 since the input terminal thereof is at the HIGH level. In the AND circuit 817, LOW is outputted to the output terminal thereof since LOW is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation at Time 2

LOW is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD3 in the clock signal line 803. HIGH is outputted from the pulse generator 810 to the reset signal line 842. The clock in which the voltage level is VDD3 is inputted from the clock signal line 803 to the functional block 804, and HIGH is inputted from the reset signal line 842 to the functional block 804. The clock in which the voltage level is VDD3 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is VDD3 in the CK input terminal thereof. The internal state of the second flip-flop circuit 813 is retained since the voltage level is VDD3 in the CK input terminal thereof. The internal state of the third flip-flop circuit 814 is retained since the voltage level is VDD3 in the CK input terminal thereof. LOW is outputted to the output terminal of the inversion circuit 816 since the input terminal thereof is at the HIGH level. In the AND circuit 817, LOW is outputted to the output terminal thereof since LOW is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation Between Time 2 and Time 3

LOW is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD3 in the clock signal line 803. HIGH is outputted from the pulse generator 810 to the reset signal line 842. The clock in which the voltage level is VDD3 is inputted from the clock signal line 803 to the functional block 804, and HIGH is inputted from the reset signal line 842 to the functional block 804. The clock in which the voltage level is VDD3 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is VDD3 in the CK input terminal thereof. The internal state of the second flip-flop circuit 813 is retained since the voltage level is VDD3 in the CK input terminal thereof. The internal state of the third flip-flop circuit 814 is retained since the voltage level is VDD3 in the CK input terminal thereof. LOW is outputted to the output terminal of the inversion circuit 816 since the input terminal thereof is at the HIGH level. In the AND circuit 817, LOW is outputted to the output terminal thereof since LOW is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation at Time 3

LOW is inputted from outside as the first clock control signal 821. LOW is inputted from outside as the second clock control signal 822. LOW is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is changed from VDD3 to VSS in the clock signal line 803. LOW is outputted from the pulse generator 810 to the reset signal line 842. The clock in which the voltage level is changed from VDD3 to VSS is inputted from the clock signal line 803 to the functional block 804, and LOW is inputted from the reset signal line 842 to the functional block 804. The clock in which the voltage level is changed from VDD3 to VSS is inputted to the CK input terminals of the first flip-flop circuit 812, the second flip-flop circuit 813, and the third flip-flop circuit 814, and LOW is inputted to the R input terminals of the respective flip-flop circuits. The internal state of the first flip-flop circuit 812 becomes LOW since the R input terminal thereof is at the LOW level. The internal state of the second flip-flop circuit 813 becomes LOW since the R input terminal thereof is at the LOW level. The internal state of the third flip-flop circuit 814 becomes LOW since the R terminal thereof is at the LOW level. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation Between Time 3 and Time 4

LOW is inputted from outside as the first clock control signal 821. LOW is inputted from outside as the second clock control signal 822. LOW is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VSS in the clock signal line 803. LOW is outputted from the pulse generator 810 to the reset signal line 842. The clock in which the voltage level is VSS is inputted from the clock signal line 803 to the functional block 804, and LOW is inputted from the reset signal line 842 to the functional block 804. The clock in which the voltage level is VSS is inputted to the CK input terminals of the first flip-flop circuit 812, the second flip-flop circuit 813, and the third flip-flop circuit 814, and LOW is inputted to the R input terminals of the respective flip-flop circuits. The internal state of the first flip-flop circuit 812 becomes LOW since the R input terminal thereof is at the LOW level. The internal state of the second flip-flop circuit 813 becomes LOW since the R input terminal thereof is at the LOW level. The internal state of the third flip-flop circuit 814 becomes LOW since the R terminal thereof is at the LOW level. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation at Time 4

LOW is inputted from outside as the first clock control signal 821. LOW is inputted from outside as the second clock control signal 822. HIGH is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VSS in the clock signal line 803. HIGH is outputted from the pulse generator 810 to the reset signal line 842. The clock in which the voltage level is VSS is inputted from the clock signal line 803 to the functional block 804, and HIGH is inputted from the reset signal line 842 to the functional block 804. The clock in which the voltage level is VSS is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VSS in the CK input terminal thereof. The internal state of the second flip-flop circuit 813 is retained since the R input terminal thereof is at the HIGH level and the voltage level is VSS in the CK input terminal thereof. The internal state of the third flip-flop circuit 814 is retained since the R terminal thereof is at the HIGH level and the voltage level is VSS in the CK input terminal thereof. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation Between Time 4 and Time 5

LOW is inputted from outside as the first clock control signal 821. LOW is inputted from outside as the second clock control signal 822. HIGH is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VSS in the clock signal line 803. HIGH is outputted from the pulse generator 810 to the reset signal line 842. The clock in which the voltage level is VSS is inputted from the clock signal line 803 to the functional block 804, and HIGH is inputted from the reset signal line 842 to the functional block 804. The clock in which the voltage level is VSS is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VSS in the CK input terminal thereof. The internal state of the second flip-flop circuit 813 is retained since the R input terminal thereof is at the HIGH level and the voltage level is VSS in the CK input terminal thereof. The internal state of the third flip-flop circuit 814 is retained since the R terminal thereof is at the HIGH level and the voltage level is VSS in the CK input terminal thereof. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW. level

Operation at Time 5

LOW is inputted from outside as the first clock control signal 821. LOW is inputted from outside as the second clock control signal 822. HIGH is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. LOW is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is changed from VSS to VDD1 in the clock signal line 803. HIGH is outputted from the pulse generator 810 to the reset signal line 842. The clock in which the voltage level is changed from VSS to VDD1 is inputted from the clock signal line 803 to the functional block 804, and HIGH is inputted from the reset signal line 842 to the functional block 804. The clock in which the voltage level is changed from VSS to VDD1 is inputted to the CK input terminals of the first flip-flop circuit 812, the second flip-flop circuit 813, and the third flip-flop circuit 814, and HIGH is inputted to the R input terminals of the respective flip-flop circuits. The first flip-flop circuit 812 fetches HIGH since the voltage level is changed from VSS to VDD1 in the CK input terminal thereof. The second flip-flop circuit 813 fetches HIGH since the voltage level is changed from VSS to VDD1 in the CK input terminal thereof. The third flip-flop circuit 814 fetches HIGH since the voltage level is changed from VSS to VDD1 in the CK input terminal thereof. LOW is outputted to the output terminal of the inversion circuit 816 since the input terminal thereof is at the HIGH level. In the AND circuit 817, HIGH is outputted to the output terminal thereof since LOW is inputted to the A input terminal thereof and HIGH is inputted to the B input terminal thereof. In the OR circuit 818, HIGH is outputted to the output terminal thereof since HIGH is inputted to the A input terminal thereof and HIGH is inputted to the B input terminal thereof. HIGH is transmitted in the enable signal line 843 because the output of the OR circuit 818 is at the HIGH level.

Operation Between Time 5 and Time 6

LOW is inputted from outside as the first clock control signal 821. LOW is inputted from outside as the second clock control signal 822. HIGH is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. LOW is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD1 in the clock signal line 803. HIGH is outputted from the pulse generator 810 to the reset signal line 842. The clock in which the voltage level is VDD1 is inputted from the clock signal line 803 to the functional block 804, and HIGH is inputted from the reset signal line 842 to the functional block 804. The clock in which the voltage level is VDD1 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VDD1 in the CK input terminal thereof. The internal state of the second flip-flop circuit 813 is retained since the R input terminal thereof is at the HIGH level and the voltage level is VDD1 in the CK input terminal thereof. The internal state of the third flip-flop circuit 814 is retained since the R terminal thereof is at the HIGH level and the voltage level is VDD1 in the CK input terminal thereof. LOW is outputted to the output terminal of the inversion circuit 816 since the input terminal thereof is at the HIGH level. In the AND circuit 817, HIGH is outputted to the output terminal thereof since LOW is inputted to the A input terminal thereof and HIGH is inputted to the B input terminal thereof. In the OR circuit 818, HIGH is outputted to the output terminal thereof since HIGH is inputted to the A input terminal thereof and HIGH is inputted to the B input terminal thereof. HIGH is transmitted in the enable signal line 843 because the output of the OR circuit 818 is at the HIGH level.

Operation at Time 6

HIGH is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. LOW is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD1 in the clock signal line 803. HIGH is outputted from the pulse generator 810 to the reset signal line 842. The clock in which the voltage level is VDD1 is inputted from the clock signal line 803 to the functional block 804, and HIGH is inputted from the reset signal line 842 to the functional block 804. The clock in which the voltage level is VDD1 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VDD1 in the CK input terminal thereof. The internal state of the second flip-flop circuit 813 is retained since the R input terminal thereof is at the HIGH level and the voltage level is VDD1 in the CK input terminal thereof. The internal state of the third flip-flop circuit 814 is retained since the R terminal thereof is at the HIGH level and the voltage level is VDD1 in the CK input terminal thereof. LOW is outputted to the output terminal of the inversion circuit 816 since the input terminal thereof is at the HIGH level. In the AND circuit 817, HIGH is outputted to the output terminal thereof since LOW is inputted to the A input terminal thereof and HIGH is inputted to the B input terminal thereof. In the OR circuit 818, HIGH is outputted to the output terminal thereof since HIGH is inputted to the A input terminal thereof and HIGH is inputted to the B input terminal thereof. HIGH is transmitted in the enable signal line 843 because the output of the OR circuit 818 is at the HIGH level.

Operation Between Time 6 and Time 7

HIGH is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. LOW is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD1 in the clock signal line 803. HIGH is outputted from the pulse generator 810 to the reset signal line 842. The clock in which the voltage level is VDD1 is inputted from the clock signal line 803 to the functional block 804, and HIGH is inputted from the reset signal line 842 to the functional block 804. The clock in which the voltage level is VDD1 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VDD1 in the CK input terminal thereof. The internal state of the second flip-flop circuit 813 is retained since the R input terminal thereof is at the HIGH level and the voltage level is VDD1 in the CK input terminal thereof. The internal state of the third flip-flop circuit 814 is retained since the R terminal thereof is at the HIGH level and the voltage level is VDD1 in the CK input terminal thereof. LOW is outputted to the output terminal of the inversion circuit 816 since the input terminal thereof is HIGH. In the AND circuit 817, HIGH is outputted to the output terminal thereof since LOW is inputted to the A input terminal thereof and HIGH is inputted to the B input terminal thereof. In the OR circuit 818, HIGH is outputted to the output terminal thereof since HIGH is inputted to the A input terminal thereof and HIGH is inputted to the B input terminal thereof. HIGH is transmitted in the enable signal line 843 because the output of the OR circuit 818 is at the HIGH level.

Operation at Time 7

HIGH is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is changed from VDD1 to VDD3 in the clock signal line 803. LOW is outputted from the pulse generator 810 to the reset signal line 842. The clock in which the voltage level is changed from VDD1 to VDD3 is inputted from the clock signal line 803 to the functional block 804, and LOW is inputted from the reset signal line 842 to the functional block 804. The clock in which the voltage level is change from VDD1 to VDD3 is inputted to the CK input terminals of the first flip-flop circuit 812, the second flip-flop circuit 813, and the third flip-flop circuit 814, and LOW is inputted to the R input terminals of the respective flip-flop circuits. The internal state of the first flip-flop circuit 812 is LOW since the R input terminal thereof is at the LOW level. The internal state of the second flip-flop circuit 813 is LOW since the R input terminal thereof is at the LOW level. The internal state of the third flip-flop circuit 814 is LOW since the R terminal thereof is at the LOW level. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation Between Time 7 and Time 8

HIGH is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD3 in the clock signal line 803. LOW is outputted from the pulse generator 810 to the reset signal line 842. The clock in which the voltage level is VDD3 is inputted from the clock signal line 803 to the functional block 804, and LOW is inputted from the reset signal line 842 to the functional block 804. The clock in which the voltage level is VDD3 is inputted to the CK input terminals of the first flip-flop circuit 812, the second flip-flop circuit 813, and the third flip-flop circuit 814, and LOW is inputted to the R input terminals of the respective flip-flop circuits. The internal state of the first flip-flop circuit 812 is LOW since the R input terminal thereof is at the LOW level. The internal state of the second flip-flop circuit 813 is LOW since the R input terminal thereof is at the LOW level. The internal state of the third flip-flop circuit 814 is LOW since the R terminal thereof is at the LOW level. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation at Time 8

LOW is inputted from outside as the first clock control signal 821. HIGH is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD3 in the clock signal line 803. HIGH is outputted from the pulse generator 810 to the reset signal line 842. The clock in which the voltage level is VDD3 is inputted from the clock signal line 803 to the functional block 804, and HIGH is inputted from the reset signal line 842 to the functional block 804. The clock in which the voltage level is VDD3 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VDD3 in the CK input terminal thereof. The internal state of the second flip-flop circuit 813 is retained since the R input terminal thereof is at the HIGH level and the voltage level is VDD3 in the CK input terminal thereof. The internal state of the third flip-flop circuit 814 is retained since the R terminal thereof is at the HIGH level and the voltage level is VDD3 in the CK input terminal thereof. HIGH is outputted to the output terminal of the inversion circuit 816 since the input terminal thereof is LOW. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation Between Time 8 and Time 9

LOW is inputted from outside as the first clock control signal 821. HIGH is inputted from outside as the second clock control signal 822. LOW is inputted from outside as the third clock control signal 823. LOW is inputted from the pulse generator 810 to the gate terminal D of the Nch transistor 811. LOW is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD3 in the clock signal line 803. HIGH is outputted from the pulse generator 810 to the reset signal line 842. The clock in which the voltage level is VDD3 is inputted from the clock signal line 803 to the functional block 804, and HIGH is inputted from the reset signal line 842 to the functional block 804. The clock in which the voltage level is VDD3 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the R input terminal thereof is at the HIGH level and the voltage level is VDD3 in the CK input terminal thereof. The internal state of the second flip-flop circuit 813 is retained since the R input terminal thereof is at the HIGH level and the voltage level is VDD3 in the CK input terminal thereof. The internal state of the third flip-flop circuit 814 is retained since the R terminal thereof is at the HIGH level and the voltage level is VDD3 in the CK input terminal thereof. HIGH is outputted to the output terminal of the inversion circuit 816 since the input terminal thereof is at the LOW level. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

Operation at Time 9

LOW is inputted from outside as the first clock control signal 821. HIGH is inputted from outside as the second clock control signal 822. LOW is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. LOW is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is changed from VDD3 to VDD2 in the clock signal line 803. HIGH is outputted from the pulse generator 810 to the reset signal line 842. The clock in which the voltage level is changed from VDD3 to VDD2 is inputted from the clock signal line 803 to the functional block 804, and HIGH is inputted from the reset signal line 842 to the functional block 804. The clock in which the voltage level is changed from VDD3 to VDD2 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is changed from VDD3 to VDD2 in the CK input terminal thereof. The second flip-flop circuit 813 fetches HIGH since the voltage level is changed from VDD3 to VDD2 in the CK input terminal thereof. The internal state of the third flip-flop circuit 814 is retained since the voltage level is changed from VDD3 to VDD2 in the CK input terminal thereof. HIGH is outputted to the output terminal of the inversion circuit 816 since the input terminal thereof is at the LOW level. In the AND circuit 817, HIGH is outputted to the output terminal thereof since HIGH is inputted to the A input terminal thereof and HIGH is inputted to the B input terminal thereof. In the OR circuit 818, HIGH is outputted to the output terminal thereof since HIGH is inputted to the A input terminal thereof and LOW is inputted to the B input terminal thereof. HIGH is transmitted in the enable signal line 843 because the output of the OR circuit 818 is at the HIGH level.

Operation Between Time 9 and Time 10

LOW is inputted from outside as the first clock control signal 821. HIGH is inputted from outside as the second clock control signal 822. LOW is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. LOW is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD2 in the clock signal line 803. HIGH is outputted from the pulse generator 810 to the reset signal line 842. The clock in which the voltage level is VDD2 is inputted from the clock signal line 803 to the functional block 804, and HIGH is inputted from the reset signal line 842 to the functional block 804. The clock in which the voltage level is VDD2 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is VDD2 in the CK input terminal thereof. The internal state of the second flip-flop circuit 813 is retained since the voltage level is VDD2 in the CK input terminal thereof. The internal state of the third flip-flop circuit 814 is retained since the voltage level is VDD2 in the CK input terminal thereof. HIGH is outputted to the output terminal of the inversion circuit 816 since the input terminal thereof is at the LOW level. In the AND circuit 817, HIGH is outputted to the output terminal thereof since HIGH is inputted to the A input terminal thereof and HIGH is inputted to the B input terminal thereof. In the OR circuit 818, HIGH is outputted to the output terminal thereof since HIGH is inputted to the A input terminal thereof and LOW is inputted to the B input terminal thereof. HIGH is transmitted in the enable signal line 843 because the output of the OR circuit 818 is at the HIGH level.

Operation at Time 10

LOW is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. LOW is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD2 in the clock signal line 803. HIGH is outputted from the pulse generator 810 to the reset signal line 842. The clock in which the voltage level is VDD2 is inputted from the clock signal line 803 to the functional block 804, and HIGH is inputted from the reset signal line 842 to the functional block 804. The clock in which the voltage level is VDD2 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is VDD2 in the CK input terminal thereof. The internal state of the second flip-flop circuit 813 is retained since the voltage level is VDD2 in the CK input terminal thereof. The internal state of the third flip-flop circuit 814 is retained since the voltage level is VDD2 in the CK input terminal thereof. HIGH is outputted to the output terminal of the inversion circuit 816 since the input terminal thereof is at the LOW level. In the AND circuit 817, HIGH is outputted to the output terminal thereof since HIGH is inputted to the A input terminal thereof and HIGH is inputted to the B input terminal thereof. In the OR circuit 818, HIGH is outputted to the output terminal thereof since HIGH is inputted to the A input terminal thereof and LOW is inputted to the B input terminal thereof. HIGH is transmitted in the enable signal line 843 because the output of the OR circuit 818 is at the HIGH level.

Operation Between Time 10 and Time 11

LOW is inputted from outside as the first clock control signal 821. LOW is inputted from outside as the second clock control signal 822. LOW is inputted from outside as the third clock control signal 823. LOW is inputted from the pulse generator 810 to the gate terminal D of the Nch transistor 811. HIGH is inputted from the pulse generator 810 to the gate terminal C of the Pch transistor 809. LOW is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VDD2 in the clock signal line 803. HIGH is outputted from the pulse generator 810 to the reset signal line 842. The clock in which the voltage level is VDD2 is inputted from the clock signal line 803 to the functional block 804, and HIGH is inputted from the reset signal line 842 to the functional block 804. The clock in which the voltage level is VDD2 is inputted to the CK input terminals of the first flip-flop circuit 812, the second flip-flop circuit 813, and the third flip-flop circuit 814, and HIGH is inputted to the R input terminals of the respective flip-flop circuits. The internal state of the first flip-flop circuit 812 is retained since the voltage level is VDD2 in the CK input terminal thereof. The internal state of the second flip-flop circuit 813 is retained since the voltage level is VDD2 in the CK input terminal thereof. The internal state of the third flip-flop circuit 814 is retained since the voltage level is VDD2 in the CK input terminal thereof. HIGH is outputted to the output terminal of the inversion circuit 816 since the input terminal thereof is at the LOW level. In the AND circuit 817, HIGH is outputted to the output terminal thereof since HIGH is inputted to the A input terminal thereof and HIGH is inputted to the B input terminal thereof. In the OR circuit 818, HIGH is outputted to the output terminal thereof since HIGH is inputted to the A input terminal thereof and LOW is inputted to the B input terminal thereof. HIGH is transmitted in the enable signal line 843 because the output of the OR circuit 818 is at the HIGH level.

Operation at Time 11

LOW is inputted from outside as the first clock control signal 821. LOW is inputted from outside as the second clock control signal 822. LOW is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is changed from VDD2 to VSS in the clock signal line 803. LOW is outputted from the pulse generator 810 to the reset signal line 842. The clock in which the voltage level is changed from VDD2 to VSS is inputted from the clock signal line 803 to the functional block 804, and LOW is inputted from the reset signal line 842 to the functional block 804. The clock in which the voltage level is changed from VDD2 to VSS is inputted to the CK input terminals of the first flip-flop circuit 812, the second flip-flop circuit 813, and the third flip-flop circuit 814, and LOW is inputted to the R input terminals of the respective flip-flop circuits. The internal state of the first flip-flop circuit 812 is LOW since the R input terminal thereof is at the LOW level. The internal state of the second flip-flop circuit 813 is LOW since the R input terminal thereof is at the LOW level. The internal state of the third flip-flop circuit 814 is LOW since the R terminal thereof is at the LOW level. HIGH is outputted to the output terminal of the inversion circuit 816 since the input terminal thereof is LOW. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the Low level.

Operation Between Time 11 to Time 12

LOW is inputted from outside as the first clock control signal 821. LOW is inputted from outside as the second clock control signal 822. LOW is inputted from outside as the third clock control signal 823. HIGH is inputted from the pulse generator 810 to the gate terminal D of the Nch transistor 811. HIGH is inputted from the pulse generator 810 to the gate terminal C of the Pch transistor 809. HIGH is inputted from the pulse generator 810 to the gate terminal B of the Pch transistor 808. HIGH is inputted from the pulse generator 810 to the gate terminal A of the Pch transistor 807. Since the gate potentials of the Nch transistor 811, the Pch transistor 809, the Pch transistor 808 and the Pch transistor 807 have the foregoing values, the voltage level is maintained at VSS in the clock signal line 803. LOW is outputted from the pulse generator 810 to the reset signal line 842. The clock in which the voltage level is VSS is inputted from the clock signal line 803 to the functional block 804, and LOW is inputted from the reset signal line 842 to the functional block 804. The clock in which the voltage level is VSS is inputted to the CK input terminals of the first flip-flop circuit 812, the second flip-flop circuit 813, and the third flip-flop circuit 814, and LOW is inputted to the R input terminals of the respective flip-flop circuits. The internal state of the first flip-flop circuit 812 is LOW since the R input terminal thereof is at the LOW level. The internal state of the second flip-flop circuit 813 is LOW since the R input terminal thereof is at the LOW level. The internal state of the third flip-flop circuit 814 is LOW since the R terminal thereof is at the LOW level. HIGH is outputted to the output terminal of the inversion circuit 816 since the input terminal thereof is LOW. In the AND circuit 817, LOW is outputted to the output terminal thereof since HIGH is inputted to the A input terminal thereof and LOW is inputted to the B input terminal thereof. In the OR circuit 818, LOW is outputted to the output terminal thereof since LOW is inputted to the A input terminal thereof and LOW is inputted to the B input terminal thereof. LOW is transmitted in the enable signal line 843 because the output of the OR circuit 818 is at the LOW level.

As described, the enable signal used for the security and the like can be generated by means of the potential of the clock signal and the combinational circuit. In the present embodiment, the combinational circuit 815 comprises the inversion circuit, the AND circuit and the OR circuit, however, can be configured otherwise.

### Embodiment 9

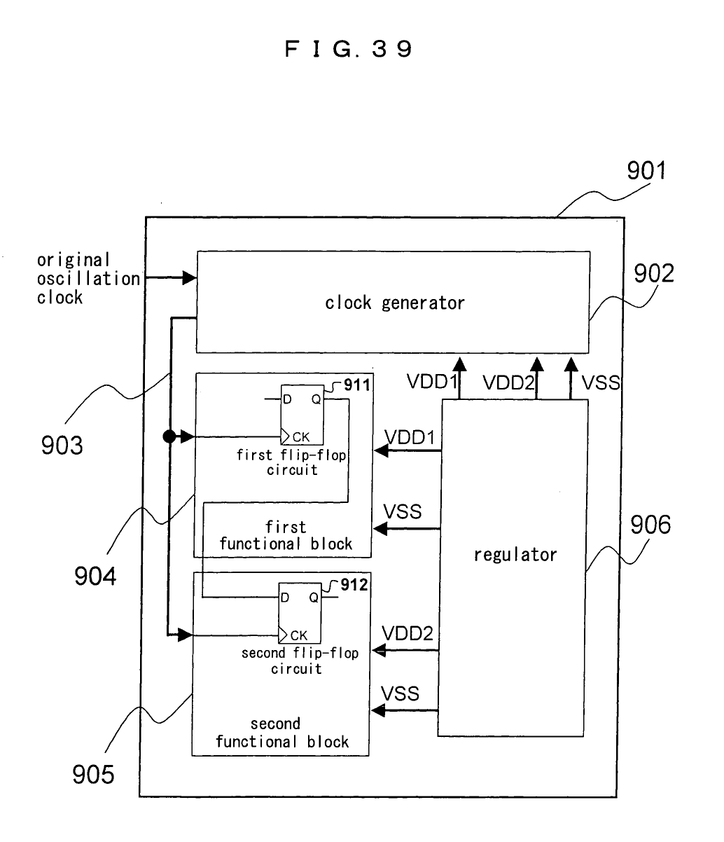

A disadvantage in the embodiment 8 is that the data cannot be received at an interval shorter than a half cycle. An embodiment 9 of the present embodiment improves the disadvantage. FIG. 39 is a block diagram illustrating a configuration of a semiconductor integrated circuit device according to the embodiment 9. A semiconductor integrated circuit device 901 comprises a clock generator (clock supplier) 902, a clock signal line 903, a first functional block (first function executor) 904, a second functional block (second function executor) 905, and a regulator (voltage supplier) 906.

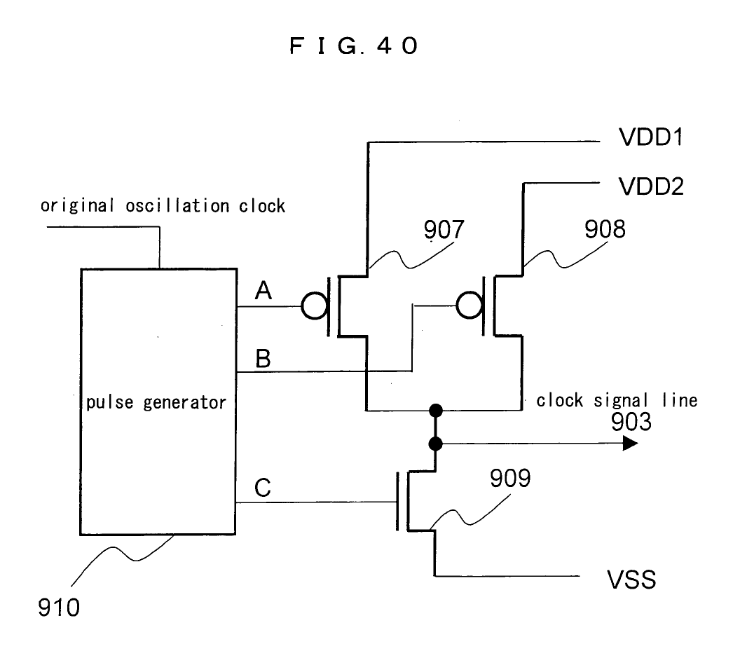

Power-supply voltage VDD1 and VDD2 and a reference voltage VSS are supplied from the regulator 906 to the clock generator 902. FIG. 40 is a circuit diagram of the clock generator 902. The clock generator 902 comprises a pulse generator 910, a Pch transistor 907, a Pch transistor 908, and an Nch transistor 909.

An original oscillation clock from outside is connected to the pulse generator 910. A drain terminal of the Pch transistor 907 is connected to the power-supply voltage VDD1, and a gate terminal thereof is connected to the pulse generator 910. A drain terminal of the Pch transistor 908 is connected to the power-supply voltage VDD2, and a gate terminal thereof is connected to the pulse generator 910. The power-supply voltage VDD2 is lower than the power-supply voltage VDD1. A drain terminal of the Nch transistor 909 is connected to a source terminal of the transistor 907, a source terminal of the transistor 908, and the clock signal line 903. A gate terminal of the Nch transistor 909 is connected to the pulse generator 910, and a source terminal thereof is connected to VSS.

The first functional block 904 comprises a first flip-flop circuit (first retainer) 911. The first flip-flop circuit 911 comprises a D input terminal connected to a logic in a previous stage, a Q output terminal connected to a D input terminal of a second flip-flop circuit 912, and a CK input terminal to which a clock is inputted from the clock signal line 903. The first flip-flop circuit 911 fetches the potential of the D input terminal thereof when a potential lower than Level A (second threshold value) changes into a potential at least the Level A.

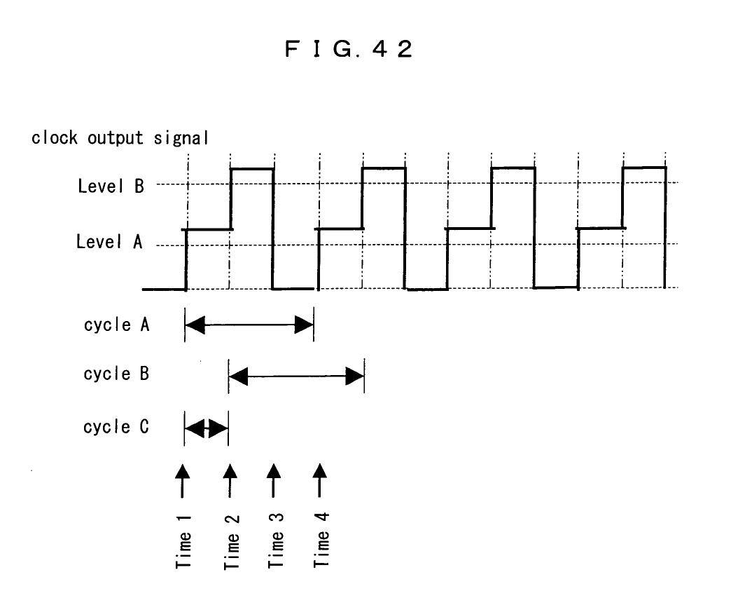

The second functional block 905 comprises the second flip-flop circuit (second retainer) 912. The second flip-flop circuit 912 comprises a D input terminal connected to the Q input terminal of the first flip-flop circuit 911, a Q output terminal connected to the logic in a subsequent stage, and a CK input terminal to which the clock is inputted from the clock signal line 903. The second flip-flop circuit 912 fetches the potential of the D input terminal when a potential lower than Level B (first threshold value) changes into a potential at least the Level B. A relationship between the Levels A and B is, as shown in FIG. 42, Level A<Level B.

The clock signal line 903 supplies a clock signal outputted from the clock generator 902 to the first functional block 904 and the second functional block 905. The regulator 906 supplies the power-supply voltages VDD1 and VDD2 (VDD2<VDD1) and the reference voltage VSS to the clock generator 902, supplies the power-supply voltage VDD1 and the reference voltage VSS to the first functional block, and supplies the power-supply voltage VDD2 and the reference voltage VSS to the second functional block.

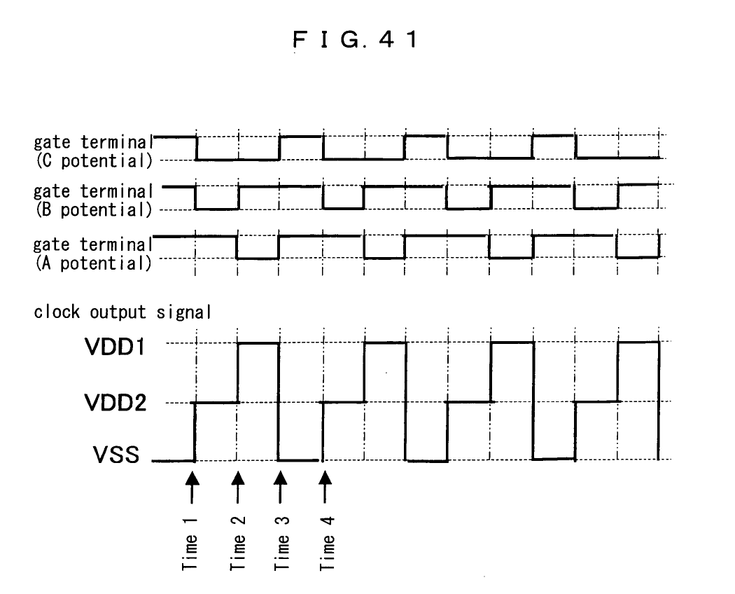

An operation of the semiconductor integrated circuit device thus configured is described below. FIG. 41 is a timing chart for illustrating a relationship among the gate terminal (A potential) of the Pch transistor 907, the gate terminal (B potential) of the Pch transistor 908, the gate terminal (C potential) of the Nch transistor 909, and the clock signal outputted from the clock generator 902 and transmitted via the clock signal line 903. FIG. 42 is a timing chart for illustrating a relationship among the clock signal line 903, the first functional block 904, and the second functional block 905. Below are described operations in Time 1-Time 5 shown in FIGS. 41 and 42.

Operation at Time 1

LOW is inputted from the pulse generator 910 to the gate terminal C of the Nch transistor 909. LOW is inputted from the pulse generator 910 to the gate terminal B of the Pch transistor 908. HIGH is inputted from the pulse generator 910 to the gate terminal A of the Pch transistor 907. Since the gate potentials of the Nch transistor 909, the Pch transistor 908 and the Pch transistor 907 have the foregoing values, the voltage level is changed from VSS to VDD2 in the clock signal line 903. The clock in which the voltage level is changed from VSS to VDD2 is inputted from the clock signal line 903 to the first functional block 904. In the first flip-flop circuit 911, the value of the D terminal is fetched since the voltage level is changed from VSS to VDD2 in the CK terminal thereof. The clock in which the voltage level is changed from VSS to VDD2 is inputted from the clock signal line 903 to the second functional block 905. In the second flip-flop circuit 912, the internal data is retained since the voltage level is changed from VSS to VDD2 in the CK terminal thereof.

Operation Between Time 1 and Time 2

LOW is inputted from the pulse generator 910 to the gate terminal C of the Nch transistor 909. LOW is inputted from the pulse generator 910 to the gate terminal B of the Pch transistor 908. HIGH is inputted from the pulse generator 910 to the gate terminal A of the Pch transistor 907. Since the gate potentials of the Nch transistor 909, the Pch transistor 908 and the Pch transistor 907 have the foregoing values, the voltage level is maintained at VDD2 in the clock signal line 903. The clock in which the voltage level is VDD2 is inputted from the clock signal line 903 to the first functional block 904. In the first flip-flop circuit 911, the internal data is retained since the voltage level is VDD2 in the CK terminal thereof. The clock in which the voltage level is VDD2 is inputted from the clock signal line 903 to the second functional block 905. In the second flip-flop circuit 912, the internal data is retained since the voltage level is VDD2 in the CK terminal thereof.

Operation at Time 2

LOW is inputted from the pulse generator 910 to the gate terminal C of the Nch transistor 909. HIGH is inputted from the pulse generator 910 to the gate terminal B of the Pch transistor 908. LOW is inputted from the pulse generator 910 to the gate terminal A of the Pch transistor 907. Since the gate potentials of the Nch transistor 909, the Pch transistor 908 and the Pch transistor 907 have the foregoing values, the voltage level is changed from VDD2 to VDD1 in the clock signal line 903. The clock in which the voltage level is changed from VDD2 to VDD1 is inputted from the clock signal line 903 to the first functional block 904. In the first flip-flop circuit 911, the internal data is retained since the voltage level is changed from VDD2 to VDD1 in the CK terminal thereof. The clock in which the voltage level is changed from VDD2 to VDD1 is inputted from the clock signal line 903 to the second functional block 905. In the second flip-flop circuit 912, the value of the D terminal is fetched since the voltage level is changed from VDD2 to VDD1 in the CK terminal thereof.

Operation Between Time 2 and Time 3

LOW is inputted from the pulse generator 910 to the gate terminal C of the Nch transistor 909. HIGH is inputted from the pulse generator 910 to the gate terminal B of the Pch transistor 908. LOW is inputted from the pulse generator 910 to the gate terminal A of the Pch transistor 907. Since the gate potentials of the Nch transistor 909, the Pch transistor 908 and the Pch transistor 907 have the foregoing values, the voltage level is maintained at VDD1 in the clock signal line 903. The clock in which the voltage level is VDD1 is inputted from the clock signal line 903 to the first functional block 904. In the first flip-flop circuit 911, the internal data is retained since the voltage level is VDD1 in the CK terminal thereof. The clock in which the voltage level is VDD1 is inputted from the clock signal line 903 to the second functional block 905. In the second flip-flop circuit 912, the internal data is retained since the voltage level is VDD1 in the CK terminal thereof.

Operation at Time 3

HIGH is inputted from the pulse generator 910 to the gate terminal C of the Nch transistor 909. HIGH is inputted from the pulse generator 910 to the gate terminal B of the Pch transistor 908. HIGH is inputted from the pulse generator 910 to the gate terminal A of the Pch transistor 907. Since the gate potentials of the Nch transistor 909, the Pch transistor 908 and the Pch transistor 907 have the foregoing values, the voltage level is changed from VDD1 to VSS in the clock signal line 903. The clock in which the voltage level is changed from VDD1 to VSS is inputted from the clock signal line 903 to the first functional block 904. In the first flip-flop circuit 911, the internal data is retained since the voltage level is changed from VDD1 to VSS in the CK terminal thereof. The clock in which the voltage level is changed from VDD1 to VSS is inputted from the clock signal line 903 to the second functional block 905. In the second flip-flop circuit 912, the internal data is retained since the voltage level is changed from VDD1 to VSS in the CK terminal thereof.

Operation Between Time 3 and Time 4

HIGH is inputted from the pulse generator 910 to the gate terminal C of the Nch transistor 909. HIGH is inputted from the pulse generator 910 to the gate terminal B of the Pch transistor 908. HIGH is inputted from the pulse generator 910 to the gate terminal A of the Pch transistor 907. Since the gate potentials of the Nch transistor 909, the Pch transistor 908 and the Pch transistor 907 have the foregoing values, the voltage level is maintained at VSS in the clock signal line 903. The clock in which the voltage level is VSS is inputted from the clock signal line 903 to the first functional block 904. In the first flip-flop circuit 911, the internal data is retained since the voltage level is VSS in the CK terminal thereof. The clock in which the voltage level is VSS is inputted from the clock signal line 903 to the second functional block 905. In the second flip-flop circuit 912, the internal data is retained since the voltage level is VSS in the CK terminal thereof.

When the operations from the Time 1 through Time 4 are repeated, the data is fetched based on Cycle A in the first flip-flop circuit 911, the data outputted from the first flip-flop circuit 911 is fetched subsequent to an interval C in the second flip-flop circuit 912, and the second flip-flop circuit 912 operates based on Cycle B.

When the clock signals having the different amplitudes and the flip-flop circuits having the different threshold values are thus used, two different frequencies can be simultaneously supplied through one clock signal line. Further, the data can be fetched at an interval shorter than the half cycle. There are the two threshold values for the flip-flop circuits in the present embodiment, however, three threshold values may be provided.

### Embodiment 10

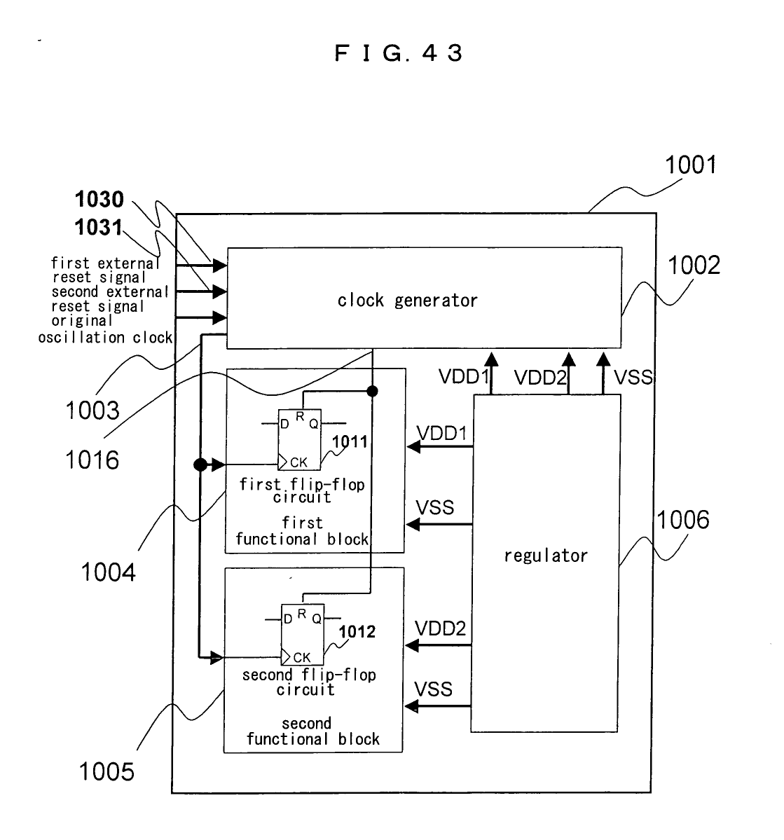

A disadvantage in the embodiment 9 is that the functional block to be asynchronously reset cannot be selected through one reset signal line. An embodiment 10 of the present invention improves the disadvantage. FIG. 43 is a block diagram illustrating a configuration of a semiconductor integrated circuit device according to the embodiment 10.

A semiconductor integrated circuit device 1001 comprises a clock generator (clock supplier) 1002, a clock signal line 1003, a first functional block (first function executor) 1004, a second functional block (second function executor) 1005, and a regulator (voltage supplier) 1006.

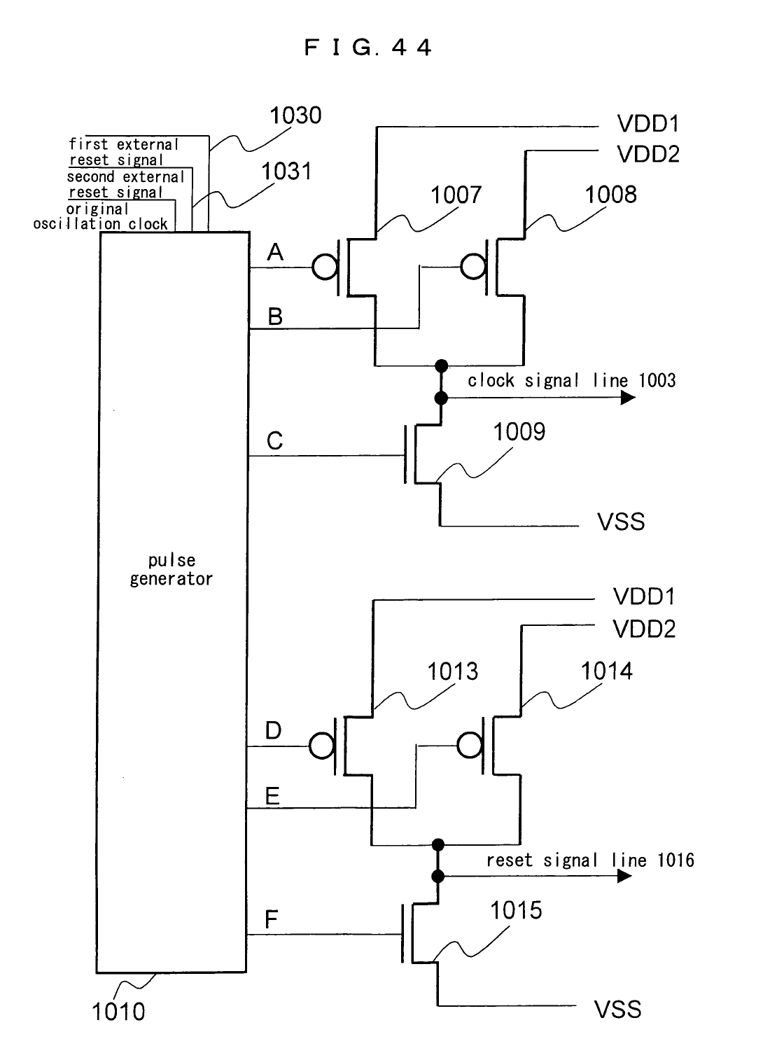

Power-supply voltage VDD1 and VDD2 and a reference voltage VSS are supplied from the regulator 1006 to the clock generator 1002. FIG. 44 is a circuit diagram of the clock generator 1002. The clock generator 1002 comprises a pulse generator 1010, a Pch transistor 1007, a Pch transistor 1008, an Nch transistor 1009, a Pch transistor 1013, a Pch transistor 1014, and an Nch transistor 1015.

An original oscillation clock, a first external reset signal 1030, and a second external reset signal 1031 from outside are connected to the pulse generator 1010. A drain terminal of the Pch transistor 1007 is connected to the power-supply voltage VDD1, and a gate terminal thereof is connected to the pulse generator 1010. A drain terminal of the Pch transistor 1008 is connected to the power-supply voltage VDD2, and a gate terminal thereof is connected to the pulse generator 1010. The power-supply voltage VDD2 is lower than the power-supply voltage VDD1. A drain terminal of the Nch transistor 1009 is connected to a source terminal of the transistor 1007, a source terminal of the transistor 1008, and the clock signal line 1003. A gate terminal of the Nch transistor 1009 is connected to the pulse generator 1010, and a source terminal thereof is connected to VSS. A drain terminal of the Pch transistor 1013 is connected to the power-supply voltage VDD1, and a gate terminal thereof is connected to the pulse generator 1010. A drain terminal of the Pch transistor 1014 is connected to the power-supply voltage VDD2, and a gate terminal thereof is connected to the pulse generator 1010. A drain terminal of the Nch transistor 1015 is connected to a source terminal of the transistor 1013, a source terminal of the transistor 1014, and a reset signal line 1016. A gate terminal of the Nch transistor 1015 is connected to the pulse generator 1010, and a source terminal thereof is connected to VSS.

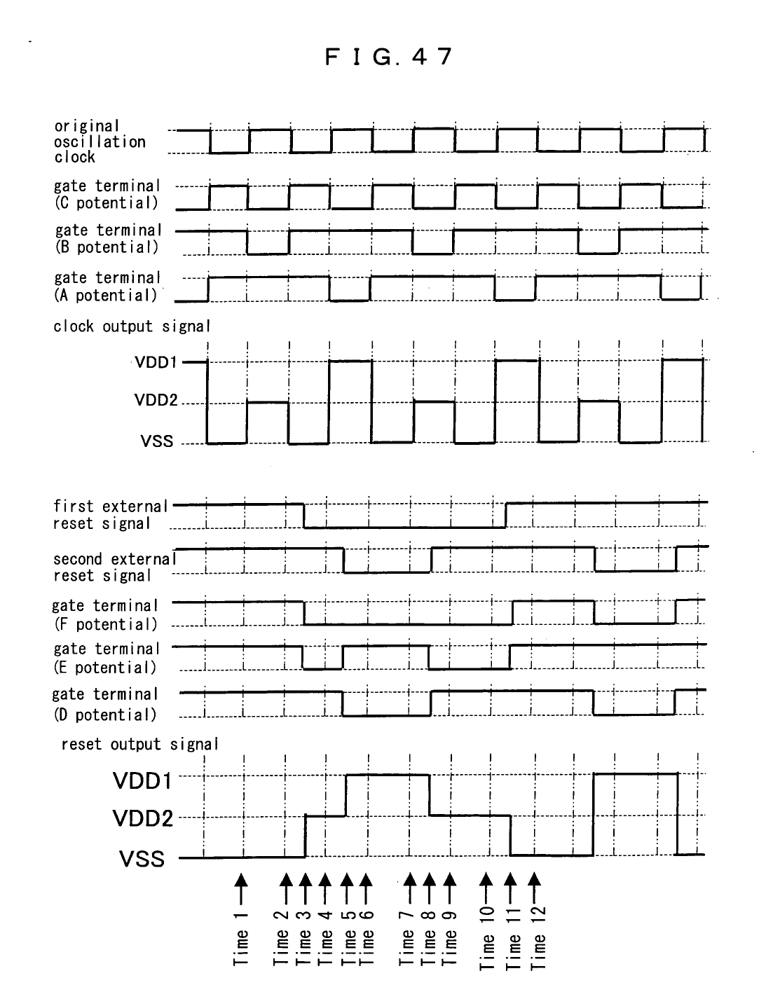

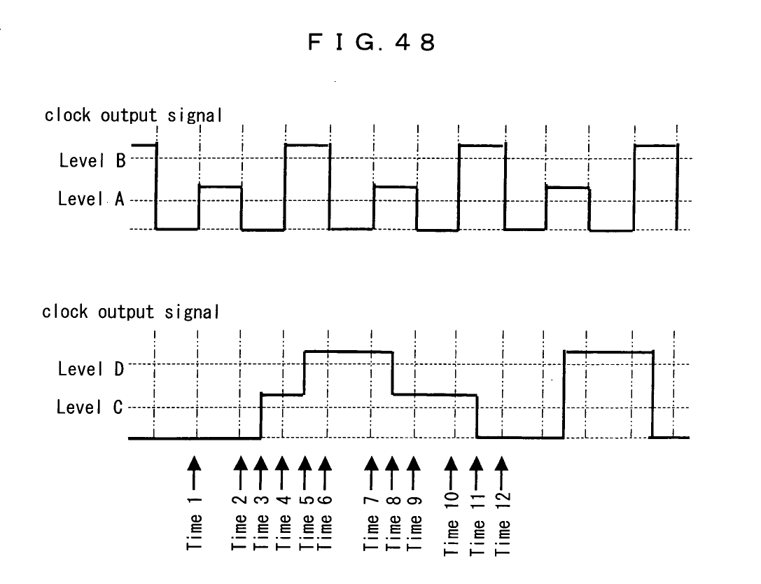

The pulse generator 1010 can supply potentials shown in FIGS. 47 and 48 to the gate terminal (A potential), the gate terminal (B potential), the gate terminal (C potential), the gate terminal (D potential), the gate terminal (E potential), and the gate terminal (F potential).

The clock signal line 1003 supplies a clock signal outputted from the clock generator 1002 to the first functional block 1004 and the second functional block 1005. The reset signal line 1016 supplies a reset signal outputted from the clock generator 1002 to the first functional block 1004 and the second functional block 1005.

The first functional block 1004 comprises a first flip-flop circuit 1011. The second functional block 1005 comprises a second flip-flop circuit 1012.

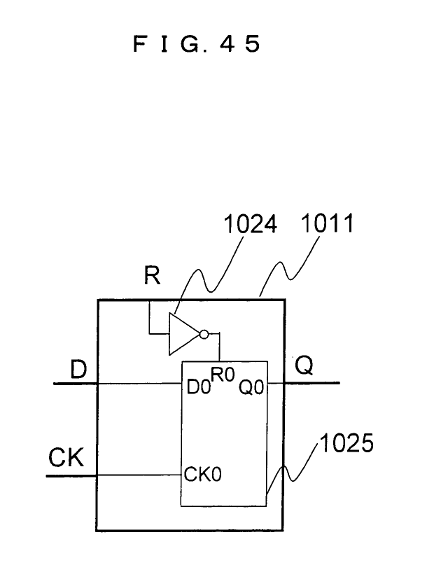

FIG. 48 shows threshold levels of the clock output signal and the reset signal. FIG. 45 is a circuit diagram of the first flip-flop circuit 1011. The first flip-flop circuit 1011 comprises an inverter 1024 and a data flip-flop 1025.

In the inverter 1024, an input terminal thereof is connected to a R input terminal of the first flip-flop circuit 1011, an output terminal thereof is connected to a R0 input terminal of the data flip-flop 1025, and LOW is outputted when the potential of the R input terminal is at least Level C (fourth threshold value).

In the data flip-flop 1025, a D0 input terminal thereof is connected to a D terminal of the first flip-flop circuit 1011, a CK0 input terminal thereof is connected to a CK terminal of the first flip-flop circuit 1011, a Q0 output terminal thereof is connected to a Q terminal of the first flip-flop circuit 1011, the potential of the D terminal is fetched when the potential of the CK terminal changes from a potential below Level A (second threshold value) to a potential at least the Level A, and LOW is outputted to the Q0 output terminal when the potential of the R0 input terminal is at the LOW level.

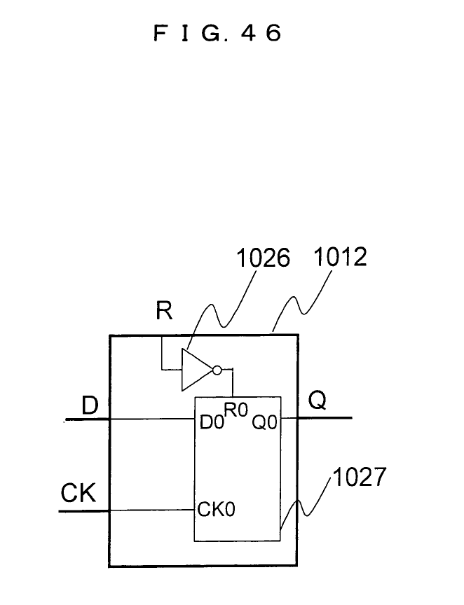

FIG. 46 is a circuit diagram of the second flip-flop circuit 1012. The second flip-flop circuit 1012 comprises an inverter 1026 and a data flip-flop 1027.

In the inverter 1026, an input terminal thereof is connected to a R input terminal of the second flip-flop circuit 1012, an output terminal thereof is connected to a R0 input terminal of the second flip-flop circuit 1012, and LOW is outputted when the potential of the R input terminal is at least Level D (third threshold value). A relationship between the Levels C and D is Level C<Level D as shown in FIG. 48.

In the data flip-flop 1027, a D0 input terminal thereof is connected to a D terminal of the second flip-flop circuit 1012, a CK0 input terminal thereof is connected to a CK terminal of the second flip-flop circuit 1012, a Q0 output terminal thereof is connected to a Q terminal of the second flip-flop circuit 1012, the potential of the D terminal is fetched when the potential of the CK terminal changes from a potential below Level B (first threshold value) to a potential at least the Level B, and LOW is outputted to the Q0 output terminal when the potential of the R0 input terminal is at the LOW level. A relationship between the Levels A and B is Level A<Level B as shown in FIG. 48.

The regulator 1006 supplies the power-supply voltages VDD1 and VDD2 (VDD2<VDD1) and the reference voltage VSS to the clock generator 1002, supplies the power-supply voltage VDD1 and the reference voltage VSS to the first functional block 1004, and supplies the power-supply voltage VDD2 and the reference voltage VSS to the second functional block 1005.

An operation of the semiconductor integrated circuit device thus configured is described below. FIG. 47 is a timing chart for illustrating a relationship among the first external reset signal 1030, the second external reset signal 1031, the original oscillation clock, the gate terminal (A potential) of the Pch transistor 1007, the gate terminal (B potential) of the Pch transistor 1008, the gate terminal (C potential) of the Nch transistor 1009, the clock signal outputted from the clock generator 1002 and transmitted via the clock signal line 1003, the gate terminal (D potential) of the Pch transistor 1013, the gate terminal (E potential) of the Pch transistor 1014, the gate terminal (F potential) of the Nch transistor 1015, and the reset signal 1016 outputted from the clock generator 1002 and transmitted via the reset signal line 1016. Below are described operations in Time 1-Time 12 shown in FIG. 47

Operation at Time 1

LOW is inputted from the pulse generator 1010 to the gate terminal C of the Nch transistor 1009. LOW is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VSS to VDD2 in the clock signal line 1003. HIGH is inputted from outside as the first external reset signal 1030. HIGH is inputted from outside as the second external reset signal 1031. HIGH is inputted from the pulse generator 1010 to the gate terminal F of the Nch transistor 1015. HIGH is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VSS is outputted to the reset signal line 1016. The clock in which the voltage level is changed from VSS to VDD2 from the clock signal line 1003 and the potential of VSS from the reset signal line 1016 are inputted to the first and second functional blocks 1004 and 1005. In the first and second flip-flop circuits 1011 and 1012, the clock in which the voltage level is changed from VSS to VDD2 is inputted to the CK input terminals thereof, and the potential of VSS is inputted to the R input terminals thereof. In the inverter 1024, HIGH is outputted since the potential of the input terminal thereof is below the Level C. In the data flip-flop 1025, the value of the D0 input terminal is fetched since the clock in which the voltage level is changed from VSS to VDD2 is inputted to the CK0 input terminal thereof, and HIGH is inputted to the R0 input terminal thereof. In the inverter 1026, HIGH is outputted since the potential of the input terminal thereof is below the Level D. In the data flip-flop 1027, the internal data is retained since the clock in which the voltage level is changed from VSS to VDD2 is inputted to the CK0 input terminal thereof and HIGH is inputted to the R0 input terminal thereof.

Operation Between Time 1 and Time 2

LOW is inputted from the pulse generator 1010 to the gate terminal C of the Nch transistor 1009. LOW is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is maintained at VDD2 in the clock signal line 1003. HIGH is inputted from outside as the first external reset signal 1030. HIGH is inputted from outside as the second external reset signal 1031. HIGH is inputted from the pulse generator 1010 to the gate terminal F of the Nch transistor 1015. HIGH is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VSS is outputted to the reset signal line 1016. The clock in which the voltage level is VDD2 from the clock signal line 1003 and the potential of VSS from the reset signal line 1016 are inputted to the first and second functional blocks 1004 and 1005. In the first and second flip-flop circuits 1011 and 1012, the clock in which the potential is VDD2 is inputted to the CK input terminals thereof, and the potential of VSS is inputted to the R input terminals thereof. In the inverter 1024, HIGH is outputted since the potential of the input terminal thereof is below the Level C. In the data flip-flop 1025, the internal state is retained since the clock in which the potential is VDD2 is inputted to the CK0 input terminal thereof, and HIGH is inputted to the R0 input terminal thereof. In the inverter 1026, HIGH is outputted since the potential of the input terminal thereof is below the Level D. In the data flip-flop 1027, the internal state is retained since the clock in which the potential is VDD2 is inputted to the CK0 input terminal thereof and HIGH is inputted to the R0 input terminal thereof.

Operation at Time 2

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VDD2 to VSS in the clock signal line 1003. HIGH is inputted from outside as the first external reset signal 1030. HIGH is inputted from outside as the second external reset signal 1031. HIGH is inputted from the pulse generator 1010 to the gate terminal F of the Nch transistor 1015. HIGH is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VSS is outputted to the reset signal line 1016. The clock in which the voltage level is changed from VDD2 to VSS from the clock signal line 1003 and the potential of VSS from the reset signal line 1016 are inputted to the first and second functional blocks 1004 and 1005. In the first and second flip-flop circuits 1011 and 1012, the clock in which the voltage level is changed from VDD2 to VSS is inputted to the CK input terminals thereof, and the potential of VSS is inputted to the R input terminals thereof. In the inverter 1024, HIGH is outputted since the potential of the input terminal thereof is below the Level C. In the data flip-flop 1025, the internal state is retained since the clock in which the potential level is changed from VDD2 to VSS is inputted to the CK0 input terminal thereof, and HIGH is inputted to the R0 input terminal thereof. In the inverter 1026, HIGH is outputted since the potential of the input terminal thereof is below the Level D. In the data flip-flop 1027, the internal tate is retained since the clock in which the voltage level is changed from VDD2 to VSS is inputted to the CK0 input terminal thereof and HIGH is inputted to the R0 input terminal thereof.

Operation at Time 3

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage at the level of VSS is outputted from the clock signal line 1003. LOW is inputted from outside as the first external reset signal 1030. HIGH is inputted from outside as the second external reset signal 1031. LOW is inputted from the pulse generator 1010 to the gate terminal F of the Nch transistor 1015. LOW is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage changed from VSS to VSS2 is outputted from the reset signal line 1016. The clock in which the voltage level is VSS from the clock signal line 1003 and the potential changed from VSS to VDD2 from the reset signal line 1016 are inputted to the first and second functional blocks 1004 and 1005. In the first and second flip-flop circuits 1011 and 1012, the clock in which the potential is VSS is inputted to the CK input terminals thereof, and the potential changed from VSS to VDD2 is inputted to the R input terminals thereof. In the inverter 1024, LOW is outputted since the potential of the input terminal thereof is at least the Level C. In the data flip-flop 1025, the internal state becomes LOW since the clock whose potential is VSS is inputted to the CK0 input terminal thereof, and LOW is inputted to the R0 input terminal thereof. In the inverter 1026, HIGH is outputted since the potential of the input terminal thereof is below the Level D. In the data flip-flop 1027, the internal state is retained since the clock whose potential is VSS is inputted to the CK0 input terminal thereof and HIGH is inputted to the R0 input terminal thereof.

Operation at Time 4

LOW is inputted from the pulse generator 1010 to the gate terminal C of the Nch transistor 1009. HIGH is inputted from the pulse generator 1010 to the gate terminal B of the Pch transistor 1008. LOW is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VSS to VDD1 in the clock signal line 1003. LOW is inputted from outside as the first external reset signal 1030. HIGH is inputted from outside as the second external reset signal 1031. LOW is inputted from the pulse generator 1010 to the gate terminal F of the Nch transistor 1015. LOW is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VSS is outputted to the reset signal line 1016. The clock in which the voltage level is changed from VSS to VDD1 from the clock signal line 1003 and the potential of VDD2 from the reset signal line 1016 are inputted to the first and second functional blocks 1004 and 1005. In the first and second flip-flop circuits 1011 and 1012, the clock in which the voltage level is changed from VSS to VDD1 is inputted to the CK input terminals thereof, and the potential of VDD2 is inputted to the R input terminals thereof. In the inverter 1024, LOW is outputted since the potential of the input terminal thereof is at least the Level C. In the data flip-flop 1025, the internal state becomes LOW since the clock in which the voltage level is changed from VSS to VDD1 is inputted to the CK0 input terminal thereof, and LOW is inputted to the R0 input terminal thereof. In the inverter 1026, HIGH is outputted since the potential of the input terminal thereof is below the Level D. In the data flip-flop 1027, the value of the D0 input terminal is fetched since the clock in which the voltage level is changed from VSS to VDD1 is inputted to the CK0 input terminal thereof and HIGH is inputted to the R0 input terminal thereof.

Operation at Time 5

LOW is inputted from the pulse generator 1010 to the gate terminal C of the Nch transistor 1009. HIGH is inputted from the pulse generator 1010 to the gate terminal B of the Pch transistor 1008. LOW is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is maintained at VDD1 in the clock signal line 1003. LOW is inputted from outside as the first external reset signal 1030. LOW is inputted from outside as the second external reset signal 1031. LOW is inputted from the pulse generator 1010 to the gate terminal F of the Nch transistor 1015. HIGH is inputted from the pulse generator 1010 to the gate terminal E of the Pch transistor 1014. LOW is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage changed from VDD2 to VDD1 is outputted to the reset signal line 1016. The clock whose voltage level is VDD1 from the clock signal line 1003 and the potential changed from VDD2 to VDD1 from the reset signal line 1016 are inputted to the first and second functional blocks 1004 and 1005. In the first and second flip-flop circuits 1011 and 1012, the clock whose potential is VDD1 is inputted to the CK input terminals thereof, and the potential changed from VDD2 to VDD1 is inputted to the R input terminals thereof. In the inverter 1024, LOW is outputted since the potential of the input terminal thereof is at least the Level C. In the data flip-flop 1025, the internal state becomes LOW since the clock whose potential is VDD1 is inputted to the CK0 input terminal thereof, and LOW is inputted to the R0 input terminal thereof. In the inverter 1026, LOW is outputted since the potential of the input terminal thereof is at least the Level D. In the data flip-flop 1027, the internal state becomes LOW since the clock whose potential is VDD1 is inputted to the CK0 input terminal thereof and LOW is inputted to the R0 input terminal thereof.

Operation at Time 6

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VDD1 to VSS in the clock signal line 1003. LOW is inputted from outside as the first external reset signal 1030. LOW is inputted from outside as the second external reset signal 1031. LOW is inputted from the pulse generator 1010 to the gate terminal F of the Nch transistor 1015. HIGH is inputted from the pulse generator 1010 to the gate terminal E of the Pch transistor 1014. LOW is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VDD1 is outputted to the reset signal line 1016. The clock in which the voltage level is changed from VDD1 to VSS from the clock signal line 1003 and the potential of VDD1 from the reset signal line 1016 are inputted to the first and second functional blocks 1004 and 1005. In the first and second flip-flop circuits 1011 and 1012, the clock in which the voltage level is changed from VDD1 to VSS is inputted to the CK input terminals thereof, and the potential of VDD1 is inputted to the R input terminals thereof. In the inverter 1024, LOW is outputted since the potential of the input terminal thereof is at least the Level C. In the data flip-flop 1025, the internal state becomes LOW since the clock in which the voltage level is changed from VDD1 to VSS is inputted to the CK0 input terminal thereof, and LOW is inputted to the R0 input terminal thereof. In the inverter 1026, LOW is outputted since the potential of the input terminal thereof is at least the Level D. In the data flip-flop 1027, the internal state becomes LOW since the clock in which the voltage level is changed from VDD1 to VSS is inputted to the CK0 input terminal thereof and LOW is inputted to the R0 input terminal thereof.

Operation Between Time 6 and Time 7

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is maintained at VSS in the clock signal line 1003. LOW is inputted from outside as the first external reset signal 1030. LOW is inputted from outside as the second external reset signal 1031. LOW is inputted from the pulse generator 1010 to the gate terminal F of the Nch transistor 1015. HIGH is inputted from the pulse generator 1010 to the gate terminal E of the Pch transistor 1014. LOW is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VDD1 is outputted to the reset signal line 1016. The clock whose potential is VSS from the clock signal line 1003 and the potential of VDD1 from the reset signal line 1016 are inputted to the first and second functional blocks 1004 and 1005. In the first and second flip-flop circuits 1011 and 1012, the clock whose potential is VSS is inputted to the CK input terminals thereof, and the potential of VDD1 is inputted to the R input terminals thereof. In the inverter 1024, LOW is outputted since the potential of the input terminal thereof is at least the Level C. In the data flip-flop 1025, the internal state becomes LOW since the clock in which the voltage level is VSS is inputted to the CK0 input terminal thereof, and LOW is inputted to the R0 input terminal thereof. In the inverter 1026, LOW is outputted since the potential of the input terminal thereof is at least the Level D. In the data flip-flop 1027, the internal state becomes LOW since the clock in which the voltage level is VSS is inputted to the CK0 input terminal thereof and LOW is inputted to the R0 input terminal thereof.

Operation at Time 7

LOW is inputted from the pulse generator 1010 to the gate terminal C of the Nch transistor 1009. LOW is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VSS to VDD2 in the clock signal line 1003. LOW is inputted from outside as the first external reset signal 1030. LOW is inputted from outside as the second external reset signal 1031. LOW is inputted from the pulse generator 1010 to the gate terminal F of the Nch transistor 1015. HIGH is inputted from the pulse generator 1010 to the gate terminal E of the Pch transistor 1014. LOW is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VDD1 is outputted to the reset signal line 1016. The clock in which the voltage level is changed from VSS to VDD2 from the clock signal line 1003 and the potential of VDD1 from the reset signal line 1016 are inputted to the first and second functional blocks 1004 and 1005. In the first and second flip-flop circuits 1011 and 1012, the clock in which the voltage level is changed from VSS to VDD2 is inputted to the CK input terminals thereof, and the potential of VSS is inputted to the R input terminals thereof. In the inverter 1024, LOW is outputted since the potential of the input terminal thereof is at least the Level C. In the data flip-flop 1025, the internal state becomes LOW since the clock in which the voltage level is changed from VSS to VDD2 is inputted to the CK0 input terminal thereof, and LOW is inputted to the R0 input terminal thereof. In the inverter 1026, LOW is outputted since the potential of the input terminal thereof is at least the Level D. In the data flip-flop 1027, the internal state is retained since the clock in which the voltage level is changed from VSS to VDD2 is inputted to the CK0 input terminal thereof and LOW is inputted to the R0 input terminal thereof.

Operation at Time 8

LOW is inputted from the pulse generator 1010 to the gate terminal C of the Nch transistor 1009. LOW is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage at the level of VDD2 is outputted to the clock signal line 1003. LOW is inputted from outside as the first external reset signal 1030. HIGH is inputted from outside as the second external reset signal 1031. LOW is inputted from the pulse generator 1010 to the gate terminal F of the Nch transistor 1015. LOW is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage changed from VDD1 to VDD2 is outputted to the reset signal line 1016. The clock whose potential is VDD2 from the clock signal line 1003 and the potential changed from VDD1 to VDD2 from the reset signal line 1016 are inputted to the first and second functional blocks 1004 and 1005. In the first and second flip-flop circuits 1011 and 1012, the clock whose potential is VDD2 is inputted to the CK input terminals thereof, and the potential changed from VDD1 to VDD2 is inputted to the R input terminals thereof. In the inverter 1024, LOW is outputted since the potential of the input terminal thereof is at least the Level C. In the data flip-flop 1025, the internal state becomes LOW since the clock whose potential is VDD2 is inputted to the CK0 input terminal thereof, and LOW is inputted to the R0 input terminal thereof. In the inverter 1026, HIGH is outputted since the potential of the input terminal thereof is below the Level D. In the data flip-flop 1027, the internal state becomes LOW since the clock whose potential is VDD2 is inputted to the CK0 input terminal thereof and HIGH is inputted to the R0 input terminal thereof.

Operation at Time 9

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VDD2 to VSS in the clock signal line 1003. LOW is inputted from outside as the first external reset signal 1030. HIGH is inputted from outside as the second external reset signal 1031. LOW is inputted from the pulse generator 1010 to the gate terminal F of the Nch transistor 1015. LOW is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VDD2 is outputted to the reset signal line 1016. The clock whose potential is changed from VDD2 to VSS from the clock signal line 1003 and the potential of VDD2 from the reset signal line 1016 are inputted to the first and second functional blocks 1004 and 1005. In the first and second flip-flop circuits 1011 and 1012, the clock in which the voltage level is changed from VDD2 to VSS is inputted to the CK input terminals thereof, and the potential of VDD2 is inputted to the R input terminals thereof. In the inverter 1024, LOW is outputted since the potential of the input terminal thereof is at least the Level C. In the data flip-flop 1025, the internal state becomes LOW since the clock in which the voltage level is changed from VDD2 to VSS is inputted to the CK0 input terminal thereof, and LOW is inputted to the R0 input terminal thereof. In the inverter 1026, HIGH is outputted since the potential of the input terminal thereof is below the Level D. In the data flip-flop 1027, the internal data is retained since the clock in which the voltage level is changed from VDD2 to VSS is inputted to the CK0 input terminal thereof and HIGH is inputted to the R0 input terminal thereof.

Operation Between Time 9 and Time 10

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is maintained at VSS in the clock signal line 1003. LOW is inputted from outside as the first external reset signal 1030. HIGH is inputted from outside as the second external reset signal 1031. LOW is inputted from the pulse generator 1010 to the gate terminal F of the Nch transistor 1015. LOW is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VDD2 is outputted to the reset signal line 1016. The clock whose potential is VSS from the clock signal line 1003 and the potential of VDD1 from the reset signal line 1016 are inputted to the first and second functional blocks 1004 and 1005. In the first and second flip-flop circuits 1011 and 1012, the clock whose potential is VSS is inputted to the CK input terminals thereof, and the potential of VDD2 is inputted to the R input terminals thereof. In the inverter 1024, LOW is outputted since the potential of the input terminal thereof is at least the Level C. In the data flip-flop 1025, the internal state becomes LOW since the clock whose potential is VSS is inputted to the CK0 input terminal thereof, and LOW is inputted to the R0 input terminal thereof. In the inverter 1026, HIGH is outputted since the potential of the input terminal thereof is below the Level D. In the data flip-flop 1027, the internal data is retained since the clock in which the voltage level is VSS is inputted to the CK0 input terminal thereof and HIGH is inputted to the R0 input terminal thereof.

Operation at Time 10

LOW is inputted from the pulse generator 1010 to the gate terminal C of the Nch transistor 1009. HIGH is inputted from the pulse generator 1010 to the gate terminal B of the Pch transistor 1008. LOW is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VSS to VDD1 in the clock signal line 1003. LOW is inputted from outside as the first external reset signal 1030. HIGH is inputted from outside as the second external reset signal 1031. LOW is inputted from the pulse generator 1010 to the gate terminal F of the Nch transistor 1015. LOW is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VDD2 is outputted to the reset signal line 1016. The clock in which the voltage level is changed from VSS to VDD1 from the clock signal line 1003 and the potential of VDD2 from the reset signal line 1016 are inputted to the first and second functional blocks 1004 and 1005. In the first and second flip-flop circuits 1011 and 1012, the clock in which the voltage level is changed from VSS to VDD1 is inputted to the CK input terminals thereof, and the potential of VDD2 is inputted to the R input terminals thereof. In the inverter 1024, LOW is outputted since the potential of the input terminal thereof is at least the Level C. In the data flip-flop 1025, the internal state becomes LOW since the clock in which the voltage level is changed from VSS to VDD1 is inputted to the CK0 input terminal thereof, and LOW is inputted to the R0 input terminal thereof. In the inverter 1026, HIGH is outputted since the potential of the input terminal thereof is below the Level D. In the data flip-flop 1027, the value of the D0 input terminal is fetched since the clock in which the voltage level is changed from VSS to VDD1 is inputted to the CK0 input terminal thereof and HIGH is inputted to the R0 input terminal thereof.

Operation at Time 11

LOW is inputted from the pulse generator 1010 to the gate terminal C of the Nch transistor 1009. HIGH is inputted from the pulse generator 1010 to the gate terminal B of the Pch transistor 1008. LOW is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage at the level of VDD1 is outputted to the clock signal line 1003. HIGH is inputted from outside as the first external reset signal 1030. HIGH is inputted from outside as the second external reset signal 1031. HIGH is inputted from the pulse generator 1010 to the gate terminal F of the Nch transistor 1015. HIGH is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage changed from VDD2 to VSS is outputted to the reset signal line 1016. The clock in which the voltage level is VDD1 from the clock signal line 1003 and the potential changed from VDD2 to VSS from the reset signal line 1016 are inputted to the first and second functional blocks 1004 and 1005. In the first and second flip-flop circuits 1011 and 1012, the clock whose potential is VDD1 is inputted to the CK input terminals thereof, and the potential changed from VDD2 to VSS is inputted to the R input terminals thereof. In the inverter 1024, HIGH is outputted since the potential of the input terminal thereof is below the Level C. In the data flip-flop 1025, the internal state is retained since the clock whose potential is VDD1 is inputted to the CK0 input terminal thereof, and HIGH is inputted to the R0 input terminal thereof. In the inverter 1026, HIGH is outputted since the potential of the input terminal thereof is below the Level D. In the data flip-flop 1027, the internal state is retained since the clock whose potential is VDD1 is inputted to the CK0 input terminal thereof and HIGH is inputted to the R0 input terminal thereof.

Operation at Time 12

HIGH is inputted from the pulse generator 1010 to the gate terminal C of the Nch transistor 1009. HIGH is inputted from the pulse generator 1010 to the gate terminal B of the Pch transistor 1008. HIGH is inputted from the pulse generator 1010 to the gate terminal A of the Pch transistor 1007. Since the gate potentials of the Nch transistor 1009, the Pch transistor 1008 and the Pch transistor 1007 have the foregoing values, the voltage level is changed from VDD1 to VSS2 in the clock signal line 1003. HIGH is inputted from outside as the first external reset signal 1030. HIGH is inputted from outside as the second external reset signal 1031. HIGH is inputted from the pulse generator 1010 to the gate terminal F of the Nch transistor 1015. HIGH is inputted from the pulse generator 1010 to the gate terminal E of the Pch transistor 1014. HIGH is inputted from the pulse generator 1010 to the gate terminal D of the Pch transistor 1013. Since the gate potentials of the Nch transistor 1015, the Pch transistor 1014 and the Pch transistor 1013 have the foregoing values, the voltage at the level of VSS is outputted from the reset signal line 1016. The clock in which the voltage level is changed from VDD1 to VSS from the clock signal line 1003 and the potential of VSS from the reset signal line 1016 are inputted to the first and second functional blocks 1004 and 1005. In the first and second flip-flop circuits 1011 and 1012, the clock in which the voltage level is changed from VDD1 to VSS is inputted to the CK input terminals thereof, and the potential of VSS is inputted to the R input terminals thereof. In the inverter 1024, HIGH is outputted since the potential of the input terminal thereof is below the Level C. In the data flip-flop 1025, the internal state is retained since the clock in which the voltage level is changed from VDD1 to VSS is inputted to the CK0 input terminal thereof, and HIGH is inputted to the R0 input terminal thereof. In the inverter 1026, HIGH is outputted since the potential of the input terminal thereof is below the Level D. In the data flip-flop 1027, the internal state is retained since the clock in which the voltage level is changed from VDD1 to VSS is inputted to the CK0 input terminal thereof and HIGH is inputted to the R0 input terminal thereof.

As described, the functional block to be asynchronously reset can be selected through one reset signal line based on the potential of the reset signal. In the description of the present embodiment, the asynchronous reset signal is used, however, an asynchronous set signal may be used. The number of the threshold values of the reset signals, which is two in the present embodiment, may be at least three.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A semiconductor integrated circuit device for generating a clock signal having a clock pulse which repeats a potential value “0” and at least two high potential values.

2. A semiconductor integrated circuit device comprising:
a clock supplier;
a first function executor;
a second function executor; and
a voltage supplier, wherein
the clock supplier generates a clock signal having a clock pulse which repeats a potential value “0” and at least two high potential values and supplies the generated clock signal to the first function executor and the second function executor,
the first function executor comprises at least one first retainer, and the first retainer sets a particular potential value as a first threshold value and fetches data when the potential of the clock signal changes from a potential lower than the first threshold value to a potential at least the first threshold value,
the second function executor comprises at least one second retainer, and the second retainer sets a potential value lower than the first threshold value as a second threshold value and fetches data when the potential of the clock signal changes from a potential lower than the second threshold value to a potential at least the second threshold value, and
the voltage supplier supplies the potential value “0” and the at least two high potential values to the clock supplier, the first function executor and the second function executor.

3. A semiconductor integrated circuit device as claimed in claim 2, wherein
the clock supplier generates a clock pulse whose potential value changes from the potential value “0” to the potential below the first threshold value as the clock signal and supplies the generated clock pulse to the first function executor and the second function executor,
the first retainer fetches the data when the potential of the clock signal changes from the potential value “0” to the potential at least the first threshold value in the first function executor, and
the second retainer fetches the data when the potential of the clock signal changes from the potential value “0” to the potential at least the second threshold value in the second function executor.

4. A semiconductor integrated circuit device as claimed in claim 2, wherein
the clock supplier generates a clock pulse whose potential value changes from the potential value “0” to a potential below the first threshold value and at least the second threshold value as the clock signal,
the first retainer retains its data non-fetch state since the potential of the clock signal does not change from the potential value “0” to the potential at least the first threshold value in the first function executor, and
the second retainer fetches the data when the potential of the clock signal changes from the potential value “0” to the potential at least the second threshold value in the second function executor.

5. A semiconductor integrated circuit device comprising:
a clock supplier;
a first function executor;
a second function executor; and
a voltage supplier, wherein
the clock supplier generates a clock signal having a clock pulse which repeats a low potential value and at least two high potential values and supplies the generated clock signal to the first function executor and the second function executor,
the first function executor comprises at least one first retainer, and the first retainer sets a particular potential value as a first threshold value and fetches data when the potential of the clock signal changes from a potential lower than the first threshold value to a potential at least the first threshold value;
the second function executor comprises at least one second retainer, and the second retainer sets a potential lower than the first threshold value as a second threshold value and fetches data when the potential of the clock signal changes from a potential lower than the second threshold value to a potential at least the second threshold value, and
the voltage supplier supplies the low potential value and the at least two high potential values to the clock supplier, the first function executor and the second function executor.

6. A semiconductor integrated circuit device as claimed in claim 5, wherein
the clock supplier generates a clock pulse whose potential value changes from the potential value below the second threshold value to the potential at least the second threshold value as the clock signal,
the first retainer retains its data non-fetch state since the potential of the clock signal does not change to the potential at least the first threshold value in the first function executor, and
the second retainer fetches the data when the potential of the clock signal changes from the potential below the second threshold value to the potential at least the second threshold value in the second function executor.

7. A semiconductor integrated circuit device as claimed in claim 5, wherein
the clock supplier generates a clock pulse whose potential changes from a potential below the first threshold value and at least the second threshold value to the potential at least the first threshold value as the clock signal,
the first retainer fetches the data when the potential of the clock signal changes from the potential below the first threshold value and at least the second threshold value to the potential at least the first threshold value in the first function executor, and
the second retainer retains its data non-fetch state since the potential of the clock signal changes from the potential at least the second threshold value to the potential at least the first threshold value in the second function executor.

8. A semiconductor integrated circuit device comprising:
a clock supplier;
a first voltage value converter;
a second voltage value converter;
a first function executor;
a second function executor; and
a voltage supplier, wherein
the clock supplier generates a clock signal having a clock pulse which repeats a potential value “0” and at least two high potential values and supplies the generated clock signal to the first voltage value converter and the second voltage value converter,
the first voltage value converter converts the clock signal and outputs the converted signal to the first function executor,
the second voltage value converter converts the clock signal and outputs the converted signal to the second function executor,
the first function executor comprises at least one first retainer, and the first retainer sets a particular potential value as a first threshold value and fetches data when the potential of the clock signal inputted from the first voltage value converter changes from a potential lower than the first threshold value to a potential at least the first threshold value,
the second function executor comprises at least one second retainer, and the second retainer sets a potential value lower than the first threshold value as a second threshold value and fetches data when the potential of the clock signal inputted from the second voltage value converter changes from a potential lower than the second threshold value to a potential at least the second threshold value,
the voltage supplier supplies the potential value “0” and the at least two high potential values to the first function executor, the second function executor and the clock supplier,
the first voltage value converter outputs the potential value “0” as the clock signal to the first function executor during a period when the potential value of the clock signal is lower than the first threshold value, and
the second voltage value converter outputs the second threshold value as the clock signal to the second function executor during a period when the potential value of the clock signal is at least the second threshold value.

9. A semiconductor integrated circuit device as claimed in claim 8, wherein
the clock supplier generates a clock pulse whose potential changes between the potential value “0” and the potential value at least the first threshold value as the clock signal,
the first voltage value converter directly outputs the clock signal without conversion, and
the second voltage value converter converts the clock signal into a clock signal whose potential value changes from the potential value “0” to the second threshold value and outputs the converted clock signal.

10. A semiconductor integrated circuit device as claimed in claim 8, wherein
the clock supplier generates a clock pulse whose potential value changes between the potential value “0” and a potential value below the first threshold value and at least the second threshold value as the clock signal,
the first voltage value converter outputs the potential value “0” as the clock signal since the potential of the clock signal is between the potential value “0” and the potential at least the second threshold value and below the first threshold value,
the second voltage value converter directly outputs the clock signal without conversion,
the first retainer retains its data non-fetch state since the potential of the clock signal is “0” in the first function executor, and
the second retainer fetches the data since the potential of the clock signal changes from the potential value “0” to the potential at least the threshold value of the second function executor in the second function executor.

11. A semiconductor integrated circuit device comprising:
a function executor comprising at least one first selector, at least one second selector, and at least one retainer;
a clock supplier for generating a clock signal having a clock pulse which repeats a potential value “0” and at least two high potential values and supplying the generated clock signal to the function executor; and
a voltage supplier for supplying the potential value “0” and the at least two high potential values to the function executor and the clock supplier, wherein
the first selector selects one of a first data and a second data respectively inputted from outside based on a selection signal,
the second selector sets a particular potential value in the clock signal as a first threshold value and sets a potential value lower than the first threshold value as a second threshold value, and selects one of the threshold values based on the selection signal, and
the retainer fetches the data selected by the first selector when the potential value of the clock signal changes from a potential lower than the threshold value selected by the second selector to a potential at least the selected threshold value.

12. A semiconductor integrated circuit device as claimed in claim 11, wherein
the clock supplier generates a clock pulse whose potential changes from the potential value “0” to the potential at least the first threshold value as the clock signal and supplies the generated clock pulse to the function executor, and
the retainer fetches the second data when the potential of the clock signal changes from the potential value “0” to the potential at least the first threshold value in a state where a high potential is inputted as the selection signal, the first selector selects the second data and the second selector selects the first threshold value in the function executor.

13. A semiconductor integrated circuit device as claimed in claim 11, wherein
the clock supplier generates a clock pulse whose potential changes from the potential value “0” to a potential at least the second threshold value and below the first threshold value as the clock signal and supplies the generated clock pulse to the function executor, and
the retainer fetches the first data when the potential of the clock signal changes from the potential value “0” to the potential at least the second threshold value and below the first threshold value in a state where a low potential is inputted as the selection signal, the first selector selects the first data and the second selector selects the second threshold value in the function executor.

14. A semiconductor integrated circuit device comprising:
a function executor comprising at least one selector and at least one retainer;
a clock supplier for generating a clock signal having a clock pulse which repeats a potential value “0” and at least two high potential values and supplying the generated clock signal to the function executor;
a controller for supplying a control signal for controlling a maximum potential value of the clock signal to the clock supplier; and
a voltage supplier for generating the potential value “0” and the at least two high potential values and supplying the generated potential values to the function executor and the clock supplier, the voltage supplier further supplying the potential value “0” and at least one high potential value to the controller, wherein
the selector sets a particular potential value in the clock signal as a first threshold value, and selects a first data from the first data and a second data respectively inputted from outside when the potential value of the clock signal is at least the first threshold value, while selecting the second data when the potential of the clock signal is lower than the first threshold value, and
the retainer sets a potential value lower than the first threshold value as a second threshold value, and fetches the data selected by the selector when the potential value of the clock signal changes from a potential lower than the second threshold value to a potential at least the second threshold value.

15. A semiconductor integrated circuit device as claimed in claim 14, wherein
the controller controls the maximum potential value to be a low potential,
the clock supplier generates the clock signal having a clock pulse whose potential value changes from the potential value “0” to a potential value at least the second threshold value and below the first threshold value and supplies the generated clock signal to the function executor,
the selector selects the second data since the potential of the clock signal is below the first threshold value, and
the retainer fetches the second data selected by the selector.

16. A semiconductor integrated circuit device as claimed in claim 14, wherein
the controller controls the maximum potential value to be a high potential,
the clock supplier generates the clock signal having a clock pulse whose potential value changes from the potential value “0” to a potential value at least the first threshold value and supplies the generated clock signal to the function executor,
the selector selects the first data since the potential of the clock signal is at least the first threshold value, and
the retainer fetches the first data selected by the selector.

17. A semiconductor integrated circuit device comprising:
a function executor comprising at least one retainer for fetching data from outside;
a clock supplier for generating a clock signal and supplying the generated clock signal to the function executor; and
a voltage supplier for supplying a potential value “0” and at least two high potential values to the function executor and the clock supplier, wherein
the retainer sets a particular potential value as a first threshold value and sets a potential value lower than the first threshold value as a second threshold value, and fetches the data showing “HIGH” when a potential of the clock signal changes from a potential lower than the second threshold value to a potential at least the first threshold value, while fetching the data showing “LOW” when the potential of the clock signal changes from the potential lower than the second threshold value to a potential at least the second threshold value and lower than the first threshold value,
the clock supplier generates a clock signal having a clock pulse which repeats the potential value “0” and the potential value at least the first threshold value when a control signal inputted from outside shows one value and supplies the generated clock signal to the function executor, and
the clock supplier further generates the clock signal having a clock pulse which repeats the potential value “0” and the potential value at least the second threshold value and lower than the first threshold value when the control signal shows any other value and supplies the generated clock signal to the function executor.

18. A semiconductor integrated circuit device as claimed in claim 17, wherein
the clock supplier generates the clock signal having a clock pulse whose potential changes from the potential value “0” to the potential at least the first threshold value in response to the input of the one value as the control signal and supplies the generated clock signal to the function executor, and
the retainer fetches the data as “HIGH” since the potential of the clock signal changes from the potential value “0” to the potential at least the first threshold value.

19. A semiconductor integrated circuit device as claimed in claim 17, wherein
the clock supplier generates the clock signal having a clock pulse whose potential value changes from the potential value “0” to the potential at least the second threshold value and below the first threshold value in response to the input of the any other value as the control signal and supplies the generated clock signal to the function executor, and
the retainer fetches the data as “LOW” since the potential of the clock signal changes from the potential value “0” to the potential at least the second threshold value and below the first threshold value.

20. A semiconductor integrated circuit device comprising:
a clock supplier for generating a clock signal having a clock pulse which repeats a potential value “0” and at least two high potential values;
a first controller for supplying a control signal for controlling a maximum potential value of the clock signal to the clock supplier;
a function executor comprising at least one second controller, at least one third controller and at least one retainer; and
a voltage supplier for supplying the potential value “0” and the at least two high potential values to the second controller, the function executor and the clock supplier and supplying the potential value “0” and at least one high potential value to the first controller, wherein
the second controller sets a particular potential value in the clock signal as a first threshold value, and outputs a low potential when the potential value of the clock signal is at least the first threshold value,
the third controller sets a potential value lower than the first threshold value as a second threshold value based on the control signal, and outputs the low potential when the potential value of the clock signal is at least the second threshold value,
the retainer sets a potential value lower than the second threshold value as a third threshold value, and sets its internal state to have a low potential when the potential value of the clock signal is at least the first threshold value, sets its internal state to have a high potential when the potential value of the clock signal is at least the second threshold value and below the first threshold value, and fetches data from outside when the potential value of the clock signal is at least the third threshold value and below the second threshold value.

21. A semiconductor integrated circuit device as claimed in claim 20, wherein
the first controller supplies the control signal for instructing that a clock pulse having a potential value at least the third threshold value and below the second threshold value is to be used as the clock signal to the clock supplier,
the clock supplier generates a clock pulse whose potential value changes from the potential value “0” to the potential at least the third threshold value and below the second threshold value as the clock signal based on the control signal and supplies the generated clock pulse to the function executor, and
the retainer fetches the data since the potential of the clock signal changes from the potential value “0” to the potential at least the third threshold value and below the second threshold value.

22. A semiconductor integrated circuit device as claimed in claim 20, wherein
the first controller supplies the control signal for instructing that a clock pulse having a potential value at least the first threshold value is to be used as the clock signal to the clock supplier,
the clock supplier generates a clock pulse whose potential changes from the potential value “0” to the potential at least the first threshold value as the clock signal based on the control signal and supplies the generated clock pulse to the first function executor, and
the retainer sets its internal state to have a low potential since the potential of the clock signal changes from the potential value “0” to the potential at least the first threshold value.

23. A semiconductor integrated circuit device as claimed in claim 20, wherein
the first controller supplies the control signal for instructing that a clock pulse having a potential at least the second threshold value and below the first threshold value is to be used as the clock signal to the clock supplier,
the clock supplier supplies the control signal for instructing that a clock pulse whose potential changes from the potential value “0” to the potential at least the second threshold value and below the first threshold value is to be used as the clock signal to the first function executor based on the control signal, and
the retainer sets its internal state to have a high potential since the potential of the clock signal changes from the potential value “0” to the potential at least the second threshold value and below the first threshold value.

24. A semiconductor integrated circuit device comprising:
a function executor comprising at least one first retainer, at least one second retainer, at least one third retainer and at least one controller;
a clock supplier for generating a clock signal having a clock pulse which repeats a potential value “0” and at least three high potential values and supplying the generated clock signal to the function executor; and
a voltage supplier for supplying the potential value “0” and at least two high potential values to the function executor and the clock supplier, wherein
the first retainer sets a particular potential value as a first threshold value, and fetches the high potential when the potential of the clock signal changes from a potential lower than the first threshold value to a potential at least the first threshold value,
the second retainer sets a potential value lower than the first threshold value as a second threshold value, and fetches the high potential when the potential of the clock signal changes from a potential lower than the second threshold value to a potential at least the second threshold value,
the third retainer sets a potential value lower than the second threshold value as a third threshold value, and fetches the high potential when the potential of the clock signal changes from a potential lower than the third threshold value to a potential at least the third threshold value, and
the controller receives outputs of the first retainer, the second retainer and the third retainer as input signals, and outputs a particular voltage value when these three input signals show particular values.

25. A semiconductor integrated circuit device as claimed in claim 24, wherein
the clock supplier generates a clock pulse whose potential changes from the potential value “0” to a potential at least the third threshold value and below the second threshold value as the clock signal and supplies the generated clock pulse to the first retainer, the second retainer and the third retainer,
the first retainer retains its internal data since the potential of the clock signal changes from the potential value “0” to the potential at least the third threshold value and below the second threshold value, and
the second retainer retains its internal data since the potential of the clock signal changes from the potential value “0” to the potential at least the third threshold value and below the second threshold value,
the third retainer fetches data from outside since the potential of the clock signal changes from the potential value “0” to the potential at least the third threshold value and below the second threshold value, and
the controller outputs a particular voltage value based on the internal states of the first retainer, the second retainer and the third retainer.

26. A semiconductor integrated circuit device as claimed in claim 24, wherein
the clock supplier generates a clock pulse whose potential changes from the potential value “0” to the potential at least the first threshold value as the clock signal and supplies the generated clock pulse to the first retainer, the second retainer and the third retainer,
the first retainer fetches data from outside since the potential of the clock signal changes from the potential value “0” to the potential at least the first threshold value, and
the second retainer fetches the data from outside since the potential of the clock signal changes from the potential value “0” to the potential at least the first threshold value,
the third retainer fetches the data from outside since the potential of the clock signal changes from the potential value “0” to the potential at least the first threshold value and
the controller outputs a particular voltage value based on the internal states of the first retainer, the second retainer and the third retainer.

27. A semiconductor integrated circuit device as claimed in claim 24, wherein
the clock supplier generates a clock pulse whose potential changes from the potential at least the third threshold value and below the second threshold value to the potential at least the second threshold value and below the first threshold value as the clock signal and supplies the generated clock pulse to the first retainer, the second retainer and the third retainer,
the first retainer retains its internal data since the potential of the clock signal changes from the potential at least the third threshold value and below the second threshold value to the potential at least the second threshold value and below the first threshold value, and
the second retainer fetches the data from outside since the potential of the clock signal changes from the potential at least the third threshold value and below the second threshold value to the potential at least the second threshold value and below the first threshold value,
the third retainer retains its internal data since the potential of the clock signal changes from the potential at least the third threshold value and below the second threshold value to the potential at least the second threshold value and below the first threshold value, and
the controller outputs a particular voltage value based on the internal states of the first retainer, the second retainer and the third retainer.

28. A semiconductor integrated circuit device comprising:
a first function executor comprising at least one first retainer;
a second function executor comprising at least one second retainer;
a clock supplier for generating a clock signal having a clock pulse which repeats a potential value “0” and at least two high potential values and supplying the generated clock signal to the first function executor and the second function executor; and
a voltage supplier for supplying the potential value “0” and the at least two high potential values to the first and second function executors and the clock supplier, wherein
the first retainer sets a particular potential value as a first threshold value, and fetches data from outside when the potential of the clock signal changes from a potential lower than the first threshold value to a potential at least the first threshold value, and
the second retainer sets a potential value lower than the threshold value of the first function executor as a second threshold value, and fetches the data from outside when the potential of the clock signal changes from a potential lower than the second threshold value to a potential at least the second threshold value.

29. A semiconductor integrated circuit device as claimed in claim 28, wherein
the clock supplier generates a clock pulse whose potential changes from the potential value “0” to a potential at least the second threshold value and below the first threshold value as the clock signal and supplies the generated clock pulse to the first function executor and the second function executor,
the first retainer retains its internal state since the potential of the clock signal changes from the potential value “0” to the potential at least the second threshold value and below the first threshold value in the first function executor, and
the second retainer fetches the data from outside since the potential of the clock signal changes from the potential value “0” to the potential at least the second threshold value and below the first threshold value in the second function executor.

30. A semiconductor integrated circuit device as claimed in claim 28, wherein
the clock supplier generates a clock pulse whose potential changes from a potential at least the second threshold value and below the first threshold value to the potential at least the first threshold value as the clock signal and supplies the generated clock pulse to the first function executor and the second function executor,
the first retainer fetches the data from outside since the potential of the clock signal changes from the potential at least the second threshold value and below the first threshold value to the potential at least the first threshold value in the first function executor, and
the second retainer retains its internal data since the potential of the clock signal changes from the potential at least the second threshold value and below the first threshold value to the potential at least the first threshold value in the second function executor.

31. A semiconductor integrated circuit device comprising:
a first function executor comprising at least one first retainer;
a second function executor comprising at least one second retainer;
a clock supplier for generating a clock pulse which repeats a potential value “0” and at least two high potential values and supplying the generated clock signal to the first function executor and the second function executor, the clock supplier further generating at least two reset signals having a high potential value and supplying the generated reset signals to the first function executor and the second function executor; and
a voltage supplier for supplying the potential value “0” and the at least two high potential values to the first and second function executors and the clock supplier, wherein
the first retainer sets a particular potential value as a first threshold value and fetches data from outside when the potential value of the clock signal changes from a potential lower than the first threshold value to a potential at least the first threshold value,
the first retainer further sets a particular potential value as a third threshold value, and sets its internal state to have a low potential when the potentials of the reset signals change to potentials lower than the third threshold value,
the second retainer sets an potential lower than the first threshold value as a second threshold value, and fetches the data from outside when the potential of the clock signal changes from a potential lower than the second threshold value to a potential at least the second threshold value, and
the second retainer further sets a potential value lower than the third threshold value as a fourth threshold value, and sets its internal state to have a low potential low when the potentials of the reset signals change to potentials lower than the fourth threshold value.

32. A semiconductor integrated circuit device as claimed in claim 31, wherein
the clock supplier supplies the reset signal whose potential is at least the fourth threshold value and below the third threshold value to the first function executor and the second function executor,
the first retainer retains its internal state since the potential of the reset signal is at least the fourth threshold value and below the third threshold value in the first function executor, and
the second retainer sets its internal state to have a low potential since the potential of the reset signal is at least the fourth threshold value and below the third threshold value in the second function executor.

33. A semiconductor integrated circuit device as claimed in claim 31, wherein
the clock supplier supplies the reset signal whose potential is at least the third threshold value to the first function executor and the second function executor,
the first retainer sets its internal state to have a low potential since the potential of the reset signal is at least the third threshold value in the first function executor, and
the second retainer sets its internal state to have a low potential since the potential of the reset signal is at least the third threshold value in the second function executor.
